(19) United States
(12) Patent Application Publication
(10) Pub. No.: US 2024/0404207 A1
(43) Pub. Date: Dec. 5, 2024

(54) DEVICES, METHODS, AND GRAPHICAL USER INTERFACES FOR DISPLAYING CONTENT OF PHYSICAL LOCATIONS

(71) Applicant: Apple Inc., Cupertino, CA (US)

(72) Inventors: Martynas LAURITA, Santa Cruz, CA (US); Vincent P. ARROYO, Union City, CA (US); Niranjan MANJUNATH, Sunnyvale, CA (US); Stephen O. LEMAY, Palo Alto, CA (US); Peter D. ANTON, Portola Valley, CA (US); Matan STAUBER, San Francisco, CA (US); Matthew J. SUNDSTROM, Campbell, CA (US); Fiona P. O'LEARY, Palo Alto, CA (US); Konstantin SINITSYN, Carlsbad, CA (US); Giovanni S. LUIS, Manhattan Beach, CA (US); Devin FLOOD, Cupertino, CA (US); Kevin N. EUGENE, Cupertino, CA (US); Per J. FAHLBERG, Sunnyvale, CA (US); Ryan W. APUY, San Francisco, CA (US)

(21) Appl. No.: 18/733,497

(22) Filed: Jun. 4, 2024

Related U.S. Application Data
(60) Provisional application No. 63/506,134, filed on Jun. 4, 2023.
(60) Provisional application No. 63/655,510, filed on Jun. 3, 2024.

(51) Int. Cl. G06T 19/00; G06F 3/01

(52) U.S. Cl. CPC G06T 19/003; G06F 3/011

(57) ABSTRACT

In some embodiments, a computer system displays a navigation user interface that includes a first representation of a first location experience and a first portion of a navigation user interface element with a first orientation that includes a first representation of a first point of interest associated with the first location experience. In some embodiments, the computer system changes the display of the navigation user interface element from the first orientation to a second orientation corresponding to the first location experience. In some embodiments, the computer system displays a collection of content associated with a physical location in response to user input corresponding to a request to generate the collection of content associated with the physical location.

### CROSS-REFERENCE TO RELATED APPLICATIONS

This application claims the benefit of U.S. Provisional Application No. 63/506,134, filed Jun. 4, 2023, and U.S. Provisional Application No. 63/655,510, filed Jun. 3, 2024, the contents of which are herein incorporated by reference in their entirety for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system presents virtual objects corresponding to physical locations within a three-dimensional environment in response to detecting user input indicating interaction with the virtual objects. In some embodiments, the computer system presents curated content of physical locations from content sources including different perspectives in response to detecting user input directed to the virtual objects.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7K illustrate examples of a computer system displaying curated content of a physical location within a three-dimensional environment in accordance with some embodiments.

FIG. 8 is a flowchart illustrating an exemplary method of displaying curated content of a physical location within a three-dimensional environment in accordance with some embodiments.

FIGS. 9A-9CC illustrate examples of a computer system displaying a collection of content associated with a physical location in response to user input corresponding to a request to generate the collection of content associated with the physical location in accordance with some embodiments.

FIG. 10 is a flowchart illustrating an exemplary method of displaying a collection of content associated with a physical location in response to user input corresponding to a request to generate the collection of content associated with the physical location in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays a navigation user interface that includes a first representation of a first location experience and a first portion of a navigation user interface element with a first orientation that includes a first representation of a first point of interest associated with the first location experience. In some embodiments, while displaying the user interface, the computer system detects a first input directed to the first representation of the first location experience. In some embodiments, in response to detecting the first input, the computer system changes the display of the navigation user interface element from the first orientation to a second orientation corresponding to the first location experience. In some embodiments, in response to detecting the first input, the computer system displays the navigation user interface element to include a second portion, different from the first portion and associated with the first location experience.

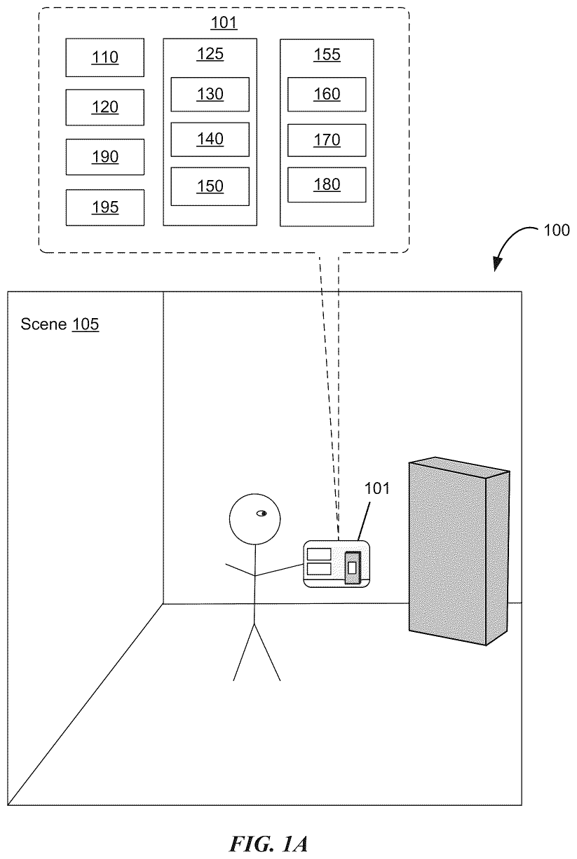

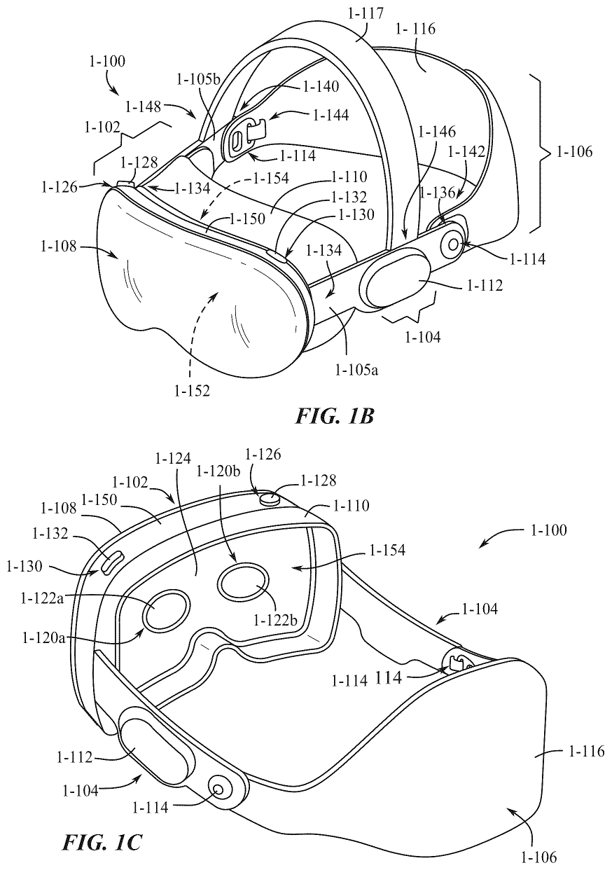

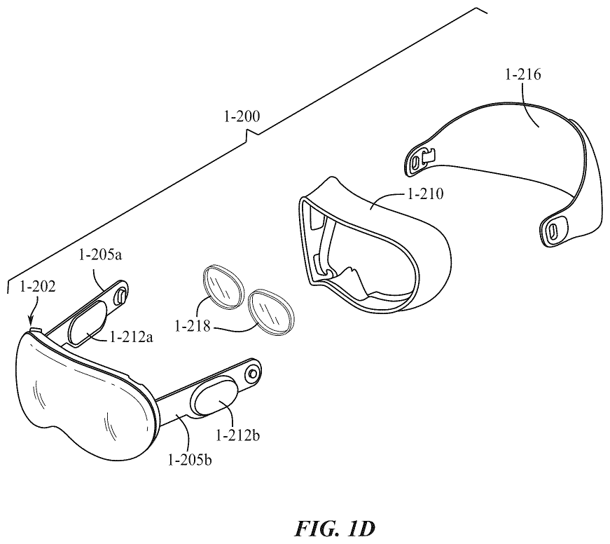

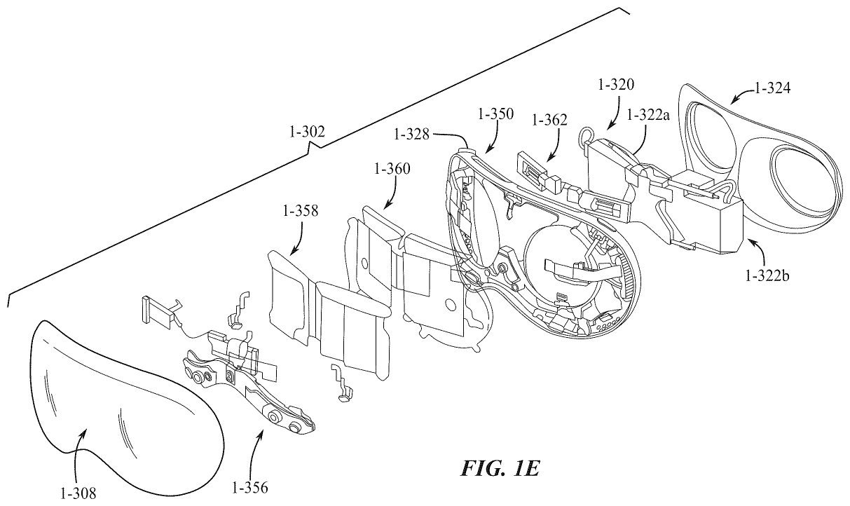

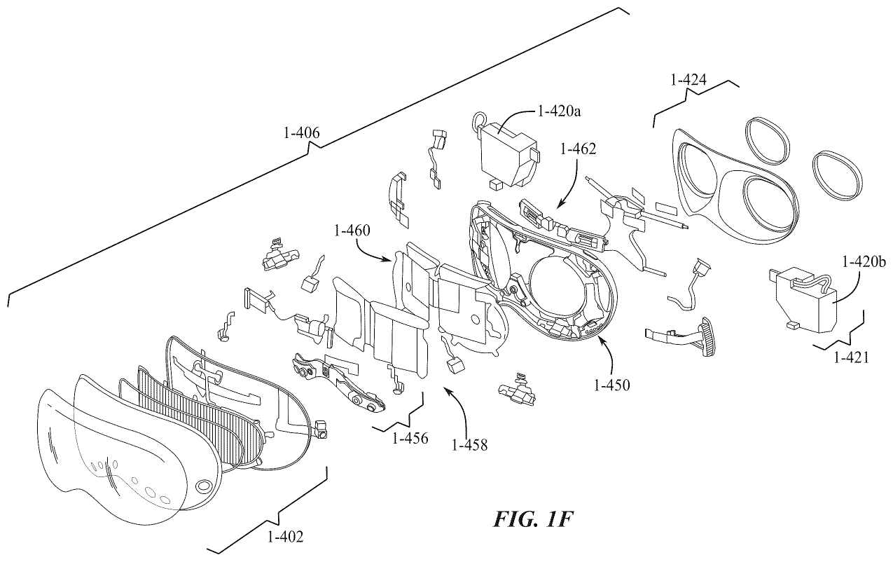

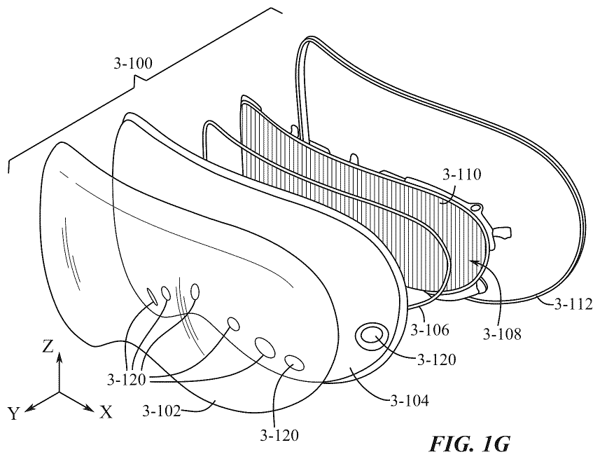

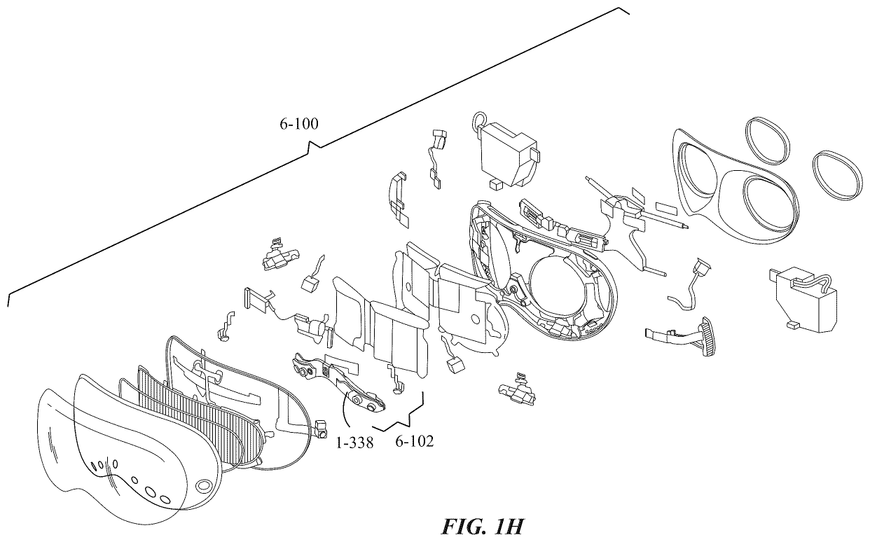

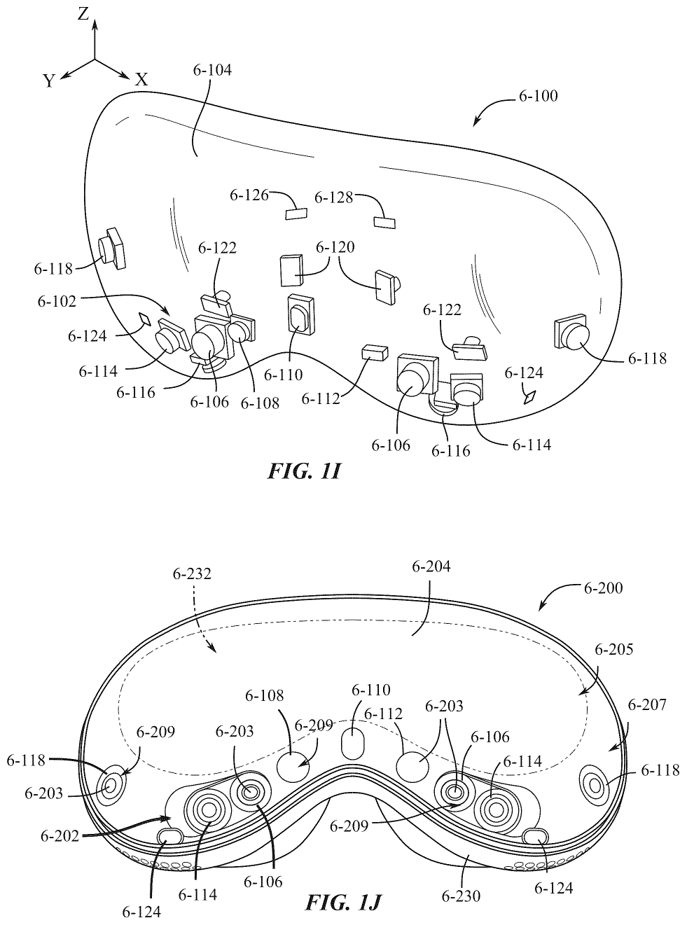

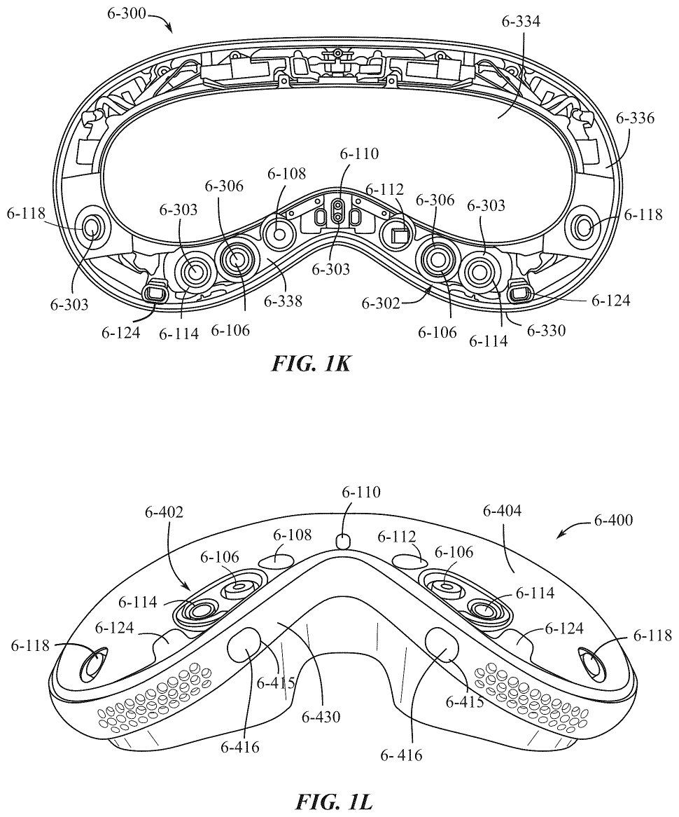

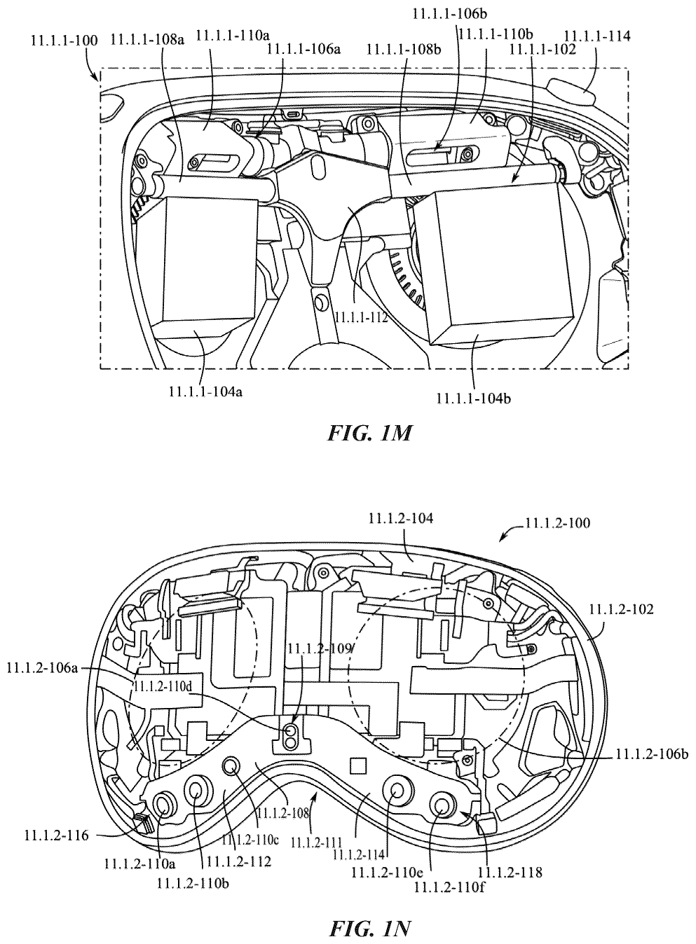

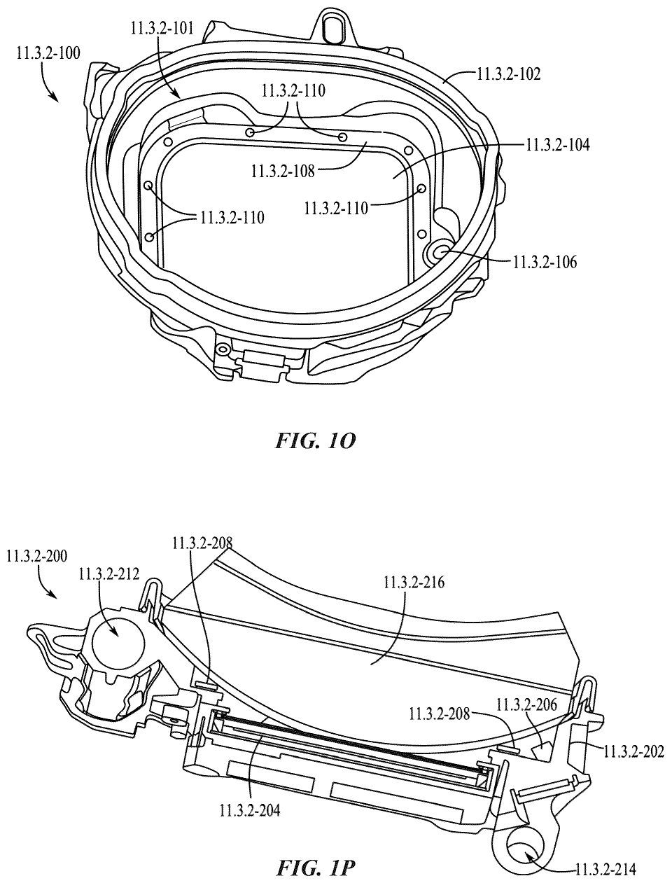

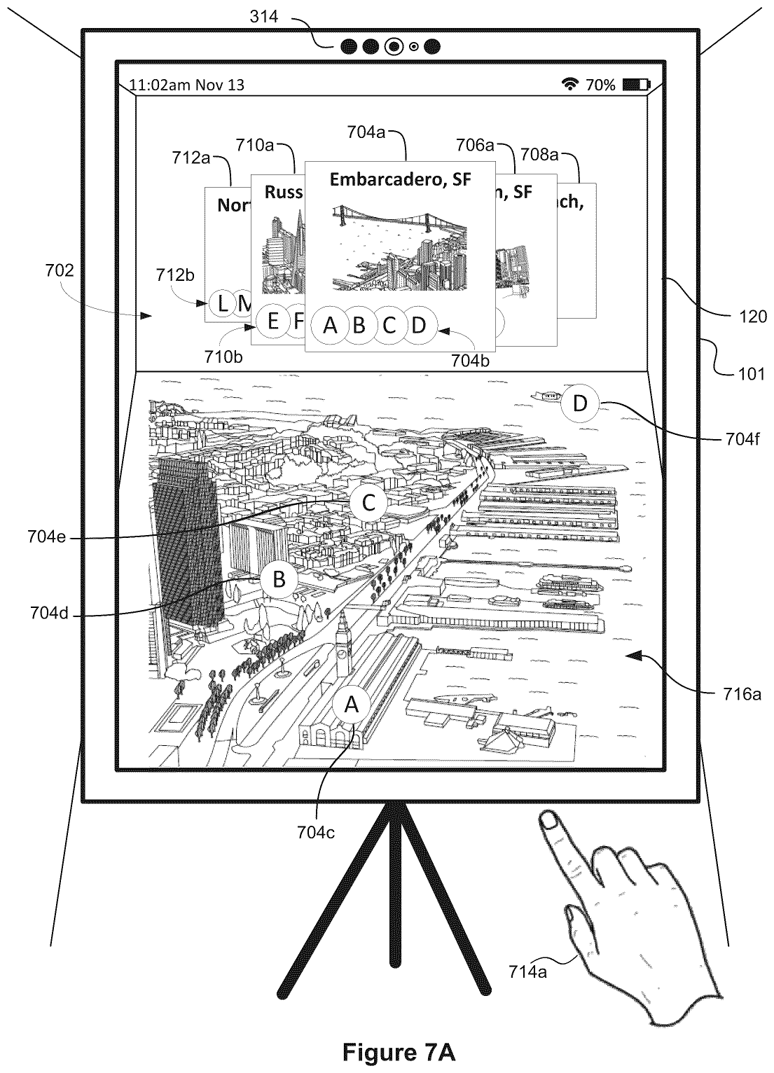

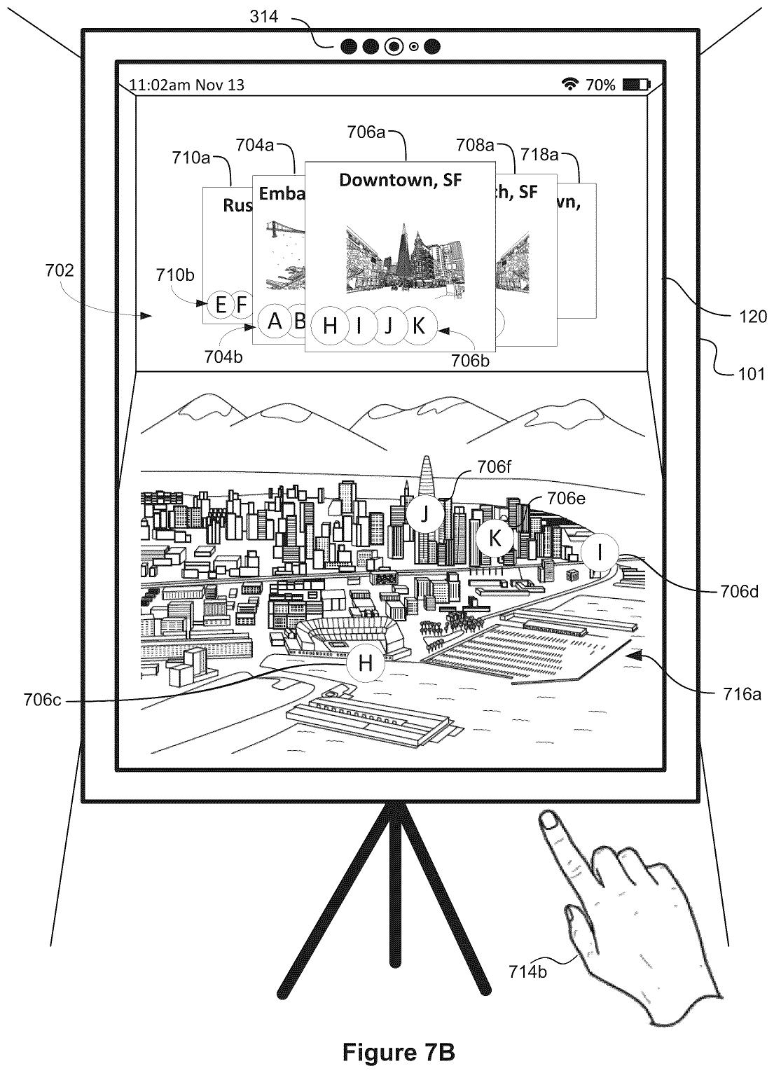

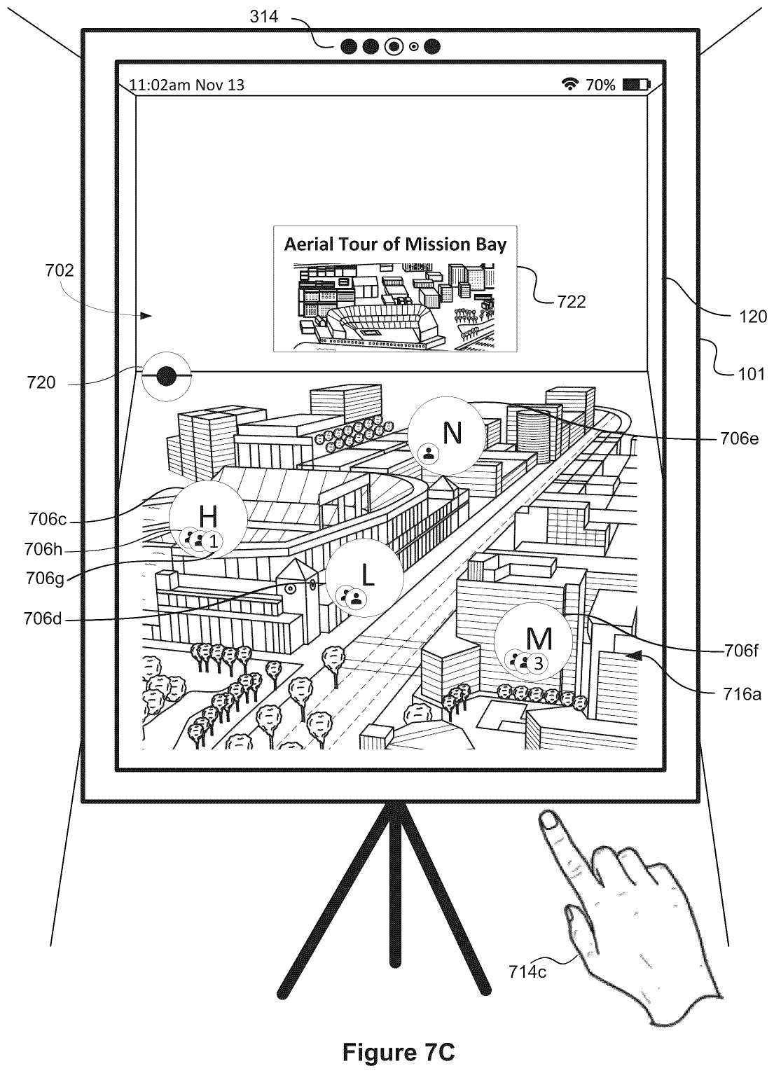

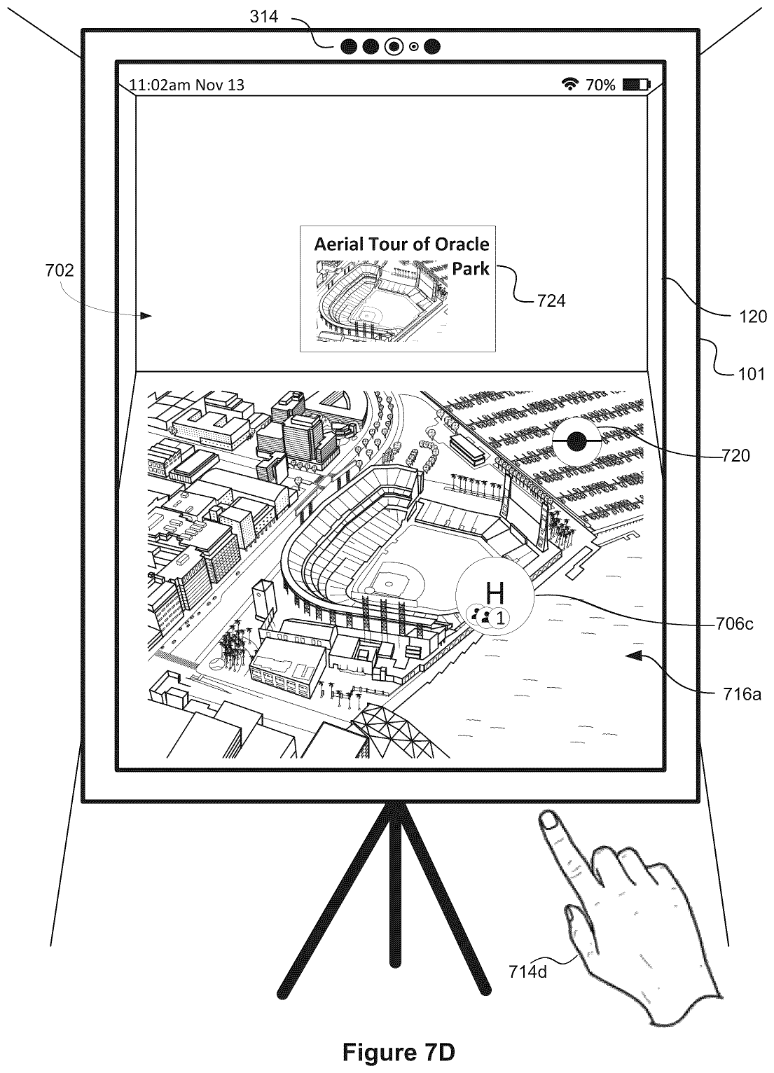

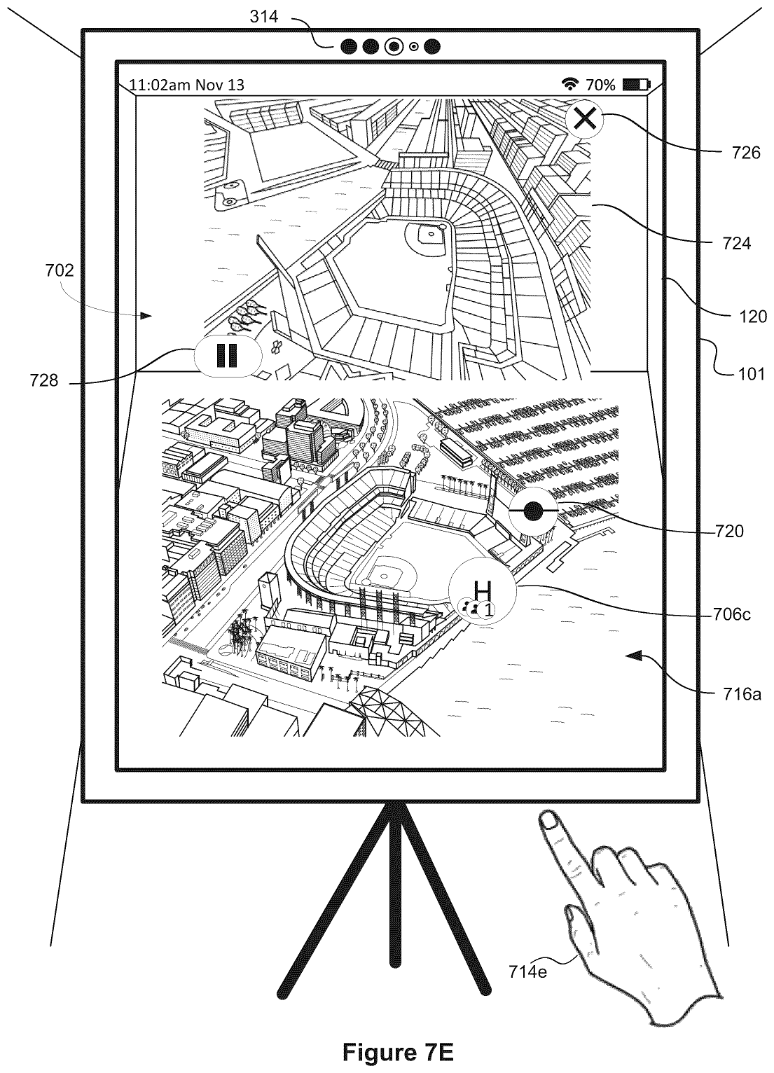

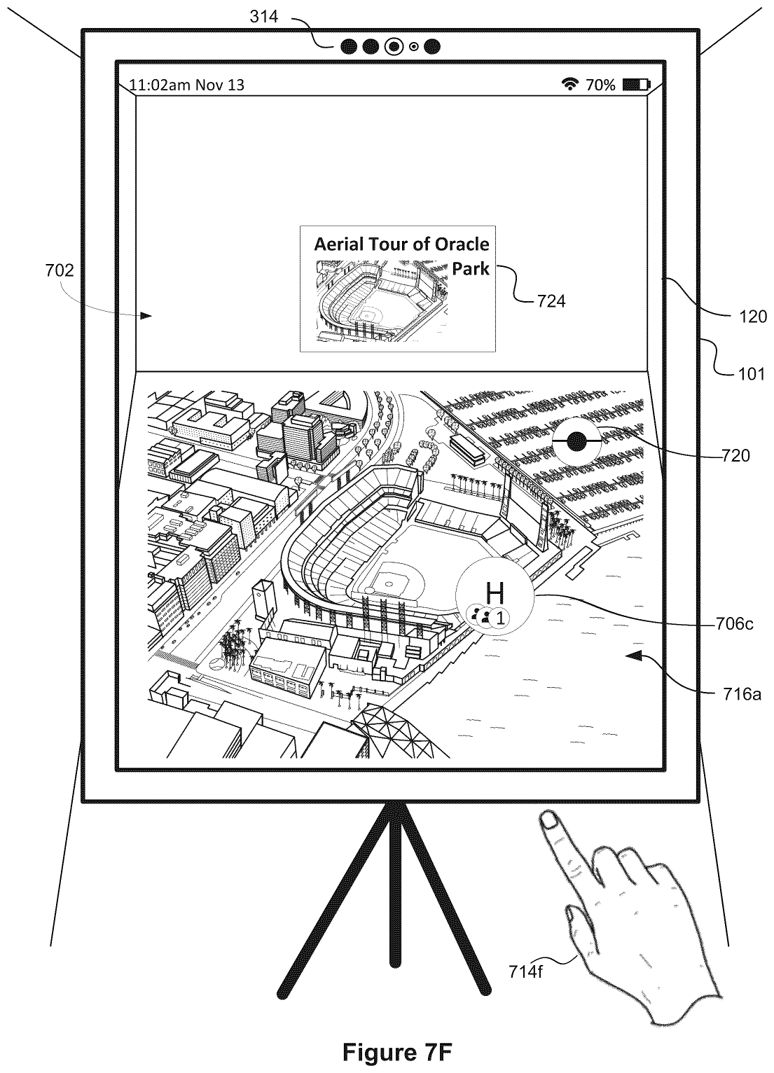

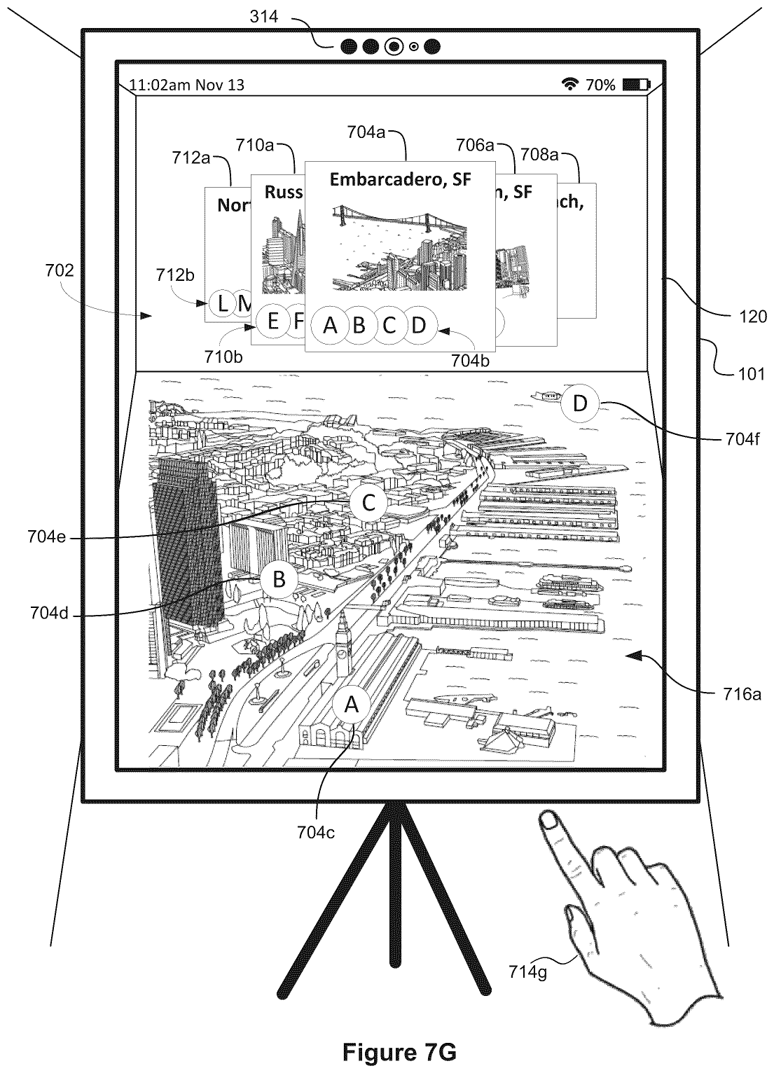

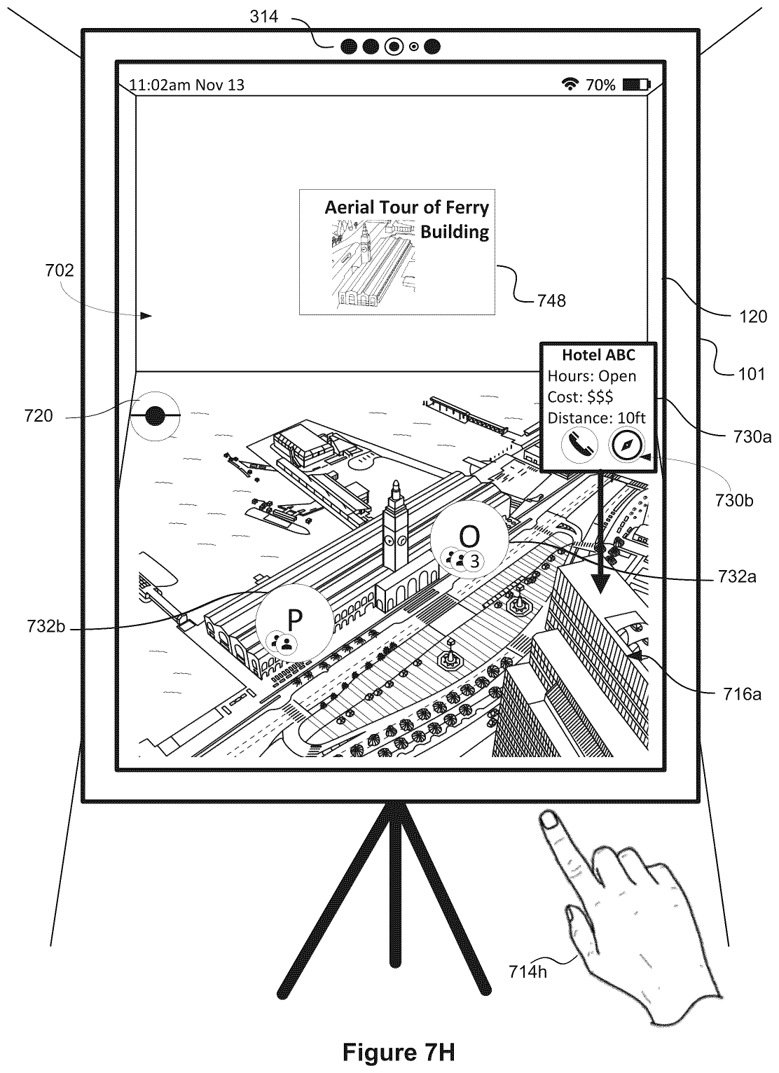

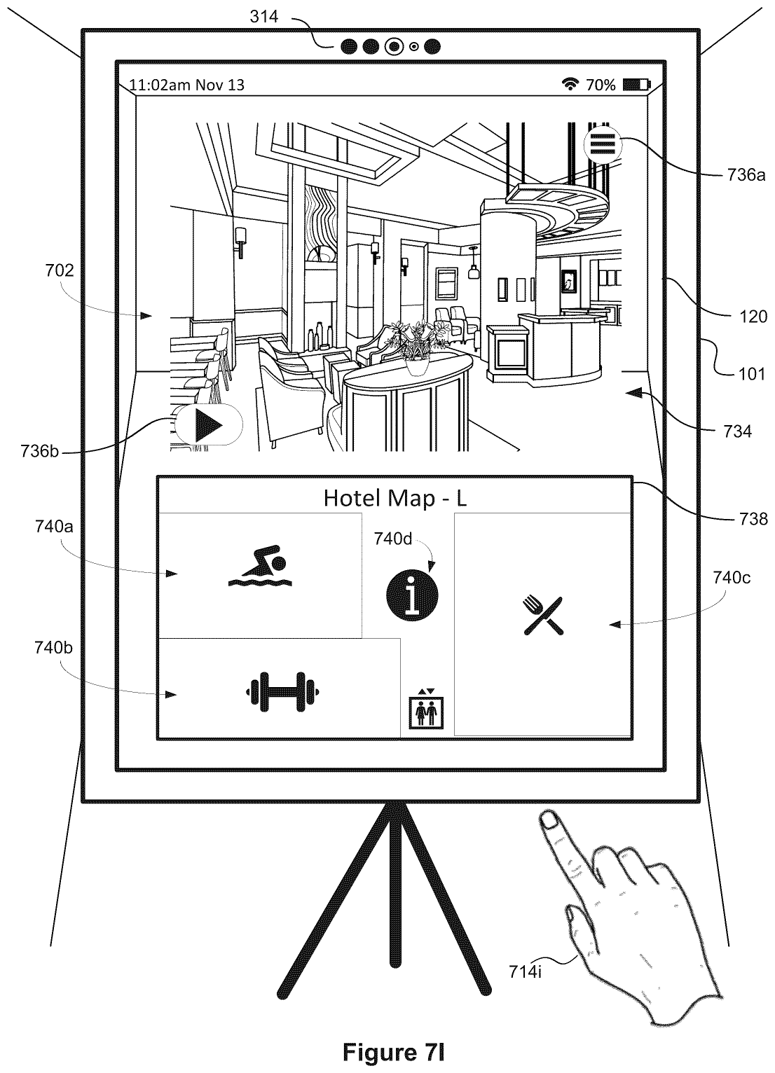

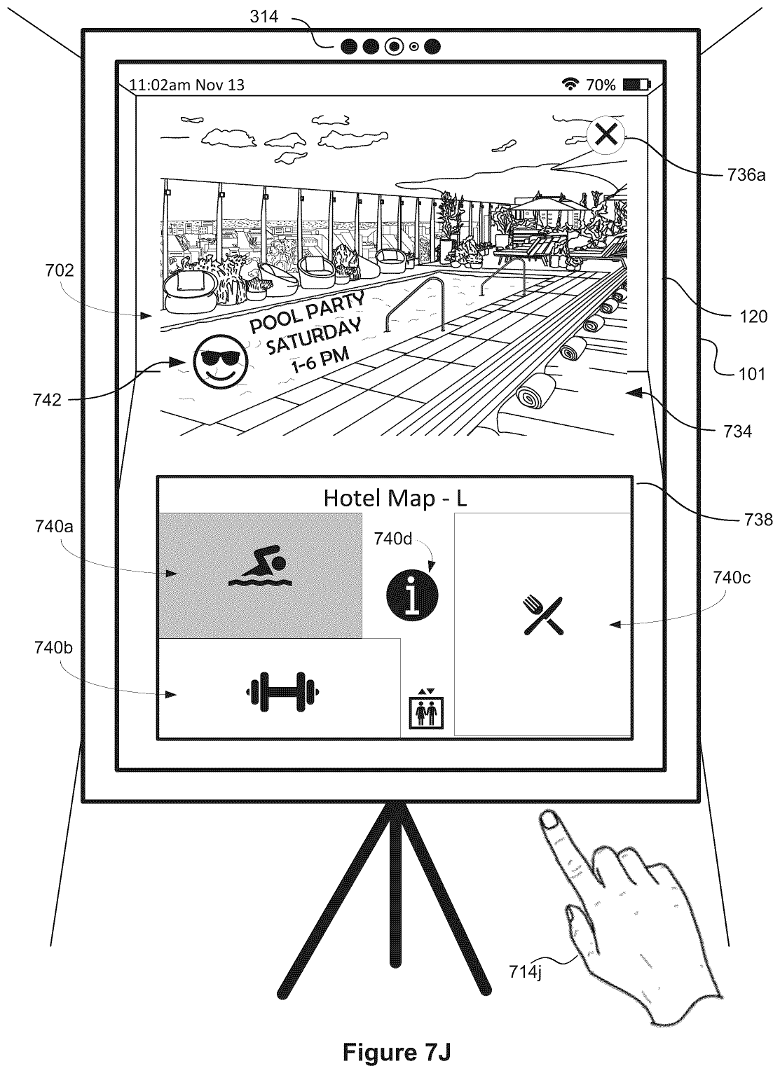

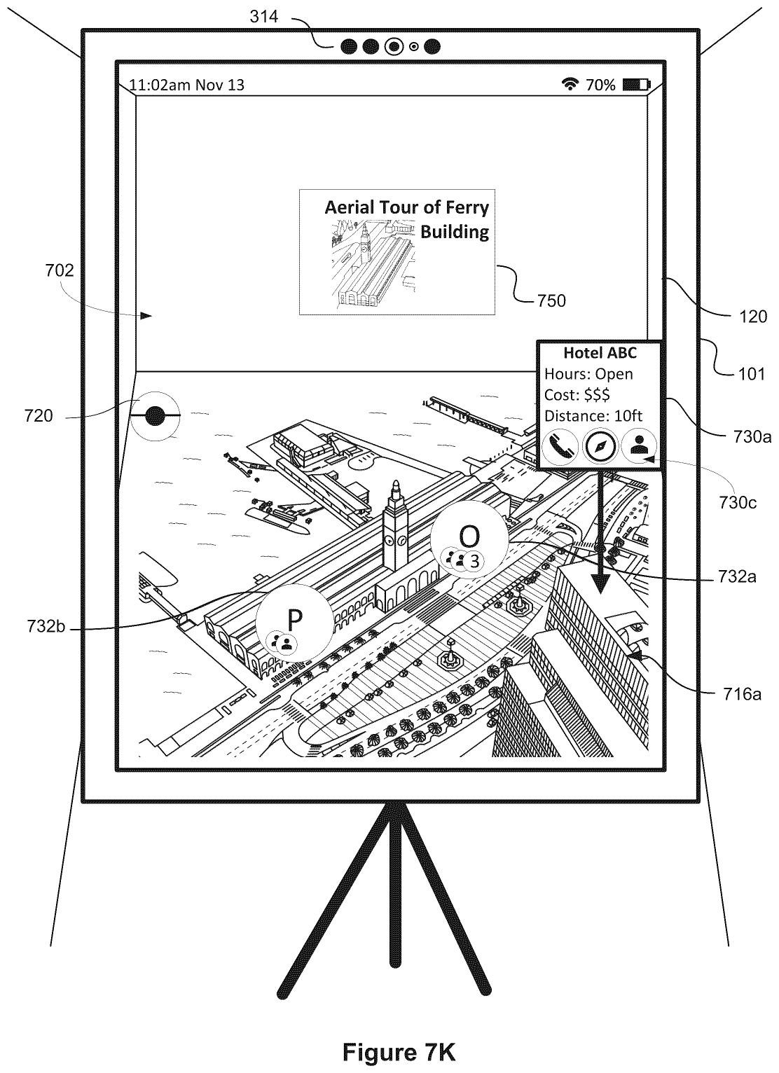

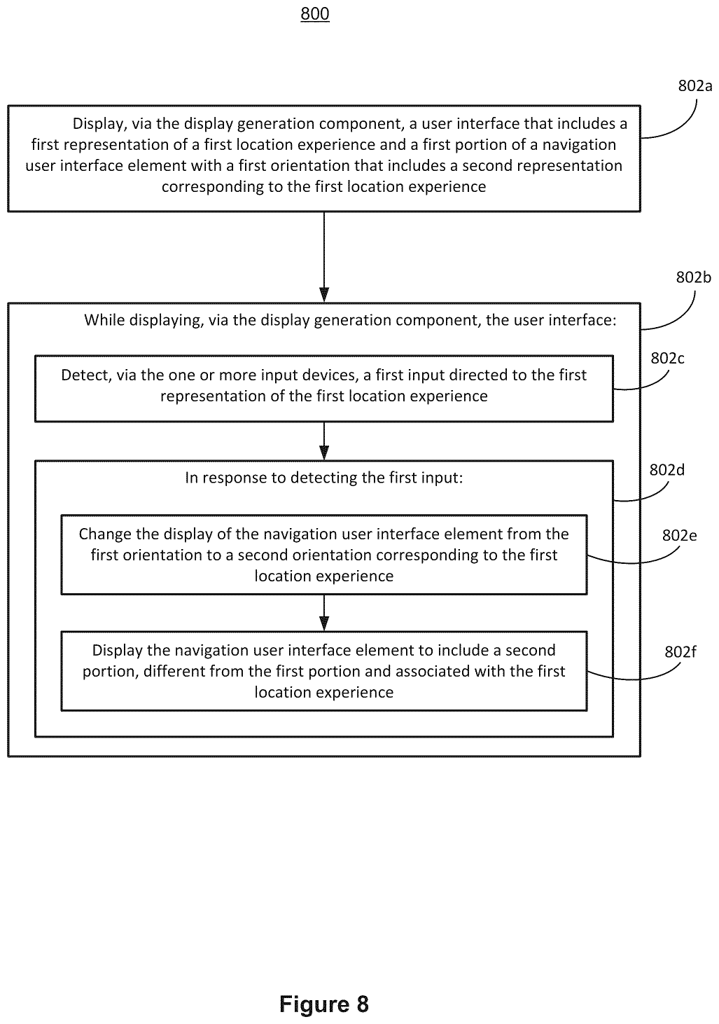

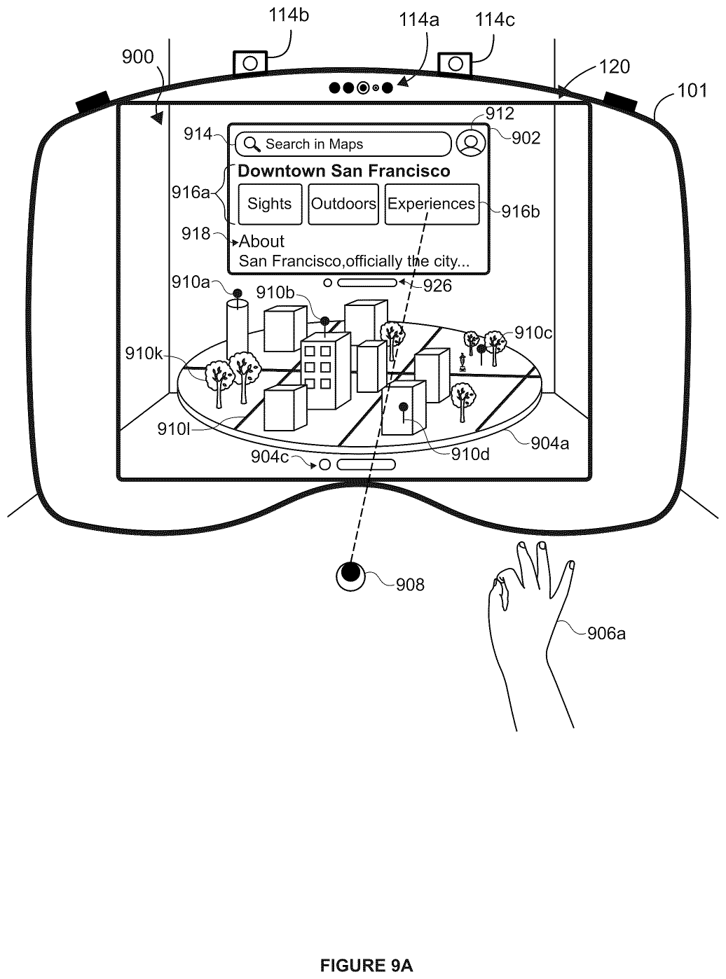

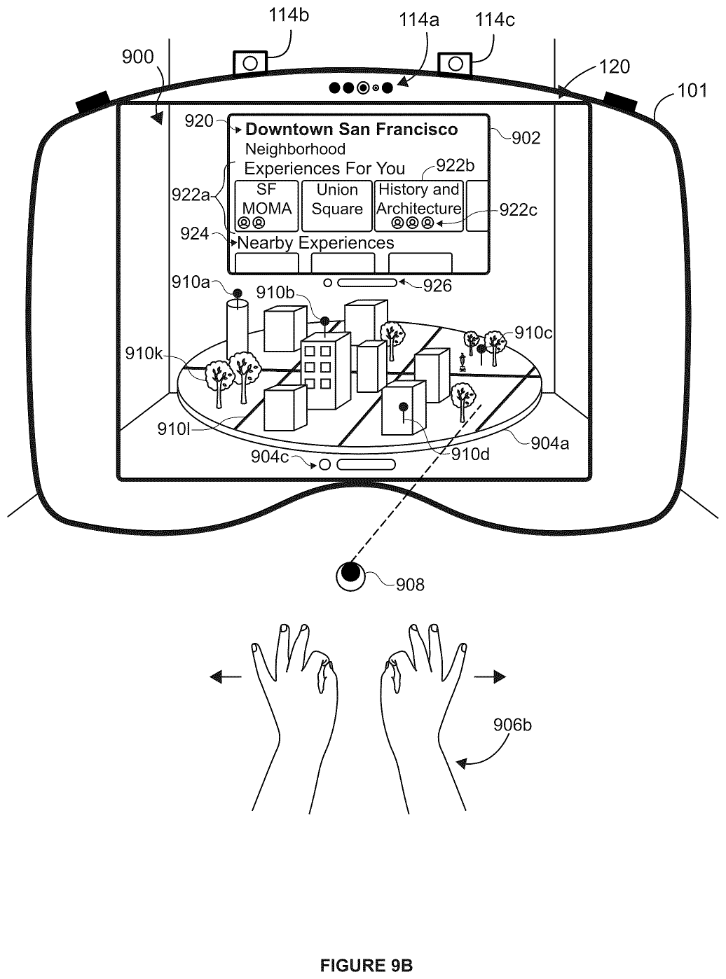

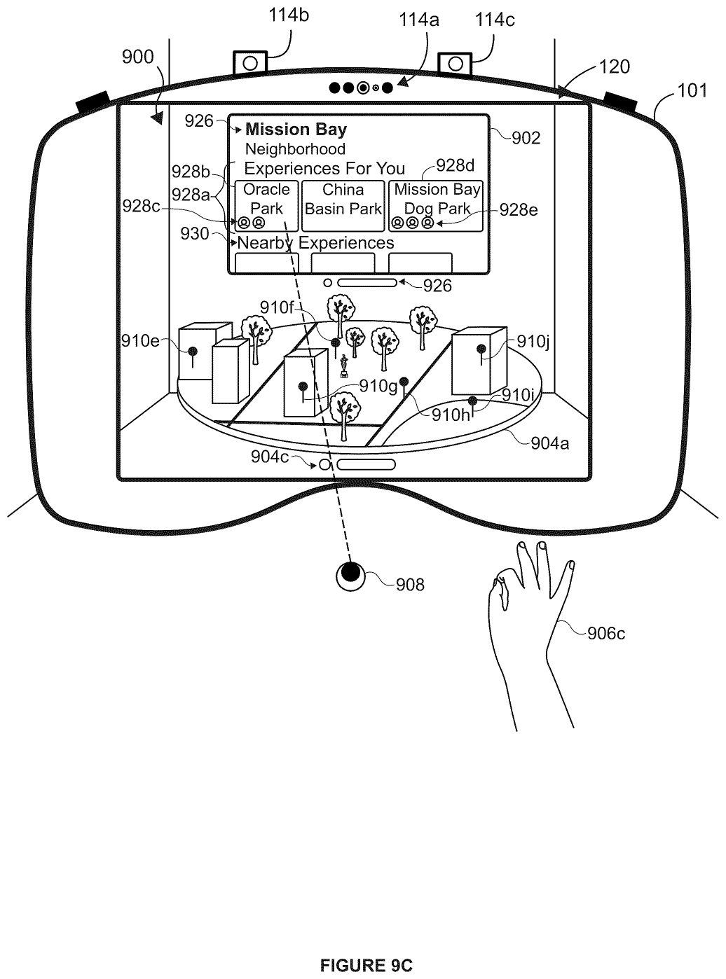

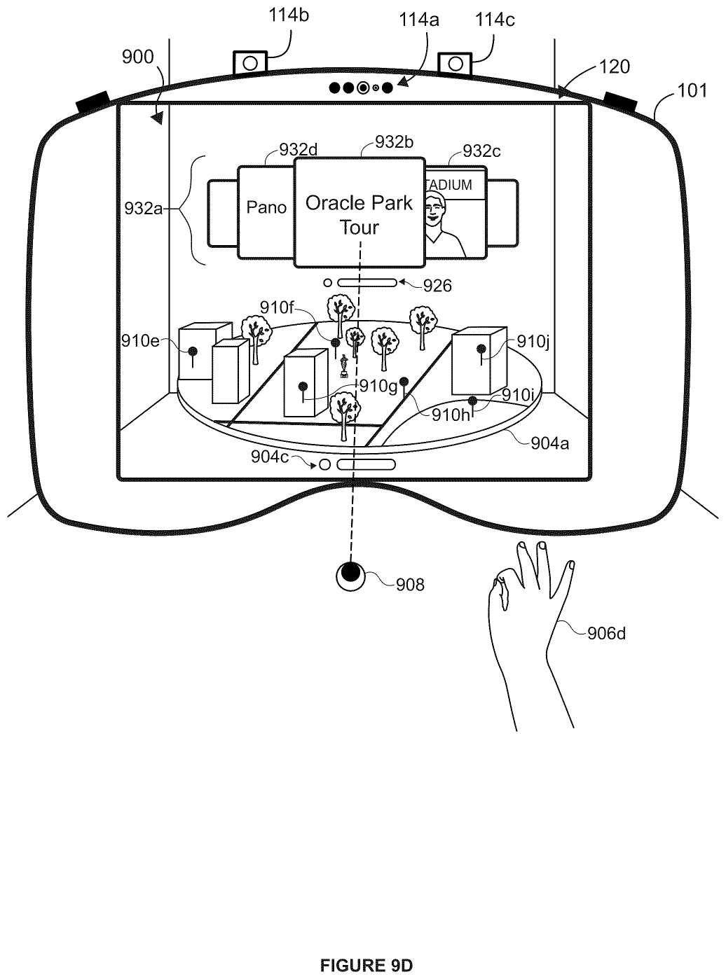

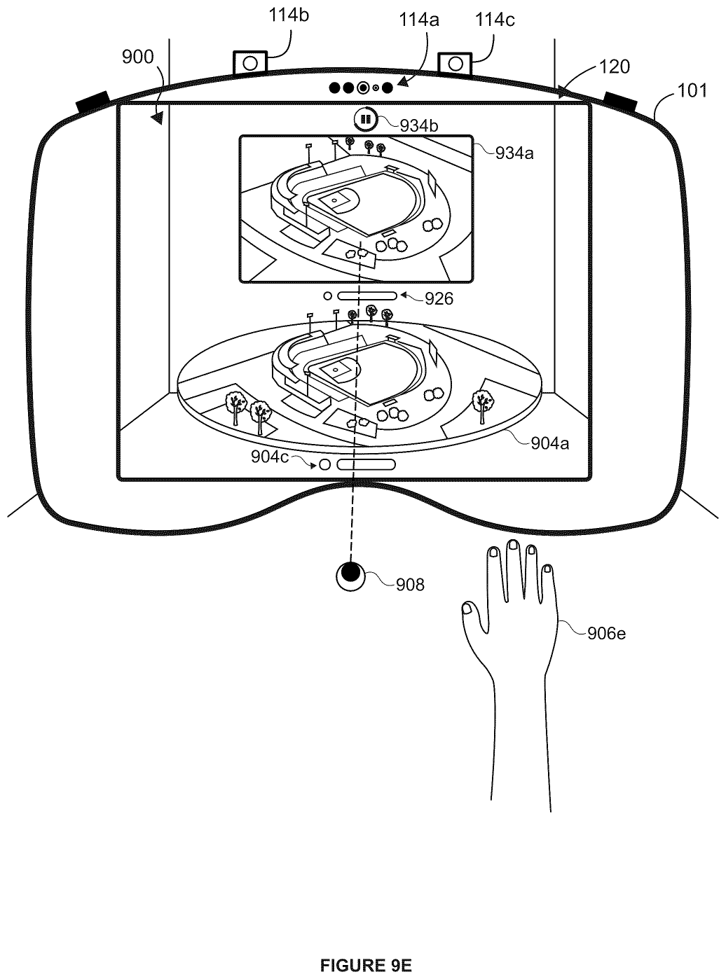

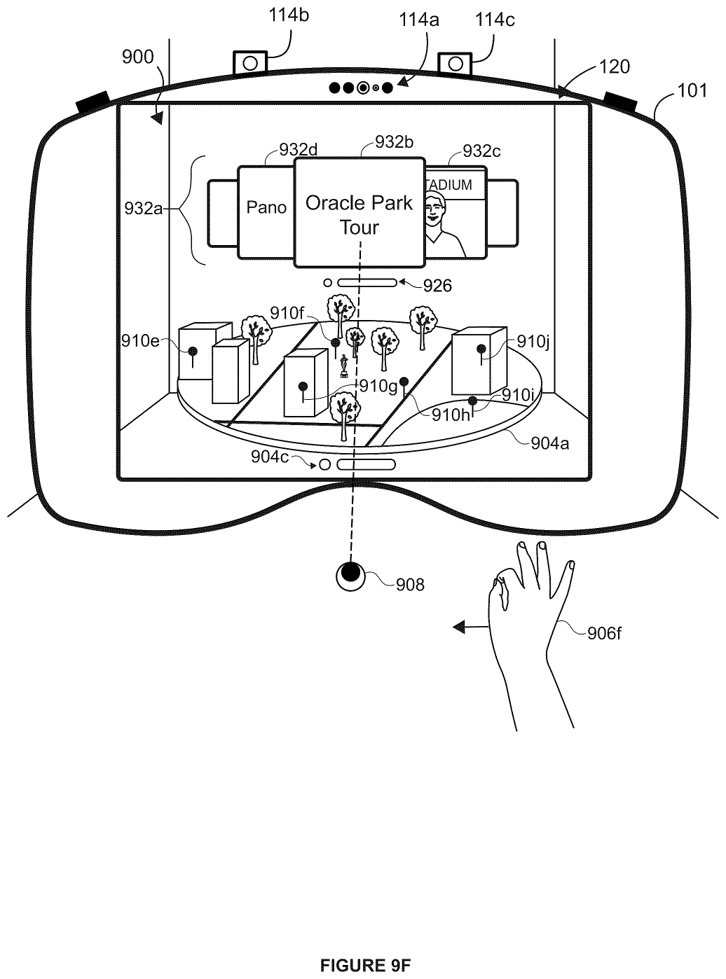

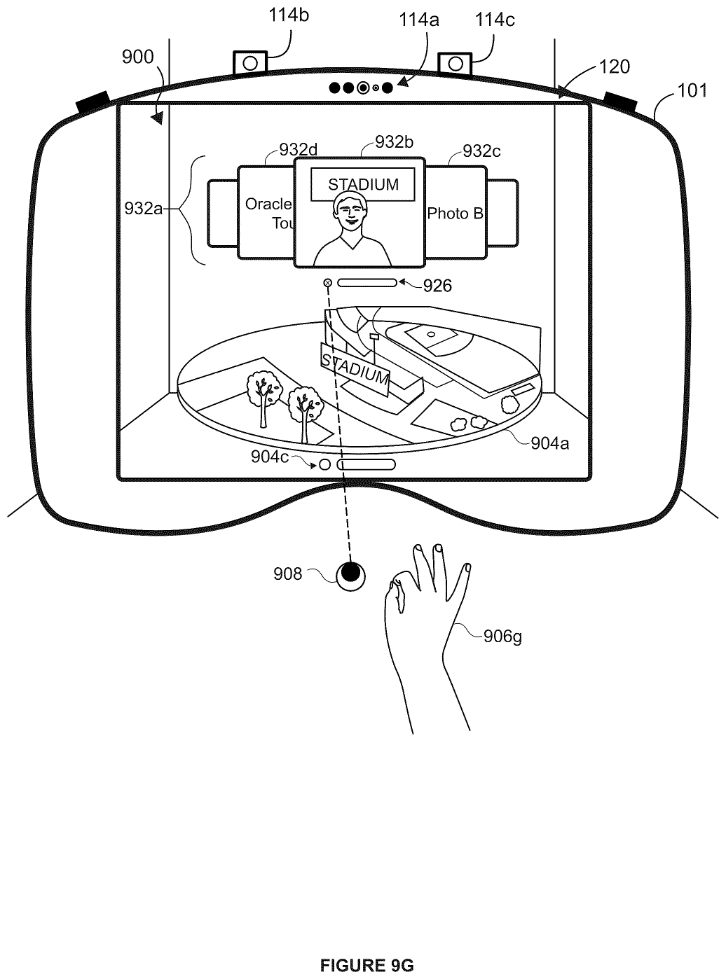

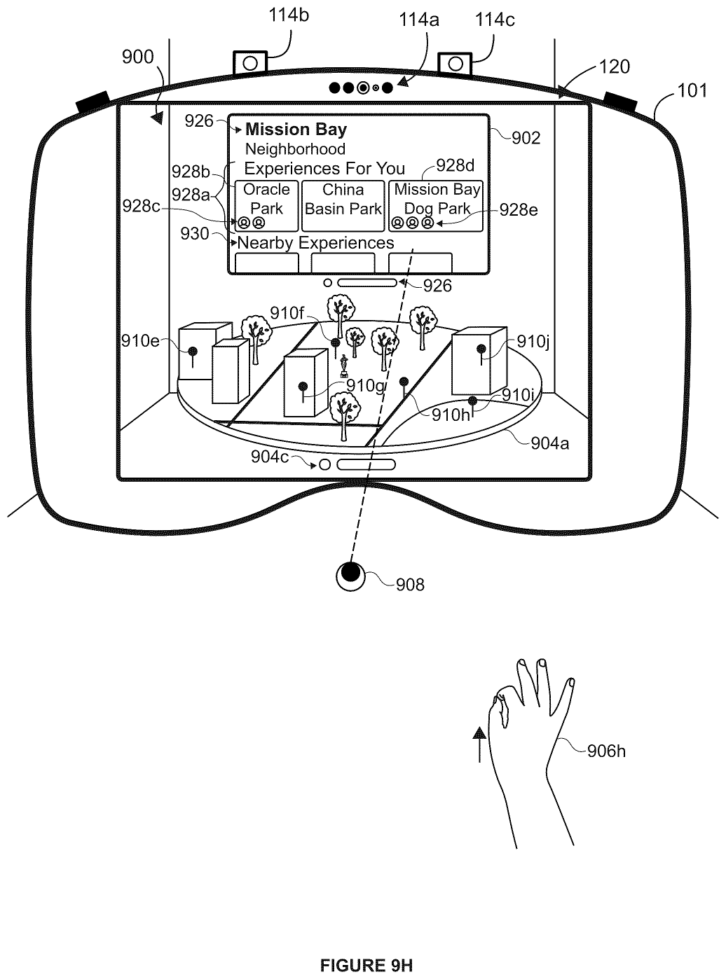

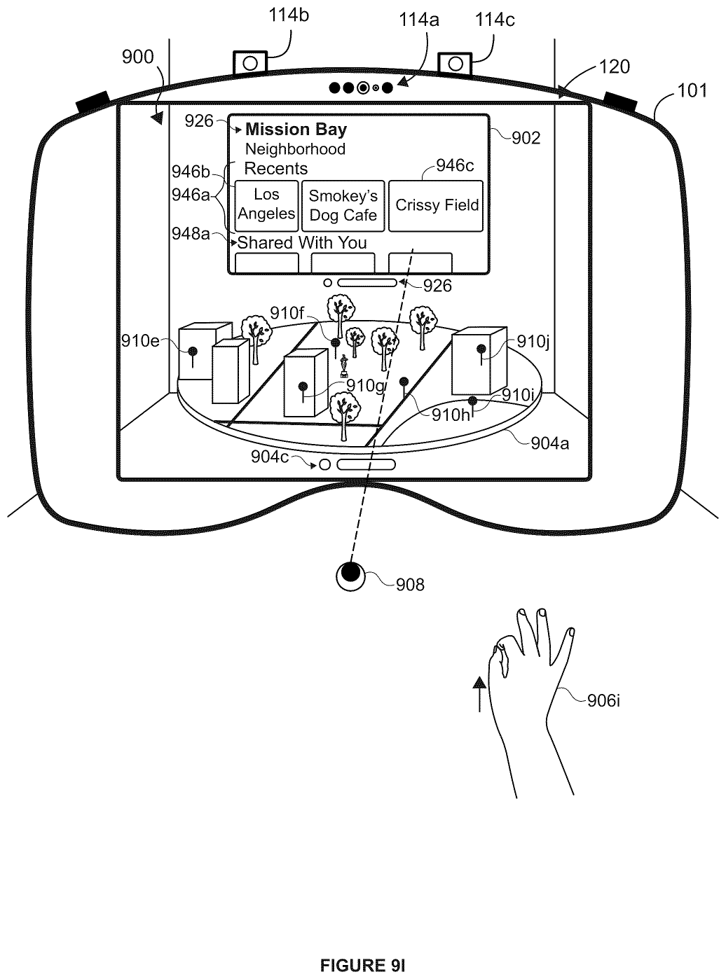

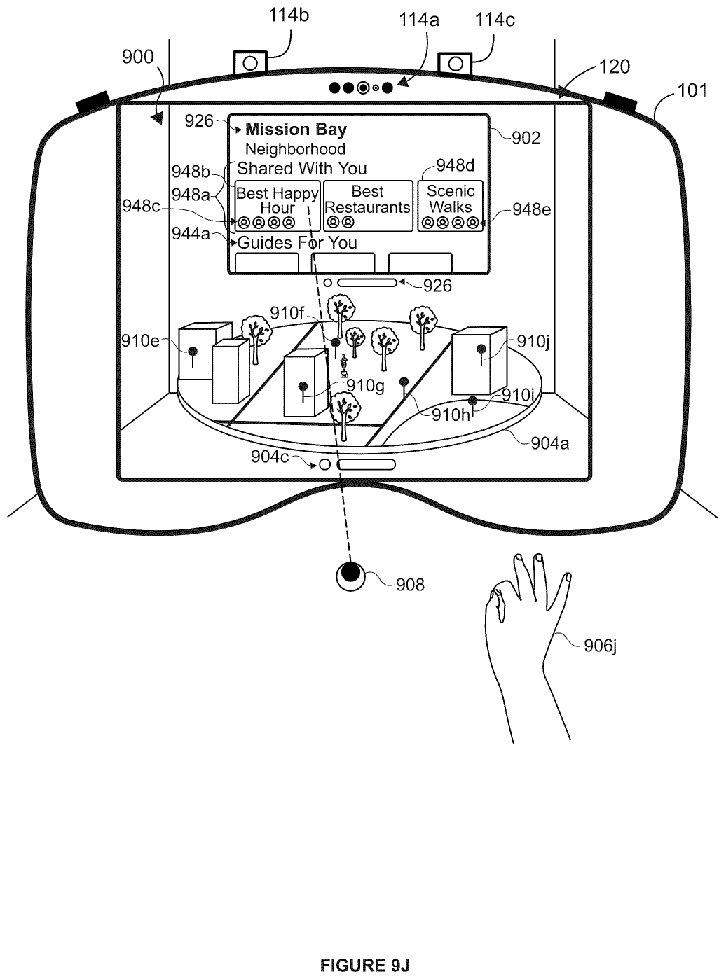

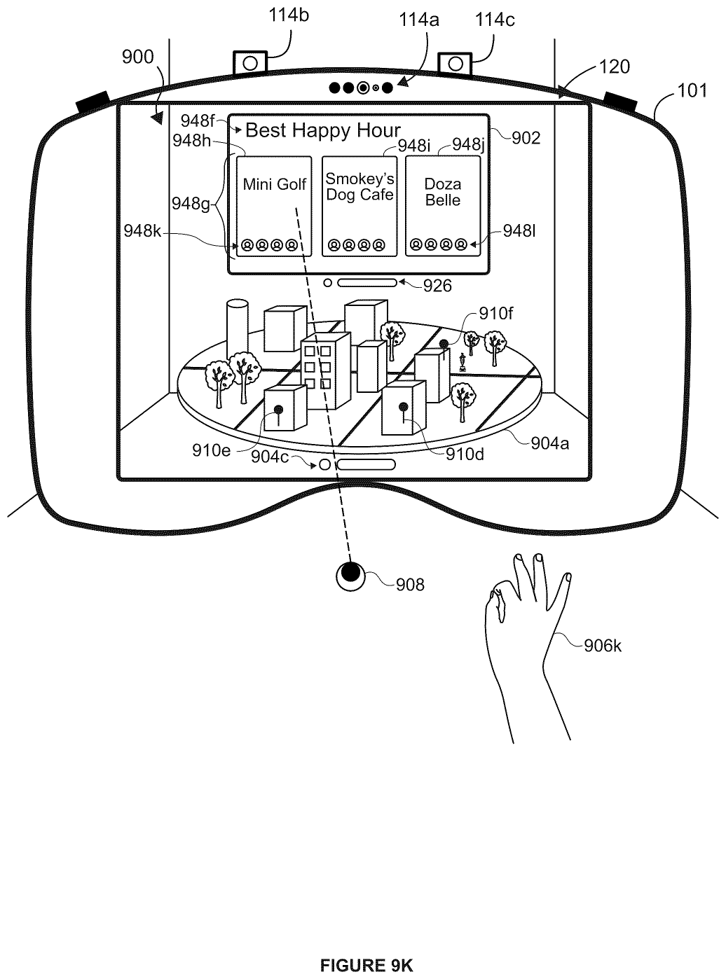

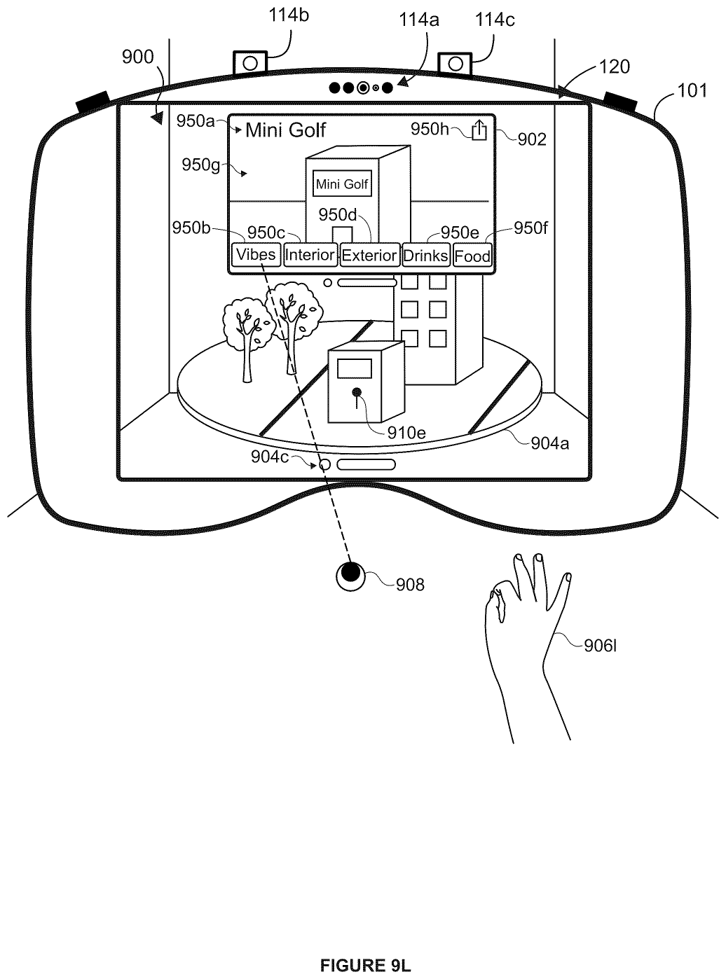

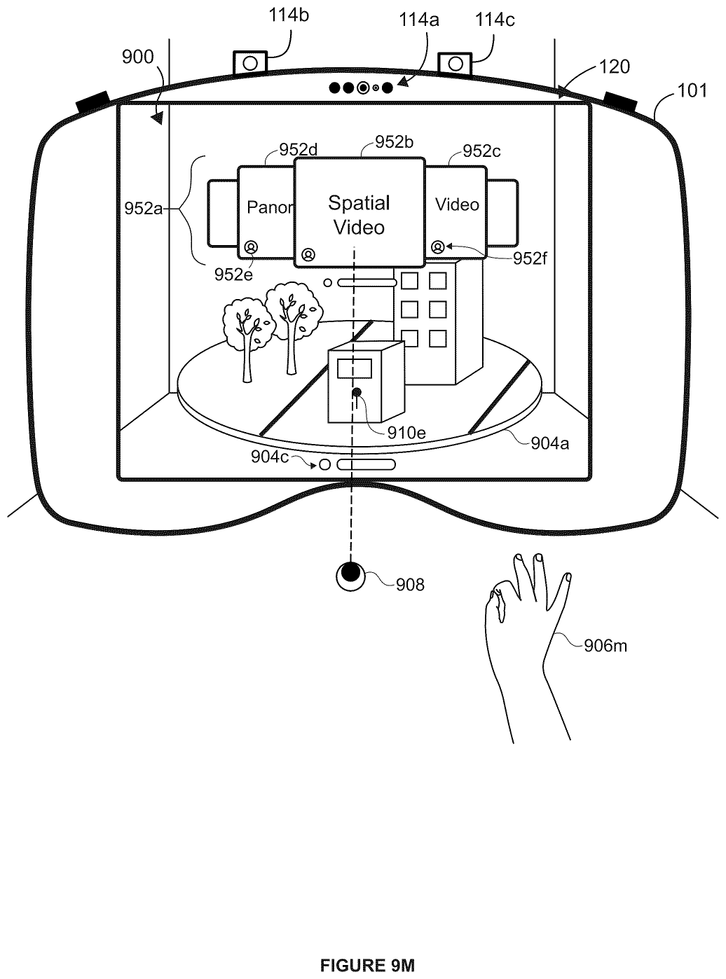

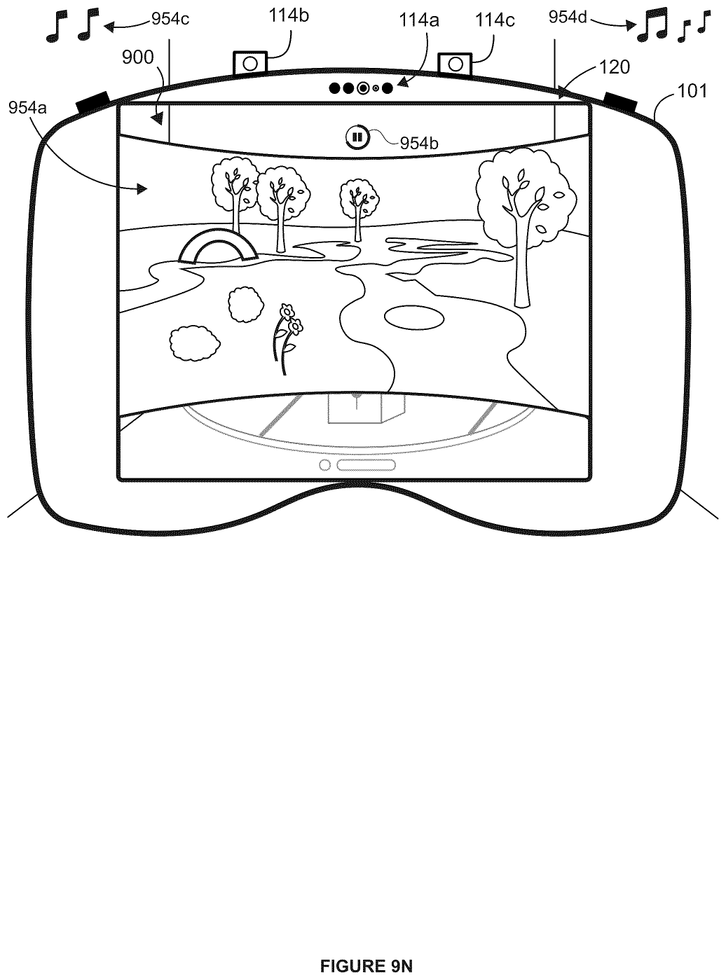

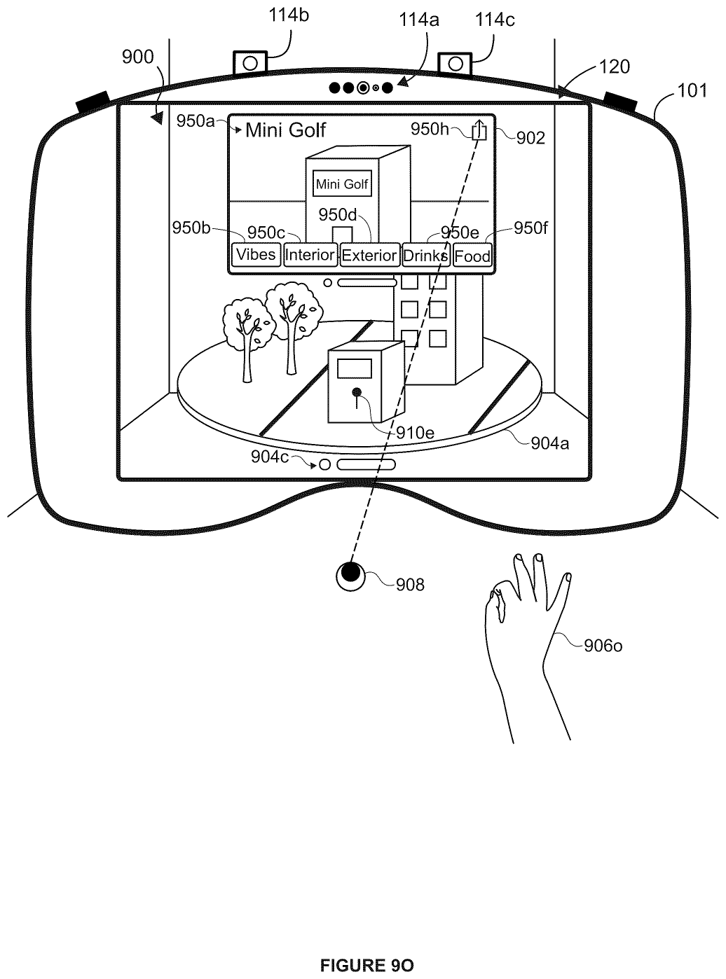

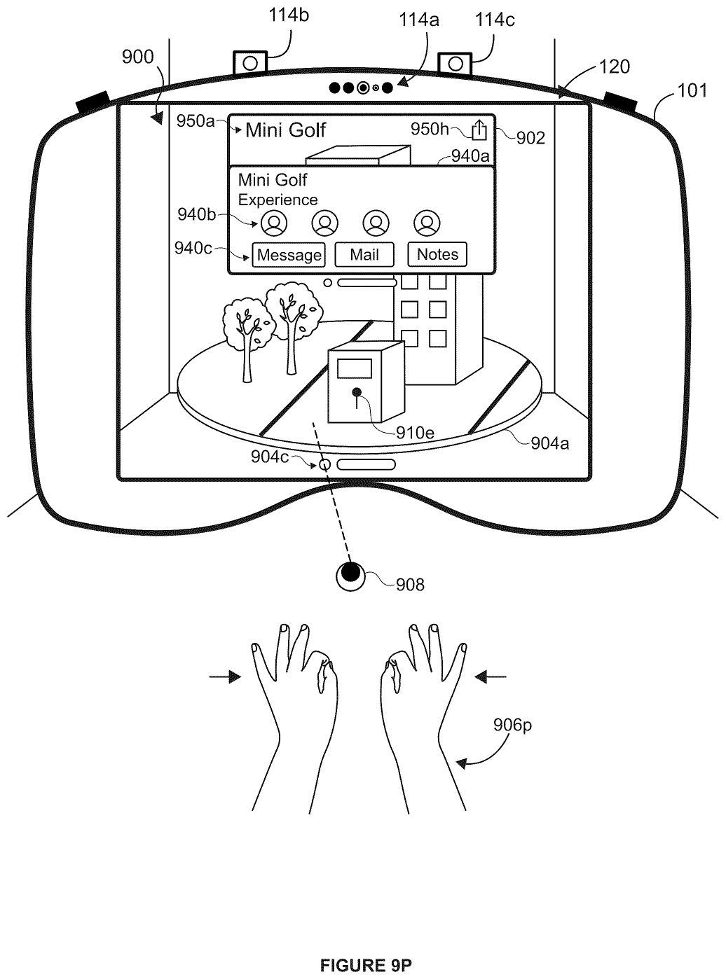

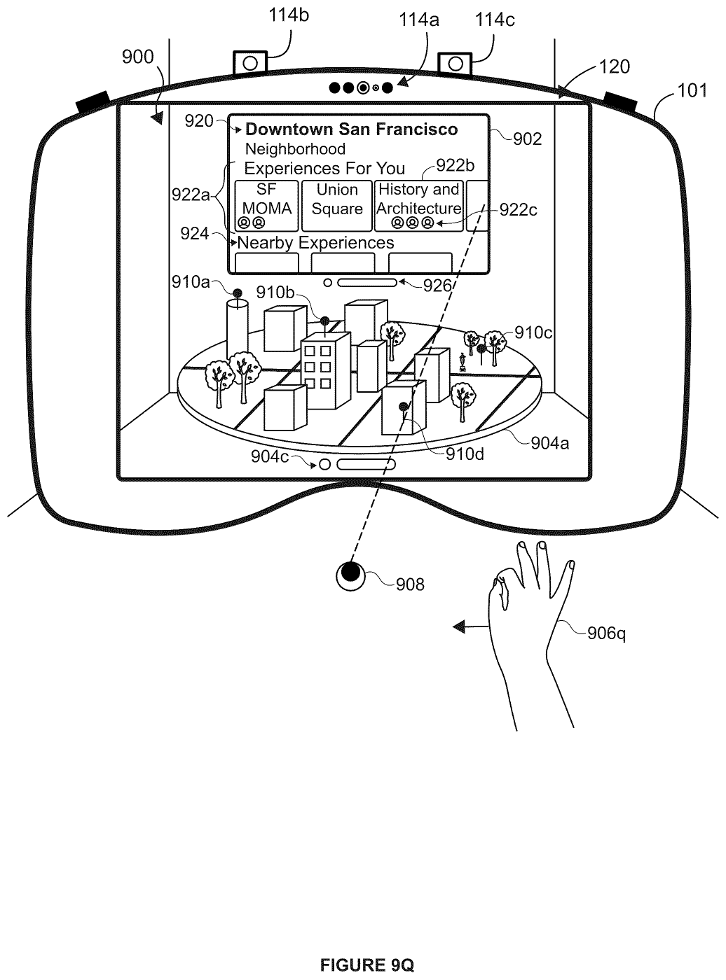

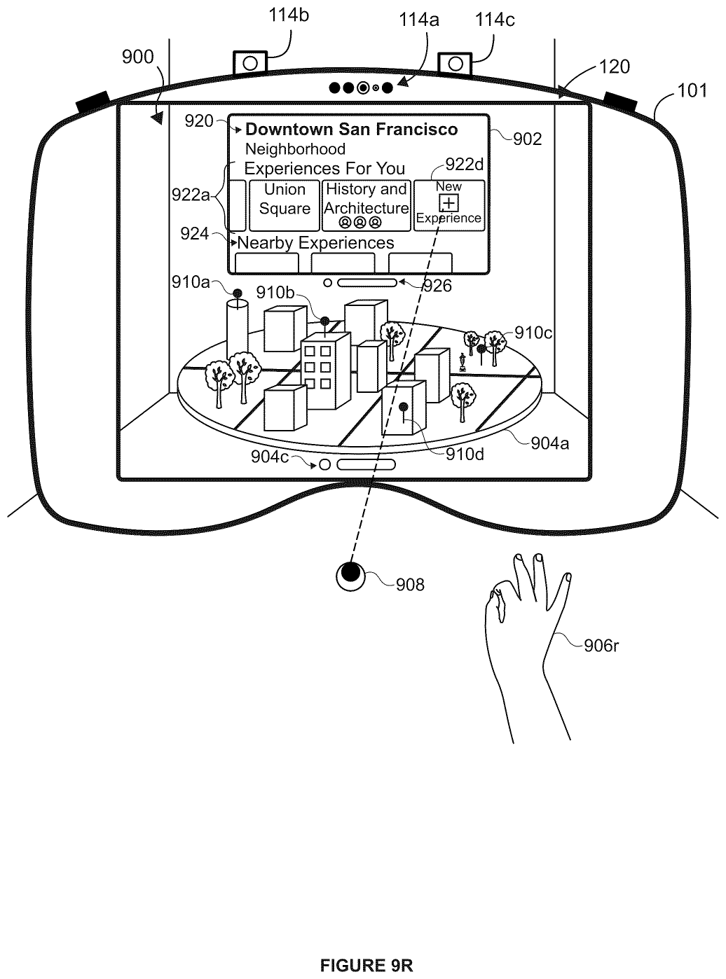

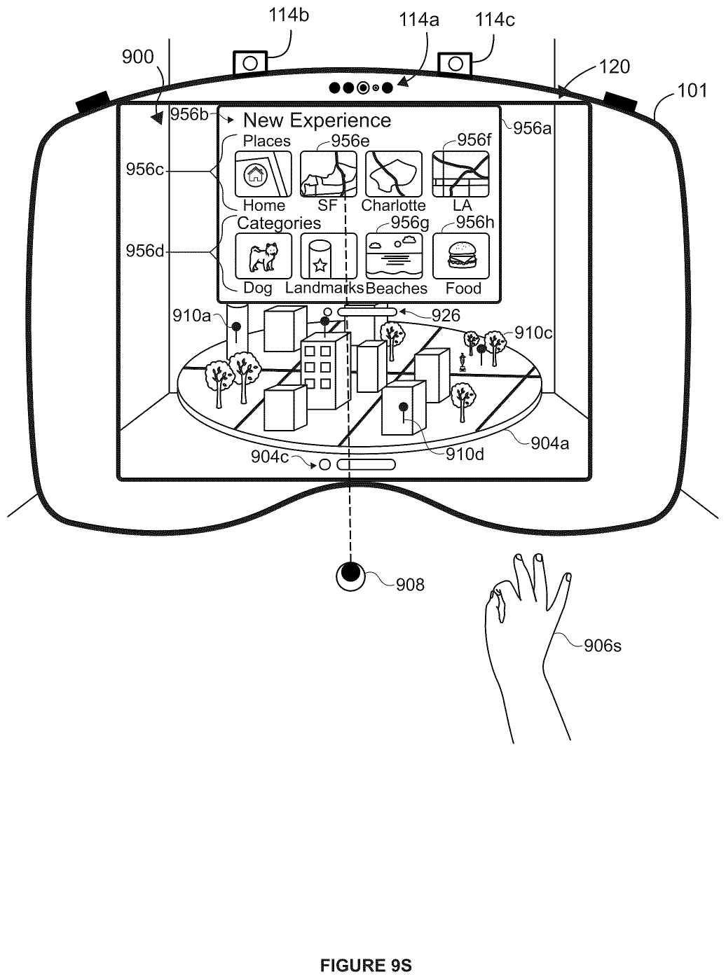

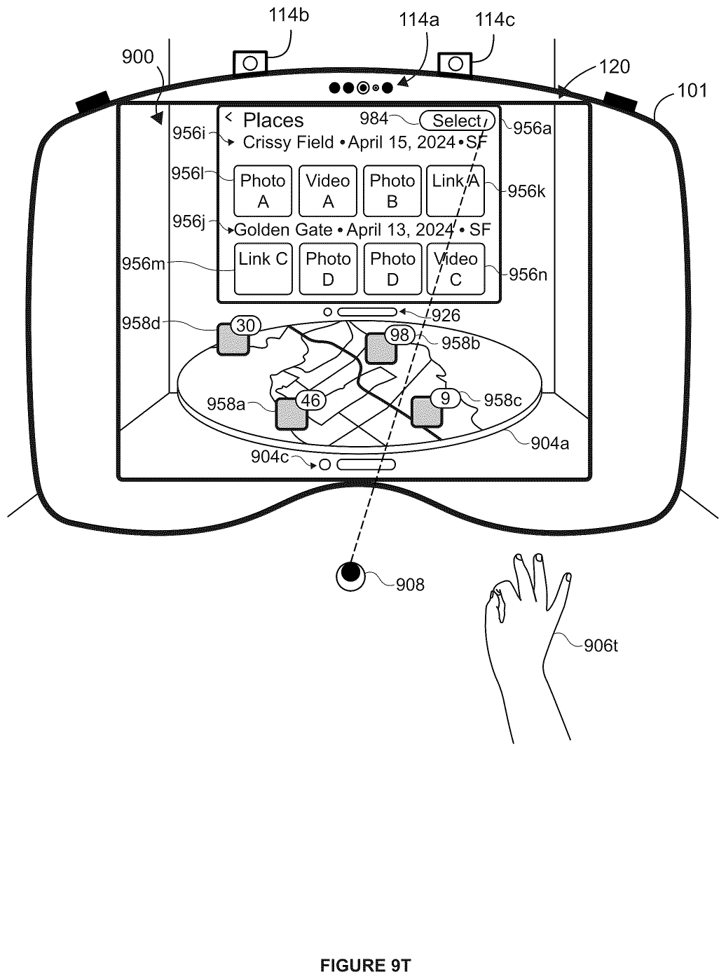

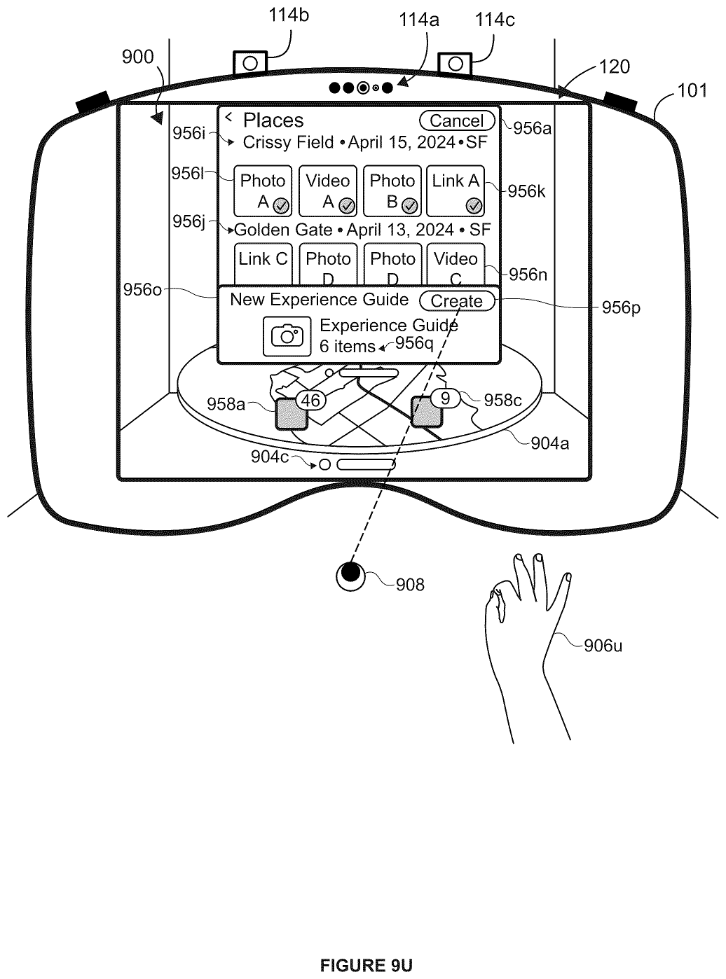

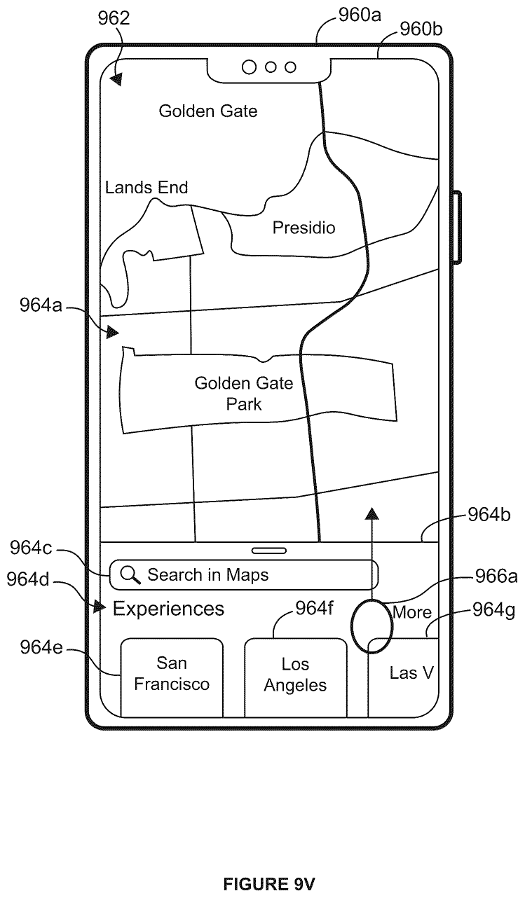

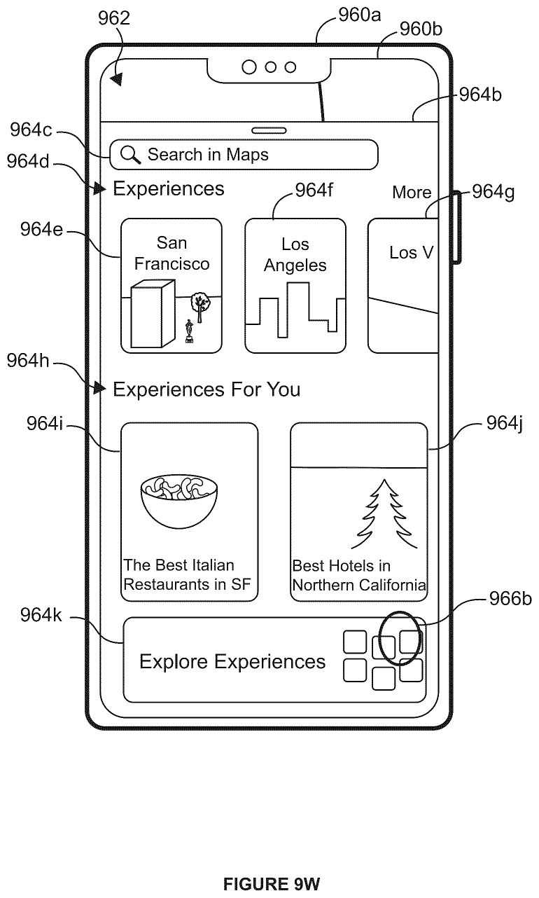

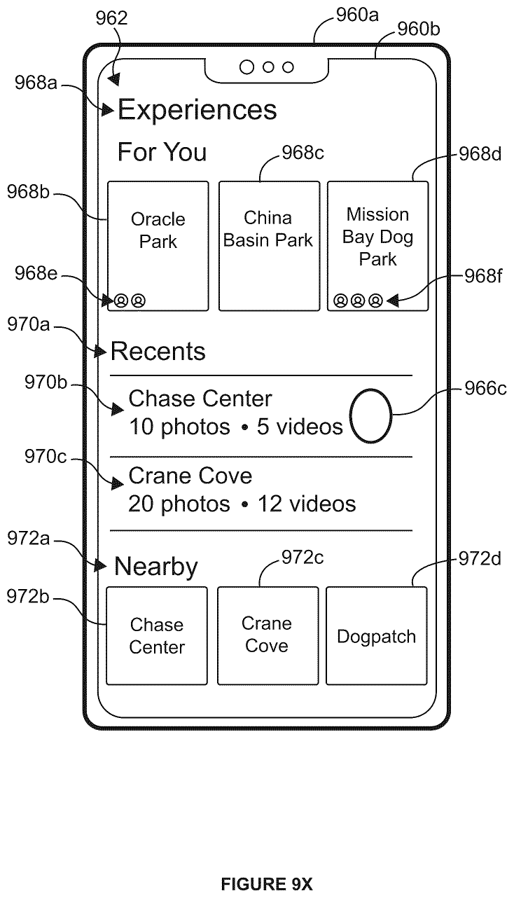

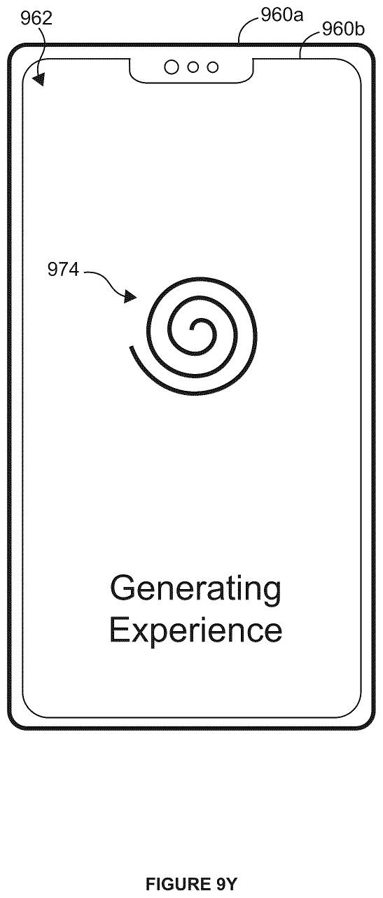

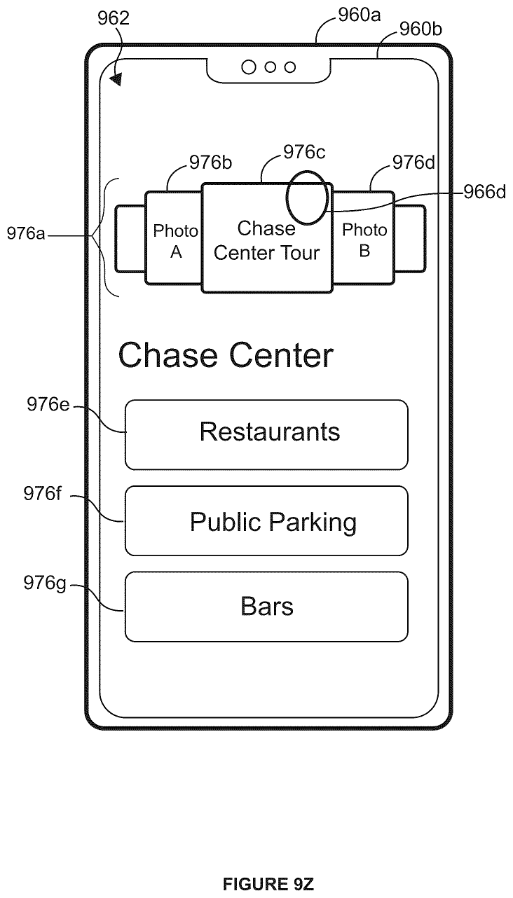

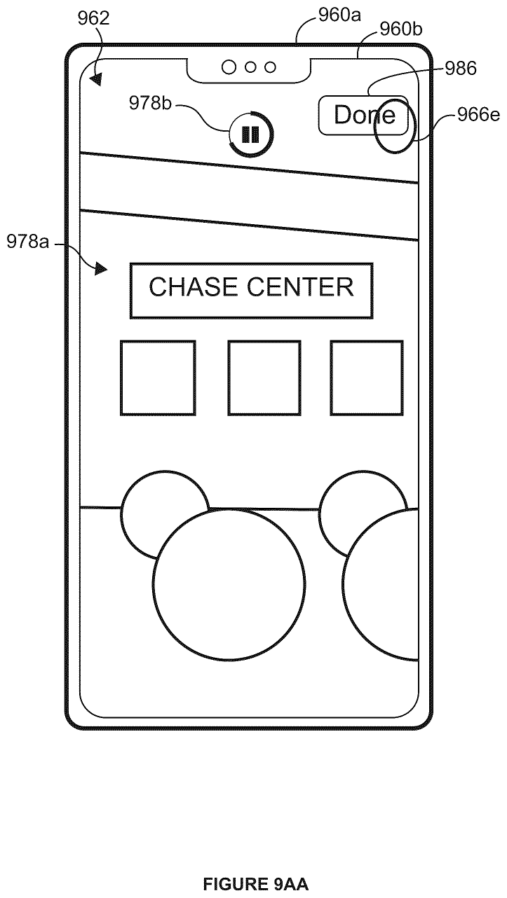

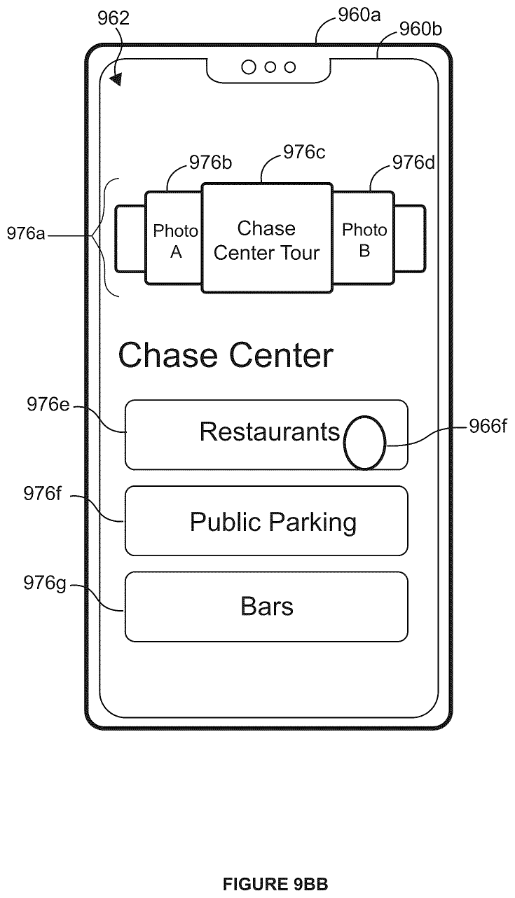

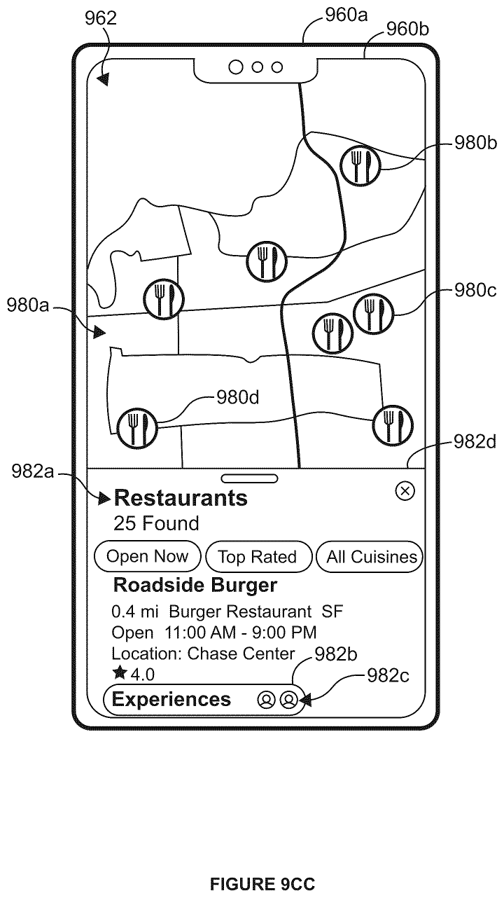

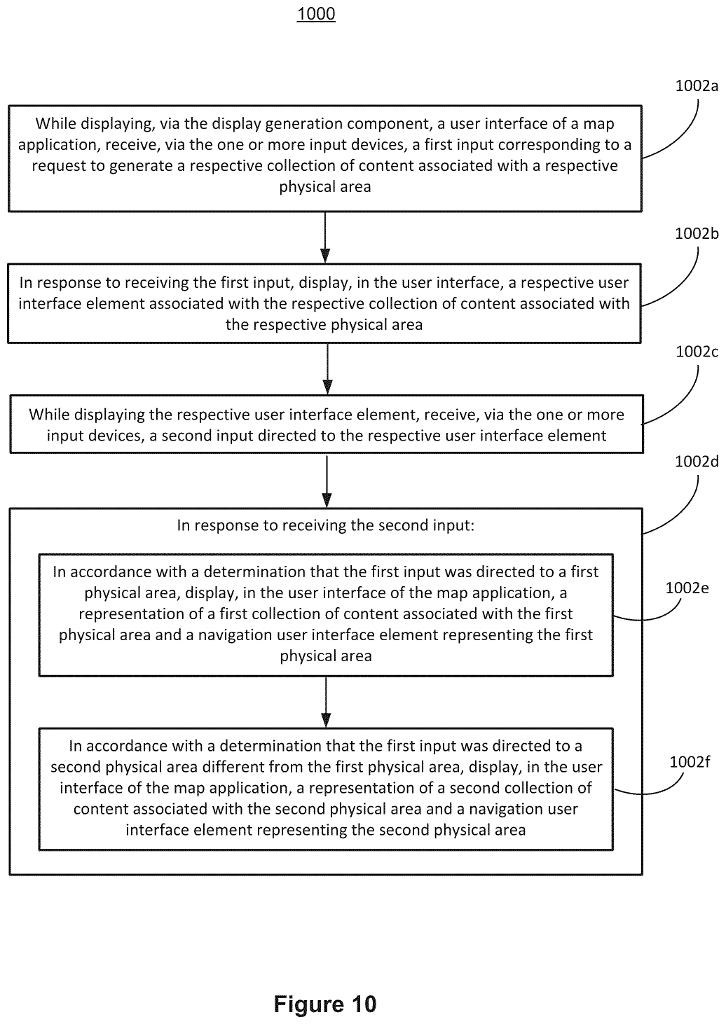

FIGS. 1-6 provide a description of example computer systems for providing XR experiences to users (such as described below with respect to methods 800 and/or 1000). FIGS. 7A-7K illustrate examples techniques for displaying one or more location experiences each associated with a physical location that, when selected by the computer system, causes the computer system to display the curated content associated with the physical location and/or display a navigation user interface element centered in on the physical location in accordance with some embodiments. FIG. 8 depicts a flow diagram of an exemplary method of displaying one or more location experiences each associated with a physical location that, when selected by the computer system, causes the computer system to display the curated content associated with the physical location and/or display a navigation user interface element centered in on the physical location in accordance with some embodiments. FIGS. 9A-9CC illustrate example techniques for displaying a collection of content associated with a physical location in response to user input corresponding to a request to generate the collection of content associated with the physical location in accordance with some embodiments. FIG. 10 depicts a flow diagram of an exemplary method of displaying a collection of content associated with a physical location in response to user input corresponding to a request to generate the collection of content associated with the physical location in accordance with some embodiments.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted display or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted display, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted display or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted display or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display.

Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

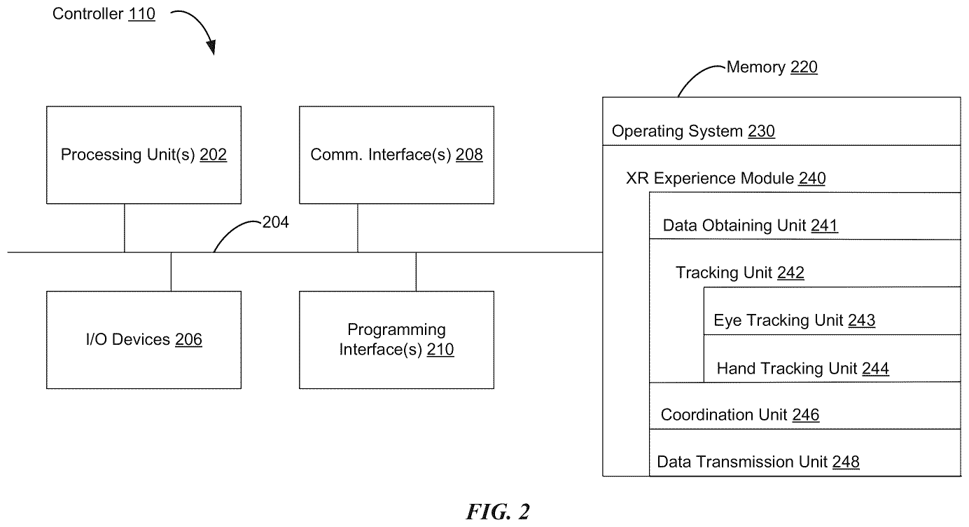

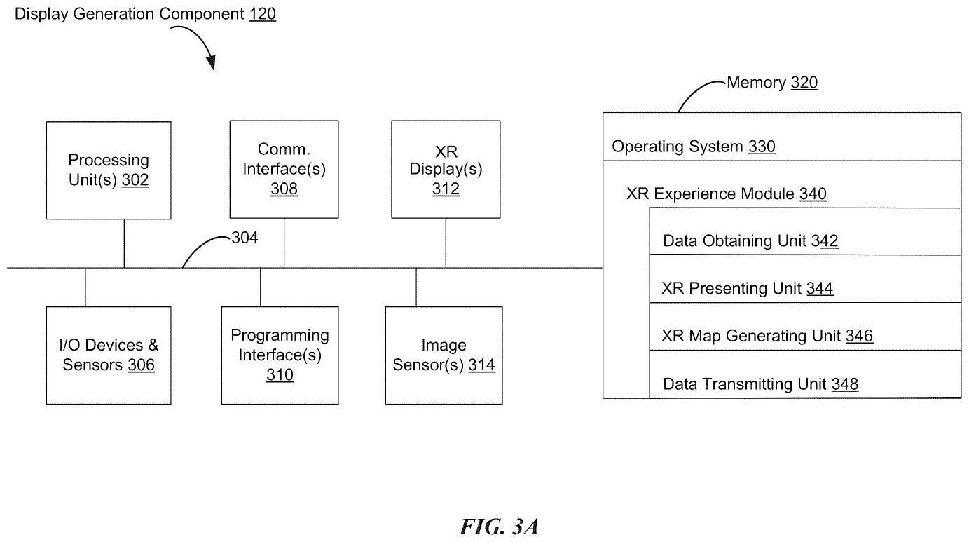

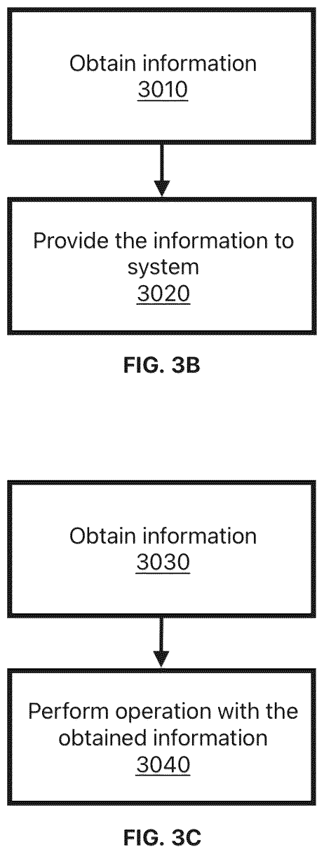

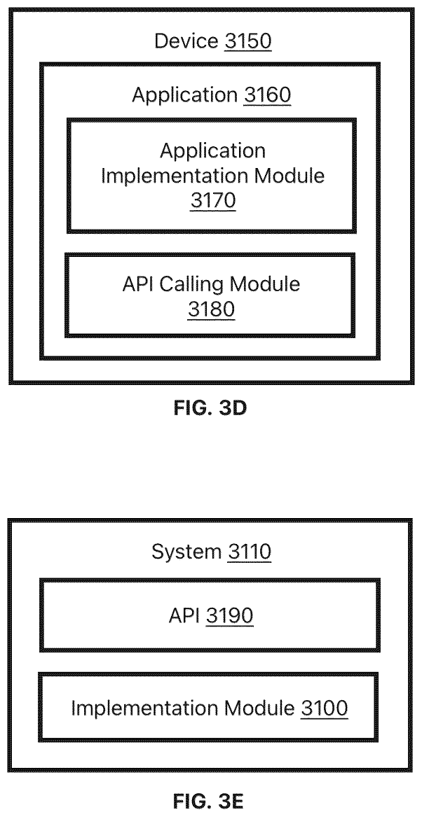

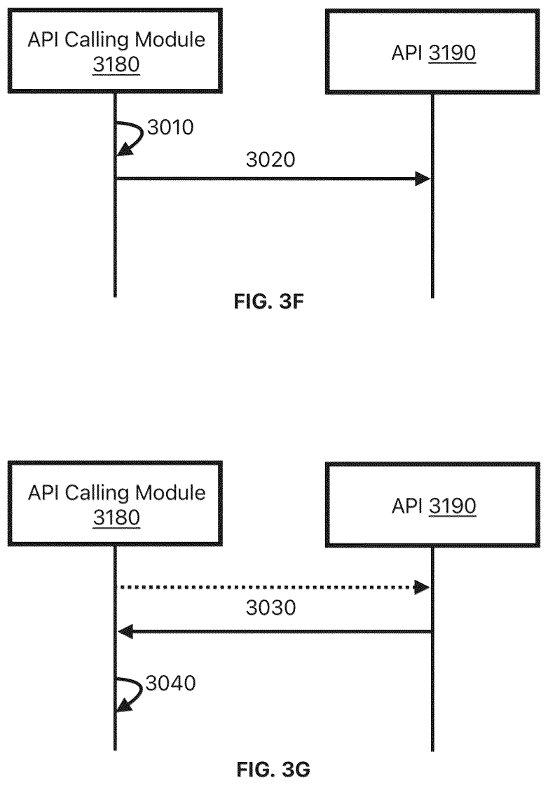

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 11) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 11) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-IF and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, IC, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 11 illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 11-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 11-1K and described herein. Likewise, any of the features, components, and/or parts, including the arrangements and configurations thereof shown and described with reference to FIGS. 11-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, cither alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

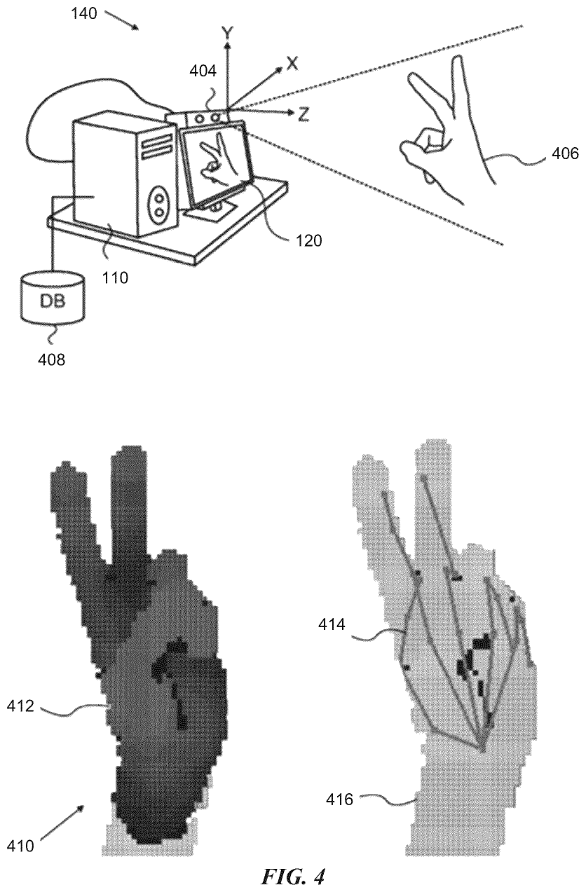

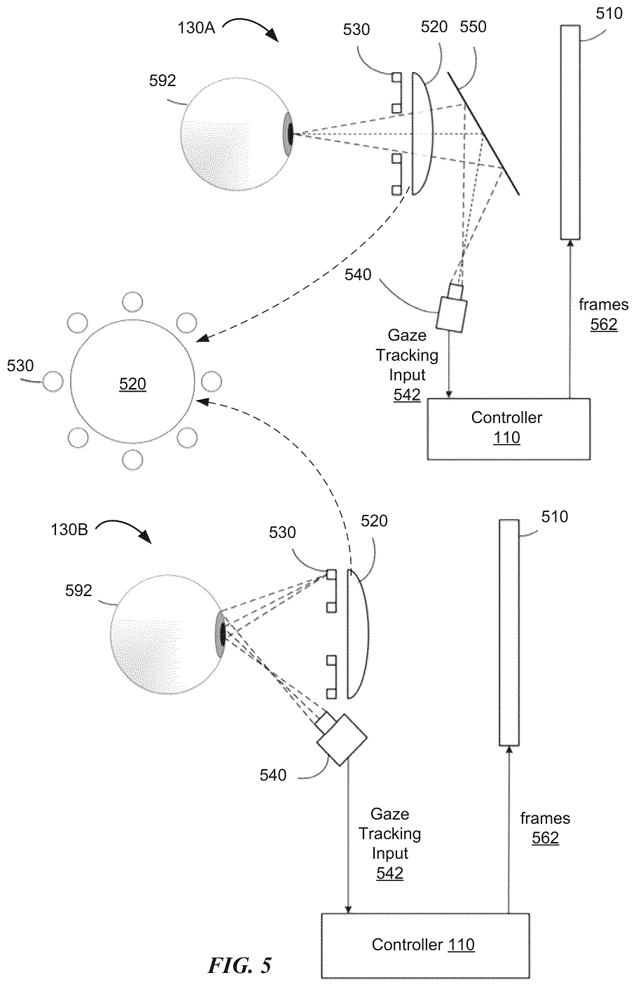

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In other embodiments, application 3160 is an application that is provided to device 3150 via an operating system update file (e.g., a first party application or a second party application). In other embodiments, application 3160 is an application that is provided via an application store. In some embodiments, the application store can be an application store that is pre-installed on device 3150 at purchase (e.g., a first party application store). In other embodiments, the application store is a third-party application store (e.g., an application store that is provided by another application store, downloaded via a network, and/or read from a storage device).

Referring to FIG. 3B and FIG. 31F, application 3160 obtains information (e.g., 3010). In some embodiments, at 3010, information is obtained from at least one hardware component of the device 3150. In some embodiments, at 3010, information is obtained from at least one software module of the device 3150. In some embodiments, at 3010, information is obtained from at least one hardware component external to the device 3150 (e.g., a peripheral device, an accessory device, a server, etc.). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on the device 3150. In some embodiments, the system (e.g., 3110 shown in FIG. 3E) is an external device (e.g., a server, a peripheral device, an accessory, a personal computing device, etc.) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and operating system (e.g., system 3110 shown in FIG. 3E). Application 3160 includes application implementation module 3170 and API calling module 3180. System 3110 includes API 3190 and implementation module 3100. It should be recognized that device 3150, application 3160, and/or system 3110 can include more, fewer, and/or different components than illustrated in FIGS. 3D and 31E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API calling module to communicate with system 3110 via API 3190 (shown in FIG. 3E).

In some embodiments, API 3190 is a software module (e.g., a collection of computer-readable instructions) that provides an interface that allows a different module (e.g., API calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In other embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is an system (e.g., operating system, server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or other hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus be both an API calling module and an implementation module. It should be recognized that implementation module 3100 can include additional functions, methods, classes, data structures, and/or other features that are not specified through API 3190 and are not available to API calling module 3180. It should also be recognized that API calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processes into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method(s) 800 and/or 1000 (FIGS. 8 and/or 10) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 3190 defines a first API call that can be provided by API calling module 3190. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

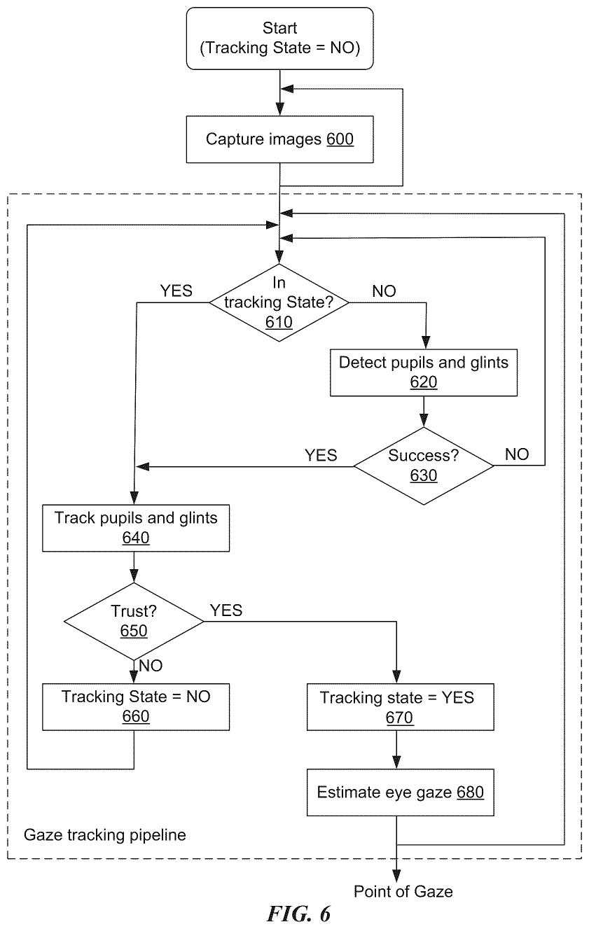

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted display or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

In some embodiments, a computer system presents curated content of a physical location within a three-dimensional environment. The curated content includes photos and/or video taken from and/or of the physical location. For example, the curated content includes video content of an aerial tour of a physical area, such as a city, neighborhood, building, or other landmark. In some embodiments, the computer system presents virtual objects representing views of the physical location from different perspectives without the need for subsequent inputs to manipulate (e.g., rotate, pan, and/or zoom in or out) a map, thus enabling a user to easily view and experience physical locations from a variety of perspectives. Enhancing interactions with a computer system reduces the amount of time needed by a user to perform operations, and thus reduces the power usage of the computer system and increases battery life for battery-powered computer system.

FIGS. 7A-7K illustrate examples of a computer system presenting one or more location experiences each associated with a physical location that, when selected by the computer system, causes the computer system to display the curated content associated with the physical location and/or display a navigation user interface element centered in on the physical location in accordance with some embodiments. The location experiences can be grouped around a single general physical area, such as a city or a neighborhood in a city (e.g., San Francisco or the mission district in San Francisco)

FIG. 7A illustrates a computer system 101 displaying, via a display generation component (e.g., display generation component 120 of FIG. 1A), a three-dimensional environment 702 from a viewpoint of a user. As described above with reference to FIGS. 1-6, the computer system 101 optionally includes a display generation component (e.g., a touch screen) and image sensors (e.g., image sensors 314 of FIG. 3). The image sensors optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user).

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 702 or portions of the physical environment are visible via the display generation component 120 of computer system 101. For example, three-dimensional environment 702 includes portions of the side and back walls, and the floor in the physical environment of the user.

In FIG. 7A, three-dimensional environment 702 also includes virtual objects, such as virtual objects 704a and 716a presented by computer system 101 that are not included in the physical environment of computer system 101. In some embodiments, virtual object 704a is a first representation of a first location experience associated with a first physical location. In some embodiments, the computer system 101 displays a plurality of first representations of respective location experiences associated with the first physical location. For example, in FIG. 7A, the computer system 101 additionally displays virtual object 706a (e.g., a first representation of a first location experience), virtual object 708a (e.g., a first representation of a second location experience), virtual object 710a (e.g., a first representation of a third location experience), and virtual object 712a (e.g., a first representation of a fourth location experience).

As discussed in method(s) 800 and displayed in FIG. 7A, the first representation of the first location experience 704a is associated with a first physical location (e.g., general vicinity, neighborhood, or district), such as a neighborhood in San Francisco. In some embodiments, the other first representations of respective location experiences (e.g., 706a, 708a, 710a, and 712a) are also associated with neighborhoods in San Francisco as described in method(s) 800. In FIG. 7A, the first representation of the first location experience 704a (e.g., for the Embarcadero neighborhood of San Francisco) includes content such as a title or description of the first location experience and an indication of one or more first representations of respective points of interest experiences 704b associated with the first location experience that, when selected, cause the computer system to change the display of virtual object 716a that will be described more with reference to at least FIGS. 7B and 7C. For example, in FIG. 7A, location experience 704a (e.g., for the Embarcadero neighborhood of San Francisco) includes a point of interest experience 704c (e.g., the Ferry Building), point of interest experience 704d (e.g., Parrot Park), point of interest experience 704e (Levi's Plaza), and point of interest experience 704f (e.g., Alcatraz Island).

In FIG. 7A, the first representation of the first location experience 704a further includes an image and/or animated image of the location experience. In some embodiments, the other first representations of respective location experiences (e.g., 706a, 708a, 710a, and 712a) have one or more characteristics similar to the first representation of the first location experience 704a. In some embodiments, the other first representations of respective location experiences (e.g., 706a, 708a, 710a, and 712a) include different content and/or points of interest from the first location experience 704a because the other first representations of respective location experiences (e.g., 706a, 708a, 710a, and 712a) are associated with different physical locations. For example, the first representation of the third location experience 710a includes one or more point of interest representations 701b of the third location experience. In another example the first representation of the fourth location experience 712a includes one or more point of interest representations 712b of the fourth location experience. In FIG. 7A, the one or more point of interest representations 704b of the location experience 704a include a visual indication of a source of the point of interest location experience that will be described below with reference to at least FIG. 7C.

As mentioned above, in FIG. 7A, the computer system 101 displays virtual object that is a navigation user interface element 716a which includes representations of the physical location including physical objects (e.g., points of interest) associated with the first location experience 704a (e.g., buildings, landmarks, buildings, landmarks, parks, and/or lanes of roads, trees). In FIG. 7A, the navigation user interface element 716a further includes the one or more points of interest representations of the first location experience 704a (e.g., representations 704c, 704d, 704e, and 704f) at respective locations in the navigation user interface element 716a corresponding to respective views and/or respective physical locations associated with the first location experience 704a. For example, the computer system 101 displays the point of interest representation 704c of the first location experience 704a, that when selected changes the display of the navigation user interface element 716a that will be described in at least FIGS. 7B and 7C.

In some embodiments, the computer system 101 renders content in the navigation user interface element 716a with an orientation, size, and/or zoom level to focus on an area and/or location of the map that corresponds to the respective location experience (e.g., 704a). In FIG. 7A, the computer system 101 detects user input 714a (e.g., finger of hand touching a trackpad, an air swipe gesture, air pinch gesture and/or air tap gesture from hand) corresponding to a request to navigate away from the first representation of the first location experience 704a to another first representation of a respective location experience. The computer system 101 may detect user input 714a while optionally attention/gaze of the user of the computer system 101 is directed to the first representation of the first location experience 704a. In response to detecting user input 714a corresponding to a request to navigate away from the first representation of the first location experience 704a to another first representation of a respective location experience (e.g., swipe gesture to view another first representation of a respective location experience) the computer system 101 changes the content of navigation user interface element 716a in FIG. 7B to include content associated with the respective location experience 706a instead of location experience 704a.

From FIG. 7A to FIG. 7B, in response to detecting user input 714a directed to a request to navigate away from location experience 704a, the computer system 101 changes from displaying the first representation of the first location experience 704a as selected with increased visual prominence relative to the other first representations of respective location experiences (e.g., 706a, 708a, 710a, and 712a) to displaying the first representation of the second location experience 706a as selected with increased visual prominence relative to the other first representations of respective location experiences (e.g., 704a, 708a, 710a, and 718a). In FIG. 7B, the computer system also navigates (or scrolls) through the representations of respective location experiences to reveal representation 718a that was not previously displayed prior to detecting the user input 714a. The computer system 101 also changes from displaying content in navigation user interface element 716a associated with the first representation of the first location experience 704a to displaying content in the navigation user interface element 716a associated with the first representation of the second location experience 706a. In some embodiments, the computer system tilts, rotates, re-sizes, and/or changes a position/orientation of content in navigation user interface element 716a such that the content in navigation user interface element 716a is centered on an area and/or location associated with the location experience (e.g., without changing the viewpoint of the user of the computer system) as described with reference to method(s) 800.

In FIG. 7B, the computer system 101 displays the content in navigation user interface element 716a including the one or more representations of points of interest experiences (e.g., representations 706c, 706d, 706e, and 706f) at respective locations in the navigation user interface element 716a corresponding to respective views and/or respective physical locations associated with the points of interest experiences. For example, the computer system 101 displays a first representation of a first point of interest experience 706c corresponding to Oracle Park. In another example, the first representation of a second point of interest 706f corresponds to a tower in downtown San Francisco. The first representation of a third point of interest 706e corresponds to Parrot Park and the first representation of a fourth point of interest 706d corresponds to the Ferry Building. In some embodiments, the computer system 101 displays the content in navigation user interface element 716a at a greater zoom level. For example, in some embodiments, the computer system 101 detects user input 714b (e.g., an input similar to or corresponding to the input 714a described above) corresponding to a request to zoom in on the content displays via the navigation user interface element 716a. In response to receiving user input 714b, the computer system 101 changes the display of the content in navigation user interface 716a, for example, as shown in FIG. 7C. For example, in FIG. 7C the computer system 101 zooms in on a portion of the content in navigation user interface 716a to display a more detailed view of the physical location associated with the first experience. For example, the content displayed by navigation user interface 716a includes a neighborhood (e.g. Mission Bay) that neighbors the physical location associated with the first location experience (e.g., Downtown San Francisco).

In FIG. 7C, the computer system 101 displays the content in navigation user interface element 716a to include one or more first representations of points of interest in the physical location associated with the first location experience (e.g., representations 706c, 706d, 706e, and 706f) at respective locations in the navigation user interface element 716a corresponding to respective views and/or respective physical locations associated with the first location experience 706a at a zoom level greater than the content of navigation user interface element 716a shown in FIG. 7B. For example, the first representation of the first point of interest 706c corresponds to Oracle Park that was previously included in the content displayed by navigation user interface element 716a. Navigation user interface element 716 also includes a first representation of a second point of interest 706d corresponding to a restaurant, a first representation of a third point of interest 706e corresponding to a hospital, and a first representation of a fourth point of interest 706f corresponding to a hotel. In some embodiments, at the zoom level shown in FIG. 7C, the computer system displays a visual indication of the sources that provided curated content corresponding to the first representation of the point of interest experience 706c In FIG. 7C, the first point of interest representation 706c includes a visual indication 706h and a visual indication 706g. The visual indication 706h is associated with a different source from the source associated with visual indication 706g. For example, visual indication 706h includes a representation (e.g., an avatar or photo or other content) of a friend of the user of the computer system 101. The visual indication indicates that a friend of the user provided (or recommended) the point of interest information associated with point of interest experience 706c. When representation 706h is selected, the computer system displays curated content of the point of interest experience provided by the friend represented by 706h. The visual indication 706g includes an icon or photo of a travel magazine. The visual indication indicates that a travel magazine provided (or recommended) point of interest information associated with point of interest experience 706c. When representation 706g is selected, the computer system displays curated content of the point of interest experience provided by the travel magazine. Other sources are displayed and are described in method(s) 800.

In FIG. 7C, the computer system 101 displays a second representation 722 of the first location experience including a video of the respective location experience associated with the content displayed in navigation user interface element 716a. In some embodiments, the representation 722 of video of the respective location experience includes animation of a portion of an aerial tour of the physical location associated with the respective location experience (e.g., an aerial tour of Mission Bay) In FIG. 7C, the computer system 101 can further display visual indication 720 of the respective viewpoint at a location relative to the navigation user interface element 716a. The computer system displays visual indication 720 at a position within the three-dimensional environment 702 relative to the navigation user interface element that corresponds to the viewpoint shown by the representation 722 of video of the respective location experience. (e.g., the visual indication is located in a position relative to the content displayed in navigation user interface element 716a corresponding to the respective view displayed by the video.

In some embodiments, the computer system 101 detects user input 714c (e.g., an input similar to or corresponding to the input 714a described above) directed to the first representation of the point of interest experience 706c. In response to receiving user input 714c directed to the first representation of a point of interest experience 706c, the computer system 101 changes the display of the content of navigation user interface 716a as shown in FIG. 7D. For example, in FIG. 7D the computer system 101 zooms in on a portion of the content in navigation user interface 716a to display a view of a particular landmark (e.g., baseball stadium Oracle Park) associated with the first point of interest experience 706c. In FIG. 7D, the view displayed in the navigation user interface 716a is more focused, centered on the landmark than the view displayed in the navigation user interface 716a in FIG. 7C.

In FIG. 7D, the computer system 101 displays the first representation of the point of interest experience 706c similarly to previously described herein. In some embodiments, the computer system ceases to display representations 706d, 706c, and 706f because, based on the view and/or zoom level, the area displayed in the navigation user interface 716a does not include respective locations corresponding to the representations 706d, 706e, and 706f. Accordingly, the view displayed in the navigation user interface 716a is not obstructed by the other representations of the respective points of interest experiences. In FIG. 7D, the computer system displays the representation 744 of video of the respective point of interest experience 706a as described with reference to FIG. 7C. The computer system 101 also displays visual indication 720 at a different position from the position of visual indication 720 shown in FIG. 7C to a position relative to the navigation user interface element 716a that corresponds to the viewpoint shown by the representation 722 of video of the second location experience. In some embodiments, the position of the visual indication 720 changes based on the zoom level and pan of the perspective view shown in navigation user element 716a.

In some embodiments, the computer system 101 detects user input 714d (e.g., an input similar to or corresponding to the input 714a described above) directed to the representation of video 724 of the point of interest experience 706c. In response to receiving user input 714d directed to the representation (724) of video of the point of interest experience 706c, the computer system 101 plays the video 724 of the point of interest experience in FIG. 7E. In some embodiments, the video 724 includes aerial tours, panoramas, photos, audio, animations, and/or other curated content corresponding to the second location experience. For example, the video 724 when played by the computer system 101 includes an aerial tour of the baseball stadium Oracle Park in San Francisco. In FIG. 7E, the computer system 101 also displays video control option 728 that, when selected, causes the computer system 101 to pause the video. In some embodiments, the computer system 101 also provides another video control option to skip ahead/rewind the video and/or scrub backwards and forwards. The computer system 101 also displays video control option 726 that, when selected, causes the computer system 101 to close or exit out of playing the video 724. The computer system 101 also displays visual indication 720 moving within the three-dimensional environment relative to the navigation user interface element 716a in FIG. 7E. For example, the computer system 101 optionally changes the position and/or orientation of the visual indication 720 to correspond to a respective viewpoint shown in the video 724 as the video 724 plays/progresses. For example, from FIG. 7D to 7E, the computer system displays visual indication 720 at different positions in the navigation user interface element 716a. In FIG. 7E, the computer system displays the visual indication 720 closer to the baseball stadium and with a position and/or orientation that corresponds to the position and/or orientation of the respective viewpoint shown in the video 724 associated with the second location experience. In some embodiments, while playing the video 724, the computer system optionally displays the content of navigation user interface element 716a with a size smaller than a size of the navigation user interface element 716a when the video 724 is not playing. In FIG. 7E, the computer system 101 detects user input 714e (e.g., an input similar to or corresponding to the input 714a described above) directed to the video control option 726. In response to receiving user input 714e directed to the video control option 726, the computer system 101 changes the display of the content in navigation user interface 716a. For example, in FIG. 7F the computer system 101 returns to the previous view displayed by the navigation user interface 716a in FIG. 7D.

In FIG. 7F, the computer system 101 detects user input 714f (e.g., an input similar to or corresponding to the input 714a described above) corresponding to a request to zoom out and rotate the content of navigation user interface element 716a. In response to detecting the user input 714f, the computer system 101 displays the content of navigation user interface element 716a representing a rotated and zoomed out view of an area associated with the first representation of the first location experience 704a as shown in FIG. 7G. For example, the computer system displays the content of navigation user interface element 716a including the one or more point of interest representations (e.g., representations 704c, 704d, 704c, and 704f) of the first location experience 704a at respective locations in the navigation user interface element 716a corresponding to respective views and/or respective physical locations associated with the location experience 704a. The representations 704c, 704d, 704c, and 704f displayed in FIG. 7G have one or more same characteristics and/or correspond to the representations 704c, 704d, 704c, and 704f displayed in FIG. 7G displayed in FIG. 7A.

In FIG. 7G, the computer system 101 detects user input 714g (e.g., an input similar to or corresponding to the input 714a described above) corresponding to a request to zoom in and rotate the navigation user interface element 716a. In response to detecting the user input 714g, the computer system 101 displays the content of the navigation user interface element 716a representing a rotated and zoomed in view such that the content of the navigation user interface element 716a includes a view of a particular landmark (e.g., Ferry Building in San Francisco) associated with the first location experience as shown in FIG. 7H. In FIG. 7H, the view displayed by the navigation user interface 716a is more focused, centered on the landmark than the view displayed by the navigation user interface 716a in FIG. 7G.

In FIG. 7G, the computer system 101 displays the navigation user interface element 716a including one or more first representations of respective points of interest experiences (e.g., representations 732a and 732b) at respective locations in the navigation user interface element 716a corresponding to respective views and/or respective physical locations of points of interest associated with the first location experience. The representations 732a and 732b displayed in FIG. 7H have one or more same characteristics to the representations 706c, 706d, 706e, and 706f displayed in FIG. 7C. FIG. 7H also includes a second representation of the point of interest (e.g., Ferry Building) including a video 748 of the point of interest and a changed position of the visual indication 720 to correspond to the respective viewpoint shown in the representation of video 748 of the point of interest 732a as described in more detail with reference to method 800. In some embodiments, the computer system 101 displays navigation user interface element 716a including a representation of a point of interest 730a. The second representation of the point of interest 730a in FIG. 7H is associated with a business and is a type of business experience. The representation of the point of interest 730a includes content related to the business and one or more options 730b, that when selected, causes the computer system 101 to communicate with the business and launch a webpage of the business, respectively.

In some embodiments, the computer system 101 detects user input 714h (e.g., an input similar to or corresponding to the input 714a described above) directed to the point of interest 730a. In response to receiving user input 714h directed to the point of interest 730a, the computer system 101 changes the display of the navigation user interface 716a to display a map of the business, in this case, a map 738 of a hotel as shown in FIG. 7I. In FIG. 7I, the map 738 of the hotel includes representations 740a, 740b, 740c, and 740d that correspond to locations of the pool, gym, reception, and dining of the hotel, respectively. In FIG. 7I, the computer system 101 displays a representation 722 of video of the hotel location experience (e.g., reception/lobby). In some embodiments, the representation 722 of video of the second location experience includes a walking tour of the hotel location experience. In some embodiments, the computer system 101 also displays video control option 736b that, when selected, causes the computer system 101 to pause the video. The computer system 101 also displays option 736a that, when selected, causes the computer system 101 to display a menu of actions that can be performed while interacting the hotel location experience. For example, the computer system 101 receives user input 714i (e.g., an input similar to or corresponding to the input 714a described above) directed to the option 736a corresponding to a request to navigate to the pool location. In response to the receiving user input 714i, the computer system 101 changes the display of the representation 722 of the video of the second location experience to display the representation of the video of pool location experience 734 in FIG. 7J which includes a walking tour of the pool location experience.

In FIG. 7J, the computer system 101 also changes the map 738 to indicate interaction with the pool location 740a. For example, as shown in FIG. 7J, the computer system 101 displays the portion of the map associated with the pool location 740a at a different color than the color used in FIG. 7I for the pool location 740a. In some embodiments, additionally or alternatively, the computer system 101 changes another visual characteristic of the pool location 740a, such as opacity, size, line style, and/or a location of an icon in the map 738. In some embodiments, in response to receiving user input corresponding to a request to add an annotation to the representation of the video of pool location experience 734, the computer system displays the representation of the video of pool location experience 734 including a representation 742 of the annotation. The computer system 101 also displays video control option 736a that, when selected, causes the computer system 101 to close or exit out of the representation of the video of pool location experience 734.

In FIG. 7J, the computer system 101 detects user input 714j (e.g., an input similar to or corresponding to the input 714a described above) directed to video control option 736a. In response to detecting the user input 714j, the computer system 101 navigates away from the hotel location experience to the point of interest experience shown in FIG. 7K that is similar and/or corresponds to the point of interest experience in FIG. 7H. In FIG. 7K, the computer system 101 displays an updated point of interest 730a to include option 730c, which indicates that the point of interest experience includes an annotation added by the user of computer system 101. In some embodiments, in response to receiving an input selecting option 730c, the computer system 101 displays the representation of the video of pool location experience 734 including a representation 742 of the annotation in FIG. 7J.

FIG. 8 is a flowchart illustrating an exemplary method of displaying curated content of a physical location within a three-dimensional environment in accordance with some embodiments.

In some embodiments, method 800 is performed at a computer system (e.g., 101) in communication with a display generation component (e.g., 120) and one or more input devices (e.g., 314). For example, the computer system is or includes a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, or a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the computer system displays (802a), via the display generation component, a user interface that includes a first representation of a first location experience and a first portion of a navigation user interface element with a first orientation that includes a first representation of a first point of interest associated with the first location experience (e.g., in a three-dimensional environment), such a three-dimensional environment 702 that includes first representation 704a and navigation user interface element 716a including first representation 704c of a point of interest in FIG. 7A. For example, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, a physical environment surrounding the display generation component is visible through a transparent portion of the display generation component (e.g., true or real passthrough). In some embodiments, a representation of the physical environment is displayed in the three-dimensional environment via the display generation component (e.g., virtual or video passthrough). In some embodiments, the computer system displays the user interface and the navigation user interface element in the three-dimensional environment that is in the field of view of a user of the computer system from a viewpoint of the user of the three-dimensional environment.

In some embodiments, the user interface is a user interface of a map application. In some embodiments, the user interface is a user interface of an application other than the map application, such as a media content application or a travel guide application. In some embodiments, the first location experience includes curated content of a location or geographical feature. The first location experience optionally includes a first capture position where the curated content was captured (e.g., aerial, street-level, satellite, a combination thereof, or other view). In some embodiments, the curated content includes a three-dimensional or panoramic representation of the location or the geographic feature. For example, the curated content includes aerial tours, panoramas, photos, videos, audio, and/or animations of a geographical feature, such as a beach, a mountain, a river, a lake, an island, a rainforest, a lake, or any other geographical feature. In some embodiments, the first location experience includes a location or place, such as a neighborhood, a city, a restaurant, a hotel, a park, an attraction, a bridge, a building, or any other point of interest. In some embodiments, the curated content is selected and/or arranged by a third party (e.g., travel guides, lifestyle magazine, and/or media and entertainment network), individuals (e.g., family, friends, coworkers, and/or social media marketers), and/or an application on the computer system (e.g., photo management application, map application, and/or digital media player application). In some embodiments, the first representation includes text, affordances, virtual objects, that when selected, causes the computer system to display a respective portion of the navigation user interface element as described herein. In some embodiments, the navigation user interface element includes a three-dimensional topographical map of a physical location associated with the first location experience. For example, the navigation user interface element optionally includes a three-dimensional topographical map of a city including three-dimensional representation of buildings, streets, and other landmarks including the first representation of a first point of interest associated with the first location experience.

In some embodiments, the navigation user interface element is oriented along a horizontal surface in the three-dimensional environment or floating along a horizontal plane and the user interface that includes the first representation of the first location experience is oriented vertically. In some embodiments, the computer system will change the display of the navigation user interface element (e.g., rotate, re-size, and/or tilt) and/or render the respective portion of the navigation user interface element at a zoom level to focus on an area and/or location of the map that corresponds to the first location experience. In some embodiments, the navigation user interface element is a two-dimensional map of the physical location associated with the first location experience. In some embodiments, the first representation of a point of interest experience includes a flag, pin, affordance, virtual object, or other visual indication displayed at the first location on and/or relative to the topographical map corresponding to an address, landmark, neighborhood, geographical feature, or coordinates in the city. In some embodiments, the user interface includes a plurality of first representations of the first location experience and a plurality of first representations of points of interest associated with the first location experience. In some embodiments, the user interface includes a plurality of location experiences different from the first location experience. In some embodiments, the plurality of location experiences is associated with respective first representations and representations of points of interest (e.g., displayed on and/or relative to the topographical map).

In some embodiments, while displaying, via the display generation component, the user interface (802b), the computer system detects (802c), via the one or more input devices, a first input directed to the first representation of the first location experience, such as input 714a directed to first representation 704a in FIG. 7A. For example, the computer system optionally detects user input (e.g., a gaze of the user, a contact on a touch-sensitive surface, actuation of a physical input device, a predefined gesture (e.g., pinch gesture or air tap gesture) and/or a voice input from the user) corresponding to (optionally selection of) the first representation of the first location experience.

In some embodiments, while displaying, via the display generation component, the user interface (802b), in response to detecting the first input (802d), the computer system changes (802c) the display of the navigation user interface element from the first orientation to a second orientation corresponding to the first location experience, such as shown by navigation user interface element 716a in FIG. 7A and navigation user interface element 716a in FIG. 7B, respectively.

In some embodiments, while displaying, via the display generation component, the user interface (802b), in response to detecting the first input, the computer system displays (802f) the navigation user interface element to include a second portion, different from the first portion and associated with the first location experience such as shown by navigation user interface element 716a in FIG. 7A and navigation user interface element 716a in FIG. 7B, respectively. For example, changing the display of the navigation user interface element from the first orientation to the second orientation corresponding to the first location experience includes rotating, re-sizing, and/or tilting the navigation user interface element from the horizontal plane such that the navigation user interface element is centered on an area and/or location associated with the first location experience (e.g., without changing the viewpoint of the user of the computer system). In some embodiments, the second portion includes the area and/or location associated with the first location experience at a zoom level (e.g., greater or less) than the first portion associated with the navigation user interface element before detecting the first input. In some embodiments, the second portion includes a larger or smaller area than the first portion. Changing the display of the navigation user interface element to center in on a location associated with the first location experience provides quick display of the location corresponding to the first location experience without requiring the user to provide further inputs to pan and/or zoom to the location corresponding to the first location experience, thereby reducing the number of inputs and providing more efficient interactions between the user and the computer system.

In some embodiments, while displaying the navigation user interface element, the computer system displays, via the display generation component, a second representation of the first location experience that includes animated content, such as representation 722 in FIG. 7C. In some embodiments, the computer system displays the second representation of the first location experience including animated content, text, affordances, virtual objects, and/or user interface elements. In some embodiments, the animated content includes aerial tours, panoramas, photos, videos, audio, animations, and/or other curated content corresponding to the first location experience. In some embodiments, the computer system displays a second representation of a point of interest associated with the first location experience. In some embodiments, the second representation of the point of interest has one or more characteristics as the second representation of the first location experience that includes animated content.

In some embodiments, the computer system receives, via the one or more input devices, an input (e.g., an input similar to or corresponding to the first input described above) selecting the second representation of the first location experience, such as input 714c directed to representation 722 in FIG. 7D. In some embodiments, in response to receiving the input selecting the second representation of the first location experience, the computer system displays, via the display generation component, the first location experience, such as representation 724 in FIG. 7E. In some embodiments, displaying the first location experience includes causing playback of the animated content. In some embodiments, displaying the first location experience does not include causing playback of the animated content. For example, displaying the first location experience includes displaying a preview of the animated content (e.g., video clip preview of an aerial tour). In some embodiments, displaying the first location experience includes causing playback of the preview of the animated content (e.g., video preview of the aerial tour). In some embodiments, the computer system displays the second representation of the first location experience that includes animated content in response to detecting the first input directed to the first representation of the first location experience (e.g., user interface element associated with the first representation) or the first representation of a first point of interest associated with the first location experience. In some embodiments, the computer system replaces the first representation with the second representation in response receiving the input selecting the second representation of the first location experience (e.g., displays the second representation instead of the first representation). In some embodiments, the computer system displays the second representation as overlaid on (or optionally proximate to) the first representation in response receiving the input selecting the second representation of the first location experience. In some embodiments, the computer system changes the display of the navigation user interface element such that the navigation user interface element is centered on an area and/or location associated with the first location experience (e.g., without changing the viewpoint of the user of the computer system) in response receiving the input selecting the second representation of the first location experience. For example, the computer system zooms in on a portion of the navigation user interface element to display a more detailed representation and/or view of the physical location associated with the first location experience than the representation of the physical location associated with the first location prior to receiving the input selecting the second representation of the first location experience. In some embodiments, the computer system changes the display of the first representation of a first point of interest associated with the first location experience to indicate a source of the photos, videos, and/or other curated content associated with the first location experience. For example, the computer system displays the first representation of a point of interest experience including buttons, icons, affordances, or any other selectable virtual object or element corresponding to sources of the curated content associated with the first location experience. In some embodiments, the computer system displays a second representation of the point of interest that includes animated content associated with the point of interest. In some embodiments, the second representation of the point of interest has one or more characteristics as the second representation of the first location experience. Displaying a second representation of the first location experience that includes animated content associated with the first location experience provides an efficient way of viewing additional content corresponding to the first physical location without having to leave the navigation user interface, thereby reducing the need for subsequent inputs to search for additional content corresponding to the first physical location which simplifies the interaction between the user and the computer system and enhances the operability of the computer system and makes the user-computer system interface more efficient.

In some embodiments, while displaying the first location experience (e.g., while the animated content associated with the first location experience is playing), the computer system displays a first selectable option (e.g., button, icon, widget, affordance, control element, virtual object, or any other selectable object), such as option 728 in FIG. 7E. In some embodiments, while the first location experience is playing, the electronic device displays the first selectable option with an indication that selecting the option will pause the first location experience, such as displaying the first selectable option with an icon and/or text that indicates pausing.

In some embodiments, the computer system receives, via the one or more input devices, a second input (e.g., an input similar to or corresponding to the first input described above) directed to the first selectable option, such as option 728 in FIG. 7E. In some embodiments, in response to receiving the second input, the computer system pauses the first location experience (e.g., pausing playback of the animated content associated with the first location experience), such as shown in FIG. 7I.

In some embodiments, while the first location experience is paused, such as shown in FIG. 7I, the computer system receives, via the one or more input devices, a third input directed to the first selectable option, such as option 736b in FIG. 7I. In some embodiments, while the first location experience is paused, the computer system displays the first selectable option with an indication that selecting the option will resume playback of the first location experience, such as displaying the first selectable option with an icon and/or text that indicates playing.

In some embodiments, in response to receiving the third input, the computer system plays the first location experience, such as representation 724 in FIG. 7E. In some embodiments, in response to detecting selection of the first selectable option, the computer system changes the first selectable option from a first option that, when selected, causes the computer system to pause the first location experience, to a second option that, when selected, causes the computer system to play the first location experience. In some embodiments, the computer system changes the first selectable option from the first option to the second option or from the second option to first option when the computer system detects an input selecting the first selectable option. For example, the computer system detects the second input directed to the first selectable option while playing the animated content associated with the first location experience. In this example, in response to detecting the second input, the computer system pauses playback of the animated content and changes the playback control option to the second option. In another example, the computer system detects the second input directed to the first selectable option while playback of the animated content is paused. In this example, in response to detecting the second input, the computer system plays the animated content and changes the playback control option to the first option. Providing a selectable option to pause or play the first location experience via which the user easily changes the current control option of the selectable option improves the interaction between the user and the computer system and reduces inputs needed to pause or play the first location experience.

In some embodiments, the second representation of the first location experience includes displaying the second representation of the first location experience at a first size, such as representation 722 in FIG. 7D. For example, the computer system optionally displays the second representation of the first location experience oriented vertically in the three-dimensional environment above the navigation user interface element that is displayed as oriented along a horizontal surface in the three-dimensional environment or floating along a horizontal plane. In some embodiments, the computer system displays the second representation of the first location experience occupying a first portion of the user interface (e.g., top, bottom, left, and/or right) while the navigation user interface element is displayed as occupying a second portion of the user interface that is different from the first portion. In some embodiments, the first portion and the second portion are the same size. In some embodiments, the first portion and the second portion are different sizes.

In some embodiments, the first location experience includes displaying the first location experience at a second size greater than the first size, such as representation 724 in FIG. 7E. In some embodiments, displaying the first location experience includes displaying or playing the animated content associated with the first location experience as described above. For example, the computer system optionally displays the first location experience occupying a third portion of the user interface larger than the first portion. In some embodiments, while the computer system displays the first location experience, the computer system displays the navigation user interface element at a size smaller than the size of the navigation user interface element when the computer system displayed the second representation of the first location experience at the first size. In some embodiments, the computer system optionally displays the first location experience occupying both the first portion and the second portion of the user interface such that the navigation user interface element is no longer displayed. In some embodiments, while displaying the first location experience at the second size, the computer system displays a two-dimensional representation of the navigation user interface element at a size smaller than the first navigation user interface element when the computer system displays the second representation and/or at a size smaller than the first size of the second representation. In some embodiments, while displaying the first location experience, the computer system further displays a second selectable option that, when selected, causes the computer system to close the first location experience (e.g., cease to display the first location experience) and/or display the second representation at the first size described herein. Displaying the first location experience at a size greater than its representation and optionally greater than the navigation user interface element provides the user with visual feedback that the computer system is responsive to the user's intention to interact with the first location experience and provides clear indication that the first location experience is the focus of attention, thereby reducing the need for subsequent inputs to increase the display size and/or visual prominence of the first location experience which simplifies the interaction between the user and the computer system and enhances the operability of the computer system and makes the user-computer system interface more efficient.

In some embodiments, and in accordance with a determination that the first representation of the point of interest experience is displayed at a first location within the navigation user interface element, displaying the second representation of the first location experience includes displaying the second representation of the first location experience at a first location in the user interface associated with the first location within the navigation user interface element, such as representation 722 in FIG. 7F. For example, the computer system optionally displays the second representation and the second representation as collocated in the user interface. For example, when the computer system displays the second representation at the first location within the navigation user interface element, the computer system optionally displays the second representation at the first location that is within a threshold distance (e.g., 0.1, 0.5, 1, 5, 10, 50, 100, 200, 300, 400, 500, 600, 700, 800, 900, or 1000 centimeters) from (e.g., above, below, left of, or right of) the first location of the second representation. In some embodiments, the computer system displays the second representation including the animated content as described above and zoomed-in on or zoomed-out of the first physical location (e.g., displaying the animated content with a viewpoint from a simulated camera that captured the animated content).

In some embodiments, and in accordance with a determination that the second representation of the first location experience is displayed at a second location within the navigation user interface element different from the first location within the navigation user interface element, displaying the second representation of the first location experience includes displaying the second representation of the first location experience at a second location in the user interface associated with the second location within the navigation user interface element and different from the first location in the user interface, such as representation 722 in FIG. 7G. For example, the second location of the second representation is greater than the threshold distance from the first location of the second representation. Accordingly, the computer system displays the second representation spatially tied or linked to the second representation such that the second location of the second representation is within the threshold distance from the second location of the second representation. In some embodiments, when the computer system detects a change of the navigation user interface element (e.g., change in size, position and/or orientation in response to input to rotate, re-size, and/or tilt the navigation user interface element), the computer system displays the second representation at a location in accordance with the change of the navigation user interface element. In some embodiments, the computer system maintains the second representation at a respective location relative to their corresponding physical location in the user interface while the second representation is displayed. Updating the location of the second representation of the first location experience in accordance with the location of the second representation of the first location experience within the navigation user interface element enables a user to view both the second representation and the second representation at the same time and understand their spatial relationships, thereby reducing the need for subsequent inputs to locate and display the second representation. Providing the second representation provides quick and efficient access to relevant content without the need for additional inputs for searching for such content and avoids erroneous inputs related to searching for such content.

In some embodiments, the first representation of the first point of interest includes information associated with a physical location corresponding to the first location experience, and the computer system displays the first representation of the first point of interest, such as representation 730a in FIG. 7H. For example, the physical location is optionally a physical place, such as a neighborhood, a city, a restaurant, a hotel, a park, an attraction, a bridge, a building, or any other point of interest similar to or corresponding to the physical location described above. In some embodiments, the information associated with the physical location includes detailed information about the physical location. For example, if the physical location is a business, the information optionally includes content such as a description of the business, the hours that the business is open, an indication of costs related to the business, and/or user interface elements that, when selected, cause the computer system to communication with the business or launch a webpage of the business. In another example, if the physical location is a city, the information optionally includes a description of the business and/or one or more interactive user interface elements such as travel guides based on interest (e.g., food, sights, and/or tours.

In some embodiments, and in accordance with a determination that the physical location corresponding to the first location experience is located at a first physical location, displaying the first representation of the first point of interest includes displaying the first representation of the first point of interest at a first location within the navigation user interface element corresponding to the first physical location, such as representation 730a in FIG. 7H. In some embodiments, the computer system displays the first representation of the first point of interest in the first location within the navigation user interface element that is within the threshold distance from, proximate to, and/or overlaid on the first physical location. In some embodiments, the computer system presents the information associated with the physical location in response to receiving a user input corresponding to selection of the first representation of the first point of interest.

In some embodiments, and in accordance with a determination that the physical location corresponding to the first location experience is located at a second physical location different from the first physical location, displaying the first representation of the first point of interest includes displaying the first representation of the first point of interest at a second location within the navigation user interface element corresponding to the second physical location and different from the first location within the navigation user interface element corresponding to the first physical location. For example, the computer system displays the first representation spatially tied or linked to the second physical location such that the second location of the first representation is within the threshold distance from the second physical location. In some embodiments, when the computer system detects a change of the navigation user interface element (e.g., change in size, position and/or orientation in response to input to rotate, re-size, and/or tilt the navigation user interface element), the computer system displays the first representation at a location in accordance with the change of the navigation user interface element and corresponding to the respective physical location within the navigation user interface element. Displaying information associated with a physical location corresponding to the first location experience and updating the location of the first representation in accordance with the respective physical location within the navigation user interface element provides an efficient way of viewing additional content corresponding to the physical location without having to leave the user interface and enables a user to understand the first representation's corresponding physical location within the navigation user interface element, thereby reducing the need for subsequent inputs to locate and display information associated with the physical location which simplifies the interaction between the user and the computer system and enhances the operability of the computer system and makes the user-computer system interface more efficient.

In some embodiments, while displaying the navigation user interface element including the second portion, the computer system displays a first representation of a second location experience different from the first location experience, wherein the first representation of the first location experience is displayed with increased visual prominence relative to visual prominence of the first representation of the second location experience, such as representation 704a relative to representation 710a in FIG. 7A. In some embodiments, the first representation of the second location experience includes one or more characteristics of the first representation of the first location experience described above. In some embodiments, the second location experience includes second animated content including aerial tours, panoramas, photos, videos, audio, animations, and/or other curated content corresponding to the second location experience (optionally captured from a simulated camera at a respective physical location associated with the second location experience). In some embodiments, the computer system displays the first representation of the second location experience and the first representation of the first location within a visible or invisible user interface container object is moveable and/or rotatable such as a virtual carousel, virtual scroll wheel, a virtual dial, a virtual slider, or a virtual picker configured to allow for presenting and navigating within a continuum or sequence of representations of respective location experiences including the first representation of the first location experience and the first representation of the second location experience as described herein. In some embodiments, displaying the first representation of the first location experience with increased visual prominence includes displaying the first representation of the first location experience with a degree of highlighting, lighting, color, saturation, opacity, size, shadow and/or another visual effect. In some embodiments, displaying the first representation of the first location experience with increased visual prominence includes displaying the first representation of the first location experience in a centered position in an area of the first representation of the first location experience and the first representation of the second location experience.

In some embodiments, the computer system receives, via the one or more input devices, a second input (e.g., an input similar to or corresponding to the first input described above) directed to the first representation of the first location experience that corresponds to a request to update the visual prominences of the first representation of the first location experience and the first representation of the second location experience, such as input 714 in FIG. 7A. In some embodiments, the second input includes an air tap or air swipe input, from a hand (e.g., index finger, thumb, or pinky finger) of the user of the computer system.

In some embodiments, in response to receiving the second input, the computer system displays, via the display generation component, the first representation of the second location experience with increased visual prominence relative to the visual prominence of the first representation of the first location experience, such as representation 706 relative to representation 708a in FIG. 7B. For example, the computer system optionally displays the first representation of the second location experience with a degree of highlighting, lighting, color, saturation, opacity, size, shadow and/or another visual effect greater than the degree of highlighting, lighting, color, saturation, opacity, size, shadow and/or another visual effect greater associated with the first representation of the first location experience. In some embodiments, the computer system optionally displays the first representation of the second location experience in a centered position (optionally closer to the viewpoint of the user) while the first representation of the first location experience is displayed to the left or right of the centered position occupied by the first representation of the second location experience. In some embodiments, the computer system displays the first representation of the first location experience behind the first representation of the first location experience (e.g., father from the viewpoint of the user).

In some embodiments, in response to receiving the second input, the computer system displays, via the display generation component, the navigation user interface element to include a third portion different from the first portion, different from the second portion, and associated with the second location experience, such as navigation user interface element 716a in FIG. 7A and navigation user interface element 716a in FIG. 7B. In some embodiments, the computer system changes the display of the navigation user interface element from an orientation associated with the first location experience to a second orientation corresponding to the second location experience. In some embodiments, the computer system rotates, re-sizes, and/or tilts the navigation user interface element from the horizontal plane such that the navigation user interface element is centered on the third portion associated with the second location experience (e.g., without changing the viewpoint of the user of the computer system). In some embodiments, the third portion includes the area and/or location associated with the second location experience at a zoom level (e.g., greater or less) than the first portion and the second portion before detecting the second input. In some embodiments, the third portion includes a larger or smaller area than the first portion and the second portion. Displaying a respective representation of respective location experience with increased visual prominence relative to other representations of respective location experiences in response to input directed to the respective representation of respective location experience provides the user with visual feedback that the computer system is responsive to and confirms that the user intends to interact with the respective representation of respective location experience, thereby reducing errors in the interaction between the user and the computer system and reducing inputs needed to correct such errors.

In some embodiments, displaying the user interface includes displaying the user interface in a three-dimensional environment from a viewpoint of a user of the computer system. In some embodiments, the viewpoint of the user corresponds to a location in the three-dimensional environment from which the three-dimensional environment is presented by the computer system.

In some embodiments, while displaying the three-dimensional environment from a first viewpoint of the user including displaying a third portion of the navigation user interface element oriented towards the first viewpoint of the user, detecting a change in the viewpoint of the user from the first viewpoint to a second viewpoint different from the first viewpoint. For example, the computer system optionally detects that the user of the computer system has moved locations within the physical environment. In some embodiments, the computer system updates the viewpoint of the user in response to receiving an input in addition to or alternatively to detecting movement of the user in the physical environment.

In some embodiments, in response to detecting the change in the viewpoint of the user, the computer system displays the three-dimensional environment from the second viewpoint of the user including displaying a fourth portion of the navigation user interface element oriented towards the first viewpoint of the user, the fourth portion different from the third portion, such as navigation user interface element 716a in FIG. 7F and navigation user interface element 716a in FIG. 7G, respectively. For example, the computer system optionally updates the display of the three-dimensional environment including the navigation user interface element in accordance with the change in the viewpoint of the user. For example, the computer system detects that the user of the computer system moves to the left within the physical environment, and in response, the computer system optionally expands (e.g., by tilting, rotating, and/or scaling) the navigation user interface element to include the fourth portion in accordance with the change in the viewpoint of the user. In some embodiments, the computer system similarly expands the navigation user interface element to the right, upwards, and/or downwards in response to the change in the viewpoint of the user (e.g., movement of the user and/or the user's head to the right, left, upwards, and/or downwards, respectively. In some embodiments, the computer system changes the position and/or orientation of the navigation user interface element such that the navigation user interface element is centered on the fourth portion. Changing the display of the navigation user interface element to include portions of the navigation user interface element in response to detecting a change to the viewpoint of the user provides quick display of the location corresponding to the first location experience without requiring the user to provide further inputs to pan and/or zoom to the location corresponding to the respective location experience, thereby reducing the number of inputs and providing more efficient interactions between the user and the computer system.

In some embodiments, while displaying the first location experience and the navigation user interface element, the computer system displays, via the display generation component, the first location experience including video having a respective viewpoint that changes over time, such as video representation 724 in FIG. 7E. For example, the respective viewpoint is aerial, street-level, satellite, a combination thereof, or another viewpoint. In some embodiments, the first location experience includes the characteristics described in more details above.

In some embodiments, while displaying the first location experience and the navigation user interface element, the computer system displays, via the display generation component, a visual indication of the respective viewpoint at a location relative to the navigation user interface element that changes over time in accordance with the respective viewpoint that changes over time, such as representation 720 in FIG. 7E. For example, the computer system displays the navigation user interface element (optionally, at a smaller size, as described above) while displaying the first location experience. For example, the computer system optionally displays a visual indication corresponding to a simulated camera, such as a simulated camera that captures the video having the respective viewpoint that changes over time. In some embodiments, the computer system displays the visual indication at a position (e.g., x, y, and z coordinates) within the user interface corresponding to the respective viewpoint. In some embodiments, the computer system displays the visual indication with an orientation that corresponds to the respective viewpoint. In some embodiments, the computer system changes the position and/or orientation of the visual indication to correspond to the position and/or orientation of the respective viewpoint shown in the location experience as the video associated with the location experience is played as described above. The computer system optionally displays the visual indication at a location relative to the navigation user interface element that corresponds to the viewpoint of the simulated camera. Displaying a visual indication at a location relative to the navigation user interface element that changes over time provides an efficient way of indicating to the user the viewpoint of the first location experience, thereby improving communication between the users and enabling the user to use the computer system quickly and efficiently.

In some embodiments, displaying the first representation of the first point of interest includes displaying a visual indication of a source of the first location experience, such as representation 706g in FIG. 7C. For example, the visual indication of the source of the first location experience optionally includes icons, emojis, avatars, or other graphical representation corresponding to the source of the first location experience. In some embodiments, the source includes a third party (e.g., travel guides, lifestyle magazine, and/or media and entertainment network), individuals (e.g., family, friends, coworkers, and/or social media marketers), and/or an application on the computer system (e.g., photo management application, map application, and/or digital media player application).

In some embodiments, and in accordance with a determination that the source of the first location experience is a first source, the visual indication is a first visual indication corresponding to the first source, such as representation 706h in FIG. 7C. In some embodiments, the first visual indication includes text and/or an image that indicates and/or describes the first source. For example, when the first source is an individual user, the first visual indication is an avatar.

In some embodiments, and in accordance with a determination that the source of the first location experience is a second source different from the first source, the visual indication is a second visual indication corresponding to the second source and different from the first visual indication, such as representation 706h in FIG. 7C. For example, when the second source is a travel magazine, the first visual indication is an icon. In some embodiments, when the computer system detects input (e.g., an input similar to or corresponding to the first input described above) directed to the respective visual indication, the computer system, in response, displays more information about the respective source and/or initiates an operation to display the curated content associated with the first location experience provided by the respective source. Providing an indication of the source of the location experience provides a quick way of indicating to the user the location experiences provided by third parties, individuals, and/or applications on the computer system, without requiring the user to provide further inputs to navigate away from the user interface to locate particular sources and related location experiences, thereby reducing the number of inputs and providing more efficient interactions between the user and the computer system.

In some embodiments, displaying the first representation of the first location experience includes displaying the first representation of the first location experience with a visual indication of information about a physical location corresponding to the first location experience, such as representation 730a in FIG. 7H. For example, the visual indication includes information about the physical location. For example, if the physical location is a neighborhood, the information optionally includes content such as a description of the neighborhood, history of the neighborhood, notable landmarks and/or points of interest, related media content (e.g., movies and/or tv shows filed in the neighborhood) and/or other content characterizing the neighborhood. In some embodiments, the computer system gets the information about the physical location from data associated with a maps application of the computer system or a maps application of another computer system with the same user account as the user account of the computer system. Providing an indication of information about a physical location corresponding to the first location experience provides a quick overview of the location experience without requiring the user to provide further inputs to navigate away from the user interface to search for information about the physical location, thereby reducing the number of inputs and providing more efficient interactions between the user and the computer system.

In some embodiments, displaying the first representation of the first location experience includes, in accordance with a determination that a first contact (e.g., family, friends, coworkers, and/or social media marketers) of the computer system has visited a physical location associated with the first location experience, displaying the first representation of the first location experience includes a visual indication of the first contact, such as representation 706h in FIG. 7C. For example, if the first contact opted to share they visited the physical location with the computer system and/or the general public (e.g., all computer systems and/or electronic devices that have the map application), the computer system displays a visual indication of the first contact indicating to the user of the computer system that the first contact visited the physical location associated with the first location experience. In some embodiments, the first contact is currently at the physical location when the visual indication of the first contact is displayed as will be described in more detail below. In some embodiments, the computer system ceases to display the visual indication of the first contact when the first contact is no longer located at the physical location as will be described in more detail below and/or when the first contact has not permitted to share that the first contact visited the physical location.

In some embodiments, displaying the first representation of the first location experience includes, in accordance with a determination that a second contact of the computer system different from the first contact of the computer system has visited the physical location associated with the first location experience, displaying the first representation of the first location experience includes a visual indication of the second contact different from the visual indication of the first contact. In some embodiments, the visual indication of the second contact includes one or more characteristics of the visual indication of the first contact described herein. In some embodiments, the visual indication of the second contact appears differently from the visual indication of the first contact. For example, when the second contact is a contact from a social media network, the visual indication optionally includes an icon identifying such relationship via the social media network, whereas when the first contact is identified as a friend or family member, the visual indication optionally includes a photo or avatar representing the first contact. In some embodiments, the second contact is a type different from the first contact. For example, the second contact optionally includes a third party (e.g., travel guides, lifestyle magazine, and/or media and entertainment network) of which location experiences created by the third party are shared with the user of the computer system. Accordingly the visual indication of the second contact includes a notification of a new location experience related to the physical location. Providing an indication of a contact who visited the physical location associated with the first location experience provides a quick way of indicating to the user the location experiences visited by contacts without requiring the user to provide further inputs to navigate away from the user interface to search for contacts, thereby reducing the number of inputs and providing more efficient interactions between the user and the computer system.

In some embodiments, the first location experience includes media captured by a user of the computer system, such as representation 730c in FIG. 7K. In some embodiments, the media captured by the user of the computer system includes photos, notes, guides, annotations, video optionally captured while at a respective location associated with the first location experience. In some embodiments, the computer system displays on the first representation of the first location and indication of the media content captured by the user of the computer system. In some embodiments, the computer system captured the media. In some embodiments, a difference computer system associated with the user account of the user of the computer system captured the media. Surfacing media captured by the user of the computer system related to the first location experience provides a quick way of indicating to the user content they generated about the location experience without requiring the user to provide further inputs to navigate away from the user interface to search for media captured by the user related to the first location experience, thereby reducing the number of inputs and providing more efficient interactions between the user and the computer system.

In some embodiments, while displaying the first representation of the first location experience, the first representation of the first point of interest, and the navigation user interface element, the computer system displays, via the display generation component, a visual indication of a current location of a second computer system associated with a user account that is a contact of a user account associated with the computer system, such as representation 706h in FIG. 7C. In some embodiments, the user account associated with the second computer system that is a contact of the user account associated with the computer system has permitted to share their location information to the user account associated with the computer system. For example, the user account associated with the second computer system and the user account associated with the computer system are connected via a service that presents the locations of the second computer system to the computer system and the location of the computer system to the second computer system. In some embodiments, the location information that is shared includes a current location of the second computer system. Accordingly, the computer system optionally displays a visual indication of the current location of the second computer system. In some embodiments, the visual indication has one or more characteristics of the visual indication of the first contact and/or the visual indication of the second contact described above.

In some embodiments, and in accordance with a determination that the current location is a first physical location, the visual indication of the current location is displayed at a first location in the navigation user interface element corresponding to the first physical location, such as representation 706h in FIG. 7C. In some embodiments, the computer system receives an indication (e.g., from the second computer system, from a server) of the current location of the second computer system and determines that the current location corresponds to the first physical location. In response, the computer system displays a visual indication of the current location at a first location in the navigation user interface element corresponding to the first physical location. In some embodiments, the visual indication includes the field of view (e.g., view of the first physical location) corresponding to the orientation of the second computer system relative to a fixed coordinate system of the first physical location.

In some embodiments, in accordance with a determination that the current location is a second physical location different from the first physical location, the visual indication of the current location is displayed at a second location in the navigation user interface element corresponding to the second physical location different from the first location in the navigation user interface element corresponding to the first physical location, such as representation 706c in FIG. 7D. In some embodiments, as the second computer system moves such that the current location of the second computer system changes, the computer system updates the visual indication of the current location in the navigation user interface element to correspond to the changed current location of the second computer system. In some embodiments, the computer system receives an indication that the current location is no longer within a physical location associated with a respective location experience and/or the current location does not permit sharing the location of the second computer system to the computer system. Accordingly, the computer system optionally ceases to display the visual indication of the current location of the second computer system. Providing an indication in the navigation user interface element of a current location of a second computer system associated with a user account that is a contact of a user account associated with the computer system provides a quick way of indicating to the user the current location of contacts without requiring the user to provide further inputs to navigate away from the user interface to search for contacts, thereby reducing the number of inputs and providing more efficient interactions between the user and the computer system.

In some embodiments, the first location experience is associated with a business located at a first physical location, such as representation 730a in FIG. 7H. In some embodiments, the first location experience that is associated with a business includes photos, videos, and/or other curated content associated with the business at the first location, such as maps and/or guides. In some embodiments, the maps and/or guides are displayed concurrently with and/or overlaid on the navigation user interface element such that information from the maps and/or guides present different and/or supplemental information to the respective portion displayed by the navigation user interface element. Providing a location experience that is associated with a business enables a user to view both location information and business information without requiring the user to provide further inputs to navigate away from the user interface to search for the particular business and information related to the business, thereby reducing the number of inputs and providing more efficient interactions between the user and the computer system.

In some embodiments, displaying the first location experience includes displaying, via the display generation component, one or more of (1) a selectable option that, when selected, causes the computer system to view a website of the business; and/or (2) a selectable option that, when selected, causes the computer system to initiate a process to make a reservation with the business; and/or (3) a selectable option that, when selected, causes the computer system to display, via the display generation component, a video tour of the business, such as representation 730b in FIG. 7H and representation 734 in FIG. 7I, respectively. For example, said operations to view a website of the business, make a reservation with the business, and/or display a video tour of the business are initiated by the computer system without navigating away from the user interface including the first location experience. For example, in response to receiving an input selecting the selectable option to view a website of the business, the computer system optionally displays, within the user interface concurrently with displaying the first location experience (optionally with the navigation user interface element), the website of the business overlaid on the user interface. In some embodiments, said operations to view a website of the business, make a reservation with the business, and/or display a video tour of the business are initiated by the computer system including ceasing display of the user interface including the first location experience. For example, in response to receiving an input selecting the option to view the website of the business, the computer system displays a web browsing application user interface including the website of the business and ceases display of the user interface including the first location experience. Providing a variety of selectable options to interact with the business enables a user to perform operations associated with the business without requiring the user to provide further inputs to navigate away from the user interface to search for the particular business and location said options to interact with the business, thereby reducing the number of inputs and providing more efficient interactions between the user and the computer system.

In some embodiments, the computer system displays, via the display generation component, the first representation of the first location experience and the first representation of the first point of interest is based on previous user interactions with the computer system. For example, the computer system optionally displays representations of location experiences that are similar or related to user interactions and/or queries performed by a user account associated with the computer system. For example, if the user account recently performed a search for “dog friendly” in the computer system, the electronic device is optionally configured to display representations of location experiences that are dog friendly (e.g., dog parks, dog friendly neighborhoods, off-leash hikes, off-leash beaches within a current location of the computer system or recently presented location by the user interface). In some embodiments, the computer system optionally displays representations of location experiences not related to previous user interactions with the computer system. In some embodiments, the computer system optionally displays representations of location experiences that are similar or related to content the user has recently watched, read, and/or listed to. Displaying representations of location experiences based on previous user interactions with the computer system enables a user to view location experiences that are relevant to the user, without the need for additional inputs for searching for particular location experiences, thereby proactively populating the user interface with location experiences which enables the user to use the computer system more quickly and efficiently.

In some embodiments, the first location experience includes content from a news outlet and/or event coverage. In some embodiments, the computer system displays representations of location experiences that are related to news stories or current events. For example, in response to an upcoming annual footrace in a physical location, the computer system optionally displays representations of location experiences that include maps of the race, aerial tours of the route, and/or photos/videos of the finish line. Displaying representations of location experiences based on current events enables a user to view location experiences that are current and, in the news, without the need for additional inputs for searching for particular location experiences, thereby proactively populating the user interface with location experiences which enables the user to use the computer system more quickly and efficiently.

In some embodiments, while displaying, via the display generation component, the first location experience, the computer system receives, via the one or more input devices, one or more inputs corresponding to a request to add an annotation to the first location experience, such as representation 736a in FIG. 7I. In some embodiments, the annotation to the first location experience includes text, images, graphics, handwritten input, references (e.g., links to information), or other information about the first location experience. In some embodiments, in response to receiving the one or more inputs, the computer system modifies the first location experience to include the annotation, such as representation 742 in FIG. 7J. For example, the computer system optionally displays the annotation overlaid on a portion of a photo, or other content associated with the first location experience. In some embodiments, an indication of the annotation is displayed within the navigation user interface element at a respective location corresponding to a physical location associated with the first location experience. In some embodiments, a respective representation associated with the first location experience includes an indication of the annotation. In some embodiments, the indication of the annotation has one or characteristics similar to the indication of the media content captured by the user of the computer system described above. In some embodiments, the annotation is shared with and subsequently displayed at a second computer system different from the computer system. For example, when the computer system determines that the computer system is at the physical location, the computer system optionally displays a second three-dimensional environment including a passthrough video (as described above) of the physical location associated with the first location experience and the annotation (e.g., the computer system presents an immersive augmented reality along with the first location experience including the annotation). In some embodiments, the annotation is displayed similarly and/or at a location in the second three-dimensional environment that is the same as the location that it was placed at the time of adding the annotation to the first location experience. Incorporating user annotations to location experiences and allowing annotations to be shared increases collaboration such that annotations provided by users of different computer systems appear in a same location experience, thereby improving the interaction between the user and the computer system.

FIGS. 9A-9CC illustrate examples of a computer system presenting a collection of content associated with a physical location in response to user input corresponding to a request to generate the collection of content associated with the physical location in accordance with some embodiments.

FIG. 9A illustrates a computer system 101 (e.g., an electronic device) displaying, via a display generation component (e.g., display generation component 120 of FIG. 1A and/or display generation components 1-122a and 1-122b of FIG. 1C), a three-dimensional environment 900 from a viewpoint of a user of the computer system 101.

In FIG. 9A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 9A, computer system 101 captures one or more images of the physical environment around computer system 101 (e.g., operating environment 100 of FIG. 1A), including one or more objects in the physical environment around computer system 101. In some embodiments, computer system 101 displays representations of the physical environment in three-dimensional environment 900. For example, three-dimensional environment 900 includes representations of the rear and side walls of the room in which the computer system 101 is located.

As discussed in more detail below, in FIG. 9A, display generation component 120 is illustrated as displaying one or more virtual objects in the three-dimensional environment 900. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 9A-9CC.

Display generation component 120 has a field of view (e.g., a field of view captured by external image sensors 114b and 114c and/or visible to the user via display generation component 120) that corresponds to the virtual objects shown in FIG. 9A. Because display generation component 120 is optionally a head-mounted device, the field of view of display generation component 120 is optionally the same as or similar to the field of view of the user.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to method(s) 800 and/or 1000), or via a trackpad from hand 406, and inputs described herein are optionally received via the trackpad or via air gestures/attention.

In FIG. 9A, three-dimensional environment 900 includes a plurality of virtual objects, such as user interfaces and/or user interface elements 902, 926, 904a, and 904c. In some embodiments, the virtual objects are optionally components of a user interface or window of a map application as described with reference to method(s) 800 and/or 1000. For example, in FIG. 9A, the computer system 101 displays a first maps user interface element 902 (also referred to herein as a window or volume) of the map application containing map content and/or user interface elements. For example, the first maps user interface element 902 includes representations of respective collections of content, text, images, video, hyperlinks, and/or audio content associated with a first physical area, such as “Downtown San Francisco.” In FIG. 9A, the first maps user interface element 902 includes a control element 926. In some embodiments, control element 926 is selectable to cause the computer system 101 to perform respective operations associated with the first maps user interface element 902, such as close (e.g., cease to display) the first maps user interface element 902 or move (and/or resize) the first maps user interface element 902.

In FIG. 9A, the first maps user interface element 902 includes search user interface element 914 at which the computer system 101 receives a text input defining a search query for performing a search operation. In some embodiments, the text input identifies a respective physical area as search parameters for input to a request to present map content associated with the respective physical area.

In FIG. 9A, the first maps user interface element 902 includes a representation of a user's account 912 corresponding to the respective user account that is configured on the computer system 101 and/or currently active in (e.g., logged in) the maps application. In some embodiments, the computer system 101 presents map content based on the user account as will be described in more detail below.

In FIG. 9A, the first maps user interface element 902 also includes map content presented in an organized manner. For example, user interface element 902 includes content row 916a and content row 918. In some embodiments, the respective content row includes text, images, labels, and/or selectable user interface elements. For example, the content row 918 includes a text description of a first physical area (“Downtown San Francisco”) corresponding to an area represented by a navigation user interface element 904a described in more detail below. In FIG. 9A, the content row 916a includes a group of selectable user interface elements that, when selected, causes the computer system 101 to display content associated with the first physical area. For example, the content row 916a includes a first selectable user interface element 916b that, when selected, causes the computer system to display a plurality of collections of content as will be described below.

In FIG. 9A, the computer system 101 also displays a navigation user interface element 904a representing the first physical area. The navigation user interface element 904a is analogous to and/or includes one or more characteristics of the navigation user interface element described in method(s) 800 and/or 1000. For example, the navigation user interface element 904a is a three-dimensional topographical map of the first physical area. In FIG. 9A, the navigation user interface element 904a includes three-dimensional representations of buildings, landmarks, points of interest (e.g., representations of points of interest 910a-910d), streets 9101, trees 910k, parks, bodies of water, and/or other geographical features in the first physical area. In FIG. 9A, the navigation user interface element 904a includes a control element 904c. In some embodiments, control element 904c, when selected, causes the computer system 101 to perform respective operations associated with the navigation user interface element 904a, such as close (e.g., cease to display) the navigation user interface element 904a or move (and/or resize) the navigation user interface element 904a.

In some embodiments, and as will be described below and/or with reference to method(s) 800 and/or 1000, the computer system 101 will change the display of the navigation user interface element 904a (e.g., rotate, re-size, and/or tilt) and/or render a respective portion of the navigation user interface element 904a at a zoom level to focus on an area of the map that represents the first physical area (“Downtown San Francisco”) associated with the content displayed in the first maps user interface element 902 and vice versa. For example, when the computer system 101 changes the navigation user interface element 904a to represent a second physical area (e.g., “Los Angeles”), different from the first physical area (optionally, in response to user input), the computer system 101 changes the navigation user interface element 904a from representing the first physical area to representing the second physical area; and the computer system 101 updates the first maps user interface element 902 to display content associated with the second physical area as described below and/or with reference to method(s) 800 and/or 1000.

In some embodiments, the computer system 101 displays a plurality of collections of content. A collection of content optionally refers to a location experience described with reference to method(s) 800 and/or 1000. For example, a respective collection of content associated with a respective physical area includes content (and/or representation(s) of content) captured by the user of the computer system 101 while at or nearby the respective physical area, representation(s) of points of interest at or nearby the respective physical area, and/or other location-based content (and/or representation(s) of other location-based content) as described in method 1000 and in further detail below. For example, in FIG. 9A, the computer system 101 detects user input 906a (e.g., air pinch gesture described in more detail in method(s) 800 and/or 1000) while gaze 908 of the user of the computer system 101 is directed to the first selectable user interface element 916b. In response to detecting the input in FIG. 9A, as shown in FIG. 9B, the computer system 101 displays, via display generation component 120, the first maps user interface element 902 including content row 922a and content row 924.

In FIG. 9B, the content row 922a includes a group of selectable user interface elements that, when selected, causes the computer system 101 to display collections of content associated with the first physical area created by the computer system 101, the collections of content personalized for the user of the computer system 101 as described in more detail with reference to method(s) 800 and/or 1000. In some embodiments, the collections of personalized content include content associated with a point of interest within the first physical area. For example, the content row 922a includes a first collection of content associated with a museum (“SF MOMA”) the user marked as a favorite point of interest, a second collection of content associated with a neighborhood (“Union Square”) that the user recently visited, and a third collection of content associated with a particular category (“History and Architecture”) the user recently searched for as represented by selectable user interface element 922b. In some embodiments, in response to the computer system 101 detecting user input, such as user input 906a in FIG. 9A, directed to selectable user interface element 922b, the computer system 101 displays, via display generation component 120, the third collection of content. In some embodiments, a respective selectable user interface element includes an indication that a contact of the computer system 101 shared the collection of content and/or content in the collection to the user of the computer system 101. For example, in FIG. 9B, the selectable user interface element 922b includes indications 922c of contacts who shared the third collection of content and/or content in the third collection of content to the user of the computer system 101. In some embodiments, the indications 922c include images, avatars, and/or other graphics representing the contacts.

In FIG. 9B, the content row 924 includes a partially displayed group of selectable user interface elements that, when selected, cause the computer system 101 to display collections of content nearby the first physical area. In some embodiments, and as will be described below, the computer system scrolls the content displayed in the first maps user interface element 902 such that the content row 924 including the group of selectable user interface elements is fully displayed.

In some embodiments, the computer system detects user input corresponding to a request to zoom in on an area and/or location of the navigation user interface element 904a that represents a second physical area, different from the first physical area. For example, in FIG. 9B, the user input 906b corresponding to the request to zoom includes an air pinch gesture with two hands (e.g., described in more detail in method(s) 800 and/or 1000) and movement to pull the hands apart to zoom in while the gaze 908 is directed to the navigation user interface element 904a. In response to detecting user input 906b and as illustrated in FIG. 9C, the computer system 101 zooms in on a portion of the navigation user interface element 904a to display a second physical location (“Mission Bay Neighborhood”) corresponding to a location of the gaze 908 of the user directed to the navigation user interface element 904a while receiving the user input 906b in FIG. 9B. In some embodiments, displaying the navigation user interface element 904a representing the second physical location includes more detail than displaying the navigation user interface element 904a representing the first physical location.

In some embodiments, in response to displaying the navigation user interface element 904a representing the second physical area, the computer system 101 displays, in the first maps user interface element 902, content corresponding to the second physical area. Thus, in some embodiments, the computer system 101 presents content associated with the second physical area in response to receiving the user input 906b directed to the navigation user interface element 904a without requiring additional user input (e.g., without a separate user input or without explicit interaction such as interacting with the first maps user interface element 902). For example, in FIG. 9C, the first maps user interface element 902 includes content row 928a and a content row 930 associated with the second physical area.

In FIG. 9C, the content row 928a includes a group of selectable user interface elements that, when selected, cause the computer system 101 to display collections of content associated with the second physical area created by the computer system 101, the collections of content personalized for the user of the computer system 101 as described in more detail with reference to method(s) 800 and/or 1000. In some embodiments, the collections of personalized content include content associated with a point of interest within the second physical area. For example, the content row 928a includes a first collection of content associated with a stadium (“Oracle Park”) the user has visited as represented by selectable user interface element 928b, a second collection of content associated with a park (“China Basin Park”) that recently opened, and a third collection of content associated with a park (“Mission Bay Dog Park”) the user has visited as represented by selectable user interface element 928d. In some embodiments, a respective selectable user interface element includes an indication that a contact of the computer system 101 shared the collection of content and/or content in the collection to the user of the computer system 101. In some embodiments, the respective selectable user interface element includes an indication that the user of the computer system 101 and/or a contact of the computer system 101 has been identified in content in the collection as described in more detail in method 1000. For example, a respective user is captured in a photo in the collection of content, the respective user took the photo in the collection, and/or the respective user was at the physical location corresponding to the respective location where the photo in the collection was captured and/or saved to the computer system 101. In FIG. 9C, the selectable user interface element 928b includes indications 928c of users who were captured in content in the first collection of content. In some embodiments, the indications 928c include images, avatars, and/or other graphics representing the users. In another example, the selectable user interface element 928d includes indications 928e of users who captured content (e.g., took photos and/or videos) in the first collection of content and/or who were at the physical location corresponding to the respective location where the content was captured. In some embodiments, the indications 928c include images, avatars, and/or other graphics representing the users. In FIG. 9C, the first maps user interface element 902 also includes content row 930 that includes a partially displayed group of selectable user interface elements that, when selected, causes the computer system 101 to display collections of content nearby the second physical area. In some embodiments, and as will be described below, the computer system 101 scrolls the content displayed in the first maps user interface element 902 such that the content row 930 including the group of selectable user interface elements is fully displayed.

In some embodiments, the computer system 101 displays, via the display generation component 120, a respective collection of content. For example, in FIG. 9C, the computer system 101 detects user input 906c directed to selectable user interface element 928b. In some embodiments, detecting user input 906c is analogous to and/or includes one or more characteristics of detecting user input 906a in FIG. 9A. In response to detecting user input 906c directed to selectable user interface element 920b, the computer system 101 displays, via the display generation component 120, a second maps user interface element 932a in FIG. 9D.

In some embodiments, the second maps user interface element 932a is a container element, such as a virtual carousel as described in more detail with reference to method(s) 800 and/or 1000. In some embodiments, and as will be described below, the second maps user interface element enables the user of the computer system to navigate through the respective collection of content. In FIG. 9D, the second maps user interface element 932a includes the first collection of content associated with the stadium (“Oracle Park”) the user has previously visited, such as a panorama 932d of the stadium, a representation of an aerial tour 932b of the stadium that, when selected, causes the computer system 101 to play the aerial tour, and a photo 932c taken at the physical location of the stadium.

In some embodiments, in response to detecting user input directed to a particular content item or representation, such as detecting user input 906a in FIG. 9A, the computer system 101 performs an action associated with the content item, such as displaying the content item, playing the content item, or performing a different action associated with the content item as described in more detail with reference to method(s) 800 and/or 1000. For example, in FIG. 9D, the computer system detects user input 906d directed to the representation of an aerial tour 932b. In some embodiments, detecting user input 906d is analogous to and/or includes one or more characteristics of detecting user input 906a in FIG. 9A. In some embodiments, in response to detecting user input 906d directed to the representation of the aerial tour 932b, the computer system 101 plays the aerial tour video 934a as shown in FIG. 9E. In some embodiments, in response to detecting user input 906d directed to the representation of the aerial tour 932b (or optionally, while playing the aerial tour video 934a) as shown in FIG. 9D, the computer system 101 changes the navigation user interface element 904a to represent the location corresponding to the physical location associated with the aerial tour 932b, such as displaying the navigation user interface element 904a at a zoom level to focus on the location of the stadium as shown in FIG. 9E. Thus, in some embodiments, the computer system 101 automatically displays the location of the stadium without requiring user input directed to the navigation user interface element 904 to display the location of the stadium. In FIG. 9E, the computer system 101 also displays, via the display generation component 120, an option 934b that, when selected, causes the computer system 101 to pause playback of the aerial tour video 934a.

In some embodiments, after playing the aerial tour video 934a and/or at a moment when the end of the aerial tour video 934a is reached, the computer system 101 automatically displays, via the display generation component 120, the second maps user interface element 932a and the navigation user interface element 904 representing the second physical area as shown in FIG. 9F. In some embodiments, the computer system 101 automatically displays the second maps user interface element 932a and the navigation user interface element 904 without user input requesting to display the second maps user interface element 932a and the navigation user interface element 904.

In some embodiments, the computer system 101 presents the respective collection of content in a manner where the computer system 101 navigates through the respective collection of content and provides access to a particular content item in response to detecting user input. For example, in FIG. 9F, while the computer system 101 displays the second maps user interface element 932a, the computer system 101 detects a user input 906f corresponding to a request to navigate through the first collection of content contained by the second maps user interface element 932a. In some embodiments, the user input 906f includes a swipe gesture or a scroll gesture in a first (forward) direction or a second (backwards) direction as described in more detail with reference to method(s) 800 and/or 1000. In FIG. 9F, the computer system 101 detects that user input 906f includes a swipe gesture from a right to left direction. In response to detecting the user input 906f, the computer system 101 navigates through the first collection of content in accordance with the magnitude and/or the direction of movement of the swipe gesture, such that the computer system displays photo 932c in the center of the second maps user interface element 932a (e.g., in full display, not partially display prior to detecting user input 906f). In response to detecting user input 906f, the computer system 101 changes the navigation user interface element 904a to represent the location corresponding to the location where photo 932c was captured (e.g., the location of the stadium) as shown in FIG. 9G. Thus, in some embodiments, the computer system 101 automatically displays the location of the stadium (optionally from a same viewpoint where the photo 932c was captured) without requiring user input directed to the navigation user interface element 904a to display the location of the stadium.

In FIG. 9G, the computer system 101 detects user input 906g directed to control element 926. In some embodiments, user input 906g is analogous to and/or includes one or more characteristics of detecting user input 906a in FIG. 9A. In some embodiments, in response to detecting user input 906g directed to control element 926, the computer system 101 ceases to display the second maps user interface element 932a and displays, via the display generation component 120, the first maps user interface element 902 and the navigation user interface element 904a representing the second physical area. In some embodiments, displaying the first maps user interface element 902 and the navigation user interface element 904a representing the second physical area is analogous to and/or includes one or more characteristics of displaying the first maps user interface element 902 and the navigation user interface element 904a representing the second physical area in FIG. 9C.

In some embodiments, the computer system 101 displays a plurality of collections of content in an organized manner. For example, in FIG. 9H, the computer system 101 detects user input 906h corresponding to a request to scroll the first maps user interface element 902 that includes (representations of) the plurality of collections of content. In some embodiments, the user input 906h includes an air pinch gesture described in more detail in method(s) 800 and/or 1000 followed by movement of the air pinch gesture in a direction (upwards or downwards or other direction) while gaze 908 of the user of the computer system 101 is directed to the first maps user interface element 902. In response to detecting user input 906h including movement in an upwards direction, the computer system 101 scrolls the first maps user interface element 902 in accordance with user input 906h as shown in FIG. 91. For example, the computer system 101 scrolls the first maps user interface element 902 up to reveal additional content that was not previously displayed prior to detecting user input 906h. In FIG. 91, while (and/or in response to) detecting the user input 906h, the computer system 101 displays in the first maps user interface element 902 content row 904a and content row 948a.

In FIG. 91, content row 946a includes a group of selectable user interface elements that, when selected, causes the computer system 101 to display collections of content recently viewed by the user of the computer system 101 and/or recently presented by the computer system 101 as described in more detail with reference to method(s) 800 and/or 1000. For example, the content row 946a includes a first collection of content associated with a city (“Los Angeles”), a second collection of content associated with a point of interest (“Smokey's Dog Cafe”), and a third collection of content associated with a point of interest (“Crissy Field”) as represented by selectable user interface element 946c. In some embodiments, in response to the computer system 101 detecting user input, such as user input 906a in FIG. 9A, directed to selectable user interface element 946c, the computer system 101 displays, via display generation component 120, the third collection of content.

In FIG. 91, the content row 948a includes a partially displayed group of selectable user interface elements that, when selected, cause the computer system 101 to display collections of content shared by one or more contacts of the computer system 101 as described in more detail with reference to method 1000. In some embodiments, and as will be described below, the computer system scrolls the content displayed in the first maps user interface element 902 such that the content row 948a including the group of selectable user interface elements is fully displayed. For example, in FIG. 91, the computer system 101 detects user input 906i corresponding to a request to scroll the first maps user interface element 902 that includes (representations of) the plurality of collections of content. In some embodiments, the user input 906i is analogous to and/or includes one or more characteristics of the user input 906h in FIG. 9H. In response to detecting user input 906i including movement in an upwards direction, the computer system 101 scrolls the first maps user interface element 902 in accordance with user input 906i as shown in FIG. 9J. For example, the computer system 101 scrolls the first maps user interface element 902 up to reveal additional content that was not previously displayed prior to detecting user input 906i. In FIG. 9J, while (and/or in response to) detecting the user input 906i in FIG. 91, the computer system 101 scrolls the first maps user interface element 902 such that content row 948a is displayed in its entirety (e.g., fully displayed) and content row 944a is revealed in the first maps user interface element 902.

In FIG. 9J, the content row 948a includes a group of selectable user interface elements that, when selected, causes the computer system 101 to display collections of content associated with the second physical area created by the computer system 101, the collections of content shared by one or more contacts of the computer system 101 and/or the collections of content include content shared by one or more contacts of the computer system 101. In some embodiments, the collections of content shared to the user of the computer system are grouped according to one or more categories as described in more detail with reference to method 1000. For example, the content row 948a includes a first collection of content associated with a first category (“Best Happy Hour”) as represented by selectable user interface element 948b, a second collection of content associated with a second category (“Best Restaurants”), different form the first category, and a third collection of content associated with a third category (“Scenic Walks”), different from the first category and the second category, and represented by selectable user interface element 948d. In some embodiments, in response to the computer system 101 detecting user input, such as user input 906a in FIG. 9A, directed to selectable user interface element 948d, the computer system 101 displays, via display generation component 120, the third collection of content. For example, the third collection of content includes trails, scenic viewpoints, vistas, and/or the like shared by one or more contacts of the user of the computer system 101.

In some embodiments, a respective selectable user interface element includes an indication that a contact of the computer system 101 shared the collection of content and/or content in the collection to the user of the computer system 101. For example, in FIG. 9J, the selectable user interface element 948d includes indications 948e of contacts who shared the third collection of content and/or content in the third collection of content to the user of the computer system 101. In some embodiments, the indications 922c include images, avatars, and/or other graphics representing the contacts.

In FIG. 9J, the content row 944a includes a partially displayed group of selectable user interface elements that, when selected, cause the computer system 101 to display collections of content guides associated with the second physical area as described in more detail in method 1000. In some embodiments, and as will be described below, the computer system 101 scrolls the content displayed in the first maps user interface element 902 such that the content row 944a including the group of selectable user interface elements is fully displayed.

In some embodiments, displaying a respective collection of content shared by one or more contacts of the user of the computer system 101 includes displaying additional content. For example, in FIG. 9J, the computer system 101 detects user input 906j directed to selectable user interface element 948b. In some embodiments, detecting user input 906j is analogous to and/or includes one or more characteristics of detecting user input 906a in FIG. 9A. In some embodiments, in response to detecting user input 906j directed to selectable user interface element 948b, the computer system 101 displays, via the display generation component 120, the first maps user interface element 902 including representations of points of interest associated with the first category (“Best Happy Hour”) as shown in FIG. 9K. In some embodiments, in response to detecting user input 906j directed to selectable user interface element 948b, the computer system 101 changes the navigation user interface element 904a to represent a third physical area, the third physical area includes the respective locations of the points of interest displayed in the first maps user interface element 902 as will be described below.

In FIG. 9K, the first maps user interface element 902 includes a label 948f or text description of the first category (“Best Happy Hour”) and group 948g of selectable user interface elements that, when selected, causes the computer system 101 to display a respective collection of content associated with the respective point of interest. For example, the group 948g of selectable user interface elements includes a first selectable user interface element associated with a first point of interest (“Mini Golf”), a second selectable user interface element associated with a second point of interest (“Smokey's Dog Cafe”), and a third selectable user interface element associated with a third point of interest (“Doza Belle”). In FIG. 9K, the computer system 101 also pans and/or zooms the navigation user interface element 904a to represent the third physical area that includes respective locations of the first, second, and third point of interest. For example, in FIG. 9K, the computer system 101 displays a pin 910e or representation of the first point of interest at a respective location within the navigation user interface element 904a corresponding to the physical location of the first point of interest. In another example, the computer system 101 displays a pin 910d of the second point of interest at a respective location within the navigation user interface element 904a corresponding to the physical location of the second point of interest.

In some embodiments, the computer system 101 detects user input 906k directed to first selectable user interface element 948h as shown in FIG. 9K. In some embodiments, detecting user input 906k directed to the first selectable user interface element 948h is analogous to and/or includes one or more characteristics of detecting the user input 906a in FIG. 9A. In some embodiments, in response to detecting user input 906k directed to the first selectable user interface element 948h, the computer system 101 displays, via display generation component 120, the first maps user interface element 902 including an image 950g of the first point of interest (“Mini Golf”) and a label 950a or text description of the first point of interest as shown in FIG. 9L. In some embodiments, the image 950g of the first point of interest includes a street level view image and/or video from the physical location of the first point of interest. In some embodiments, in response to detecting user input 906k directed to the first selectable user interface element 948h, the computer system 101 changes the navigation user interface element 904a to represent the physical location of the first point of interest as shown in FIG. 9L. In FIG. 9L, the computer system 101 renders the navigation user interface element 904a at a respective zoom level to focus on the physical location of the first point of interest.

In FIG. 9L, the first maps user interface element 902 also includes selectable user interface elements 950b through 950f that, when selected, cause the computer system 101 to display a respective collection of content associated with first point of interest. In some embodiments, the collection of content that is displayed is grouped according to category as described in more detail in method 1000. For example, the first maps user interface element 902 includes: selectable user interface element 950c that, when selected, causes the computer system 101 to display a collection of content that is associated with the interior of the Mini Golf attraction; selectable user interface element 950d that, when selected causes the computer system 101 to display a collection of content that is associated with the exterior of the Mini Golf attraction; selectable user interface element 950e that, when selected causes the computer system 101 to display a collection of content that is associated with drinks served at the Mini Golf attraction; and selectable user interface element 950f that, when selected causes the computer system 101 to display a collection of content that is associated with food served at the Mini Golf attraction. In FIG. 9L, the computer system 101 detects user input 906l directed to selectable user interface element 950b. In some embodiments, detecting user input 906b directed to the selectable user interface element 950b is analogous to and/or includes one or more characteristics of detecting the user input 906a in FIG. 9A. In some embodiments, in response to detecting user input 906l directed to the first selectable user interface element 950b, the computer system 101 displays, via display generation component 120, a third maps user interface element 952a in FIG. 9M. In some embodiments, the third maps user interface element 952a is analogous to and/or includes one or more characteristics of the second maps user interface element 932a in FIG. 9D.

In some embodiments, the third maps user interface element 952a includes a collection of content items associated with the vibes or atmosphere of the Mini Golf attraction, such as a panorama 952d taken at the Mini Golf attraction, a representation of a spatial video 952b taken at the Mini Golf attraction that, when selected, causes the computer system 101 to play the spatial video, and a video 952c taken at the Mini Golf attraction. In some embodiments, in response to detecting user input directed to a particular content item or representation, such as detecting user input 906a in FIG. 9A, the computer system 101 performs an action associated with the content item, such as displaying the content item, playing the content item, or performing a different action associated with the content item as described in more detail with reference to method(s) 800 and/or 1000. For example, in FIG. 9M, the computer system 101 detects user input 906m directed to the representation of the spatial video 952b. In some embodiments, detecting user input 906m is analogous to and/or includes one or more characteristics of detecting user input 906a in FIG. 9A. In some embodiments, in response to detecting user input 906m directed to the representation of the spatial video 952b, the computer system 101 plays the spatial video 954a as shown in FIG. 9N.

In some embodiments, the computer system 101 plays the spatial video 954a at a respective level of immersion. For example, in FIG. 9N, the computer system 101 displays the spatial video 954a at a medium immersion (e.g., 60, 65, 70, 75, or 80% of the field of view is consumed by the spatial video 954a such that the background, virtual objects other than the spatial video 954a, and/or real objects that are displayed are obscured, dimmed, blurred, and/or removed from display) as described in more detail with reference to method(s) 800 and/or 1000. In some embodiments, while playing the spatial video 954a at a medium immersion level, the computer system 101 outputs spatial audio 954c and 954d with one or more characteristics corresponding to the spatial video 954a such as environmental, water sounds (e.g., spatial audio 954c) associated with the mini golf course and/or human noises (e.g., spatial audio 954d) associated with users playing mini golf nearby.

In some embodiments, after playing the spatial video 954a and/or at a moment when the end of the spatial video 954a is reached, the computer system 101 automatically displays, via the display generation component 120, the first maps user interface element 902 and the navigation user interface element 904a representing the physical location of the Mini Golf attraction as shown in FIG. 90 and as described with reference to FIG. 9L. In some embodiments, the first maps user interface element 902 includes an option 950h that, when selected, causes the computer system 101 to share the respective collection of content associated with the Mini Golf attraction with a second computer system, different from the computer system 101 as described in method 1000. For example, in FIG. 90, the computer system 101 detects user input 9060 directed to option 950h. In some embodiments, detecting user input 9060 is analogous to and/or includes one or more characteristics of detecting user input 906a in FIG. 9A. In some embodiments, in response to detecting user input 9060, the computer system 101 displays user interface element 940a as shown in FIG. 9P.

In FIG. 9P, the user interface element 940a includes representations of users selectable, via user input, to share the respective collection of content with which is described in more detail with reference to method 1000. In some embodiments, the computer system shares the respective collection of content with users associated with other computer systems, different from the computer system 101, using a variety of communication channels 940c, such as a messaging application, an email application, a notetaking application, and/or other communication channel described in method(s) 800 and/or 1000.

In FIG. 9P, the computer system 101 detects user input 906p corresponding to a request to zoom out of the navigation user interface element 904a that represents the physical location of the first point of interest (“Mini Golf” attraction). For example, in FIG. 9P, the user input 906p corresponding to the request to zoom out includes an air pinch gesture with two hands (e.g., described in more detail in method(s) 800 and/or 1000) and movement to bring the hands closer together to zoom out while the gaze 908 is directed to the navigation user interface element 904a. In response to detecting user input 906p and as illustrated in FIG. 9Q, the computer system 101 zooms out of the navigation user interface element 904a to display the first physical location described above with reference to FIGS. 9A and 9B (“Downtown San Francisco”). The first physical location corresponds to a location of the gaze 908 of the user directed to the navigation user interface element 904a while receiving the user input 906p in FIG. 9P. In some embodiments, displaying the navigation user interface element 904a representing the first physical location includes less detail than displaying the navigation user interface element 904a representing the physical location of the first point of interest (“Mini Golf” attraction).

In some embodiments, the computer system enables the user of the computer system 101 to create one or more personalized experiences (e.g., collections of content) described in method 1000. For example, in FIG. 9Q, the computer system 101 detects user input 906q corresponding to a request to navigate through the group of selectable user interface elements of the content row 922a. In some embodiments, detecting the user input 906q is analogous to and/or includes one or more characteristics of detecting the user input 906f in FIG. 9F. For example, in FIG. 9Q, the computer system 101 detects that user input 906q includes a swipe gesture from a right to left direction. In some embodiments, in response to detecting the input 906q including the swipe gesture, the computer system 101 navigates through the group of selectable user interface elements of content row 922a in accordance with the movement and the direction of the swipe gesture, such that the computer system displays selectable user interface element 922d that was not previously displayed prior to detecting user input 906q.

In FIG. 9R, the computer system 101 detects user input 906r directed to the selectable user interface element 922d. In some embodiments, detecting user input 906r is analogous to and/or includes one or more characteristics of detecting user input 906a in FIG. 9A. In some embodiments, in response to detecting user input 906r directed to the selectable user interface element 922d, the computer system 101 displays, via the display generation component 120, a creation user interface element 956a for creating a collection of personalized content as shown in FIG. 9S (e.g., a location experience as described in more detail with reference to method(s) 800 and/or 1000).

In FIG. 9S, the creation user interface element 956a includes label 956b or text description of the creation user interface element 956a (“New Experience), content row 956c, and content row 956d. For example, content row 956c includes personal content (e.g., photos, videos, spatial videos, panoramas, and/or the like) captured by the computer system 101 and organized according to a first category (“Places”). Content row 956c includes a first group of personal content associated with the physical location of the “Home” of the user of the computer system 101, a second group of personal content associated with the city “San Francisco” represented by selectable user interface element 956e, and a third group of personal content associated with the city “Los Angeles” represented by selectable user interface element 956f. In some embodiments, and as will be described below, the selectable user interface elements of content row 956c, when selected, cause the computer system 101 to display respective personal content associated with the particular category (e.g., place or physical location). In some embodiments, the computer system 101 displays a respective group of content based on the navigation user interface element 904a. For example, when the computer system 101 detects user input 906r directed to the selectable user interface element 922f, the computer system determines that the physical area being represented by the navigation user interface element 904a includes a first physical area (e.g., San Francisco). In some embodiments, in accordance with the determination that the navigation user interface element 904a represents the first physical area, the computer system displays content row 956c in FIG. 9R including places associated with (within) the first physical area (e.g., neighborhoods, locations, sites, nearby cities and/or the like). Thus, in some embodiments, and as will be described in more detail below, the computer system 101 creates a collection of content based on the physical area presented in the navigation user interface element 904a.

In FIG. 9S, the content row 956d includes selectable options that, when selected, cause the computer system 101 to present personal content organized according to a second category (“Categories”). Content row 956d includes a options that, when selected, causes the computer system to display a first group of personal content associated with the category “Dog”, a second group of personal content associated with the category “Beaches” represented by selectable user interface element 956g, and a third group of personal content associated with the category “Food” represented by selectable user interface element 956h. In some embodiments, and as will be described below, the selectable user interface elements of content row 956d, when selected, cause the computer system 101 to display respective personal content associated with the particular category. For example, in FIG. 9S, the computer system detects user input 906s directed to selectable user interface element 956e (“San Francisco”). In some embodiments, detecting the user input 906s directed to selectable user interface element 956e is analogous to and/or includes one or more characteristics of detecting the user input 906a in FIG. 9A. In some embodiments, in response to detecting user input 906s, the computer system 101 displays the creation user interface element 956a including collections of personal content grouped according to the particular physical location (e.g., San Francisco) as shown in FIG. 9T.

In FIG. 9T, the creation user interface element 956a includes a first group 956i of personal content associated with a first location (“Crissy Field”). In some embodiments, the personal content associated with the first location includes a photo 9561 captured at the first location and a link 956k to a location of a particular trailhead within the first location. In some embodiments, the first group 956i of personal content includes an indication of a date and/or time (e.g., “Apr. 15, 2024) associated with the personal content, such as the date when photo 9561 was captured and the date when link 956k was presented by the maps application. The creation user interface element 965a also includes a second group 956j of personal content associated with a second location (“Golden Gate Park”). In some embodiments, the personal content associated with the second location includes a link 956m to a calendar event happening at the second location and a video 956n taken at the second location. In some embodiments, the second group 956j of personal content includes an indication of a date and/or time (e.g., “Apr. 13, 2024”) associated with the personal content, such as the date of the calendar event and the date when video 956n was captured.

In some embodiments, in response to detecting user input 906s and/or in response to (or while displaying the creating user interface element 956a including the first group 956i and the second group 956j of personal content), the computer system 101 pans and/or zooms the navigation user interface element 904a to represent a physical area that includes respective locations of the first, second, and other groups of personal content. For example, in FIG. 9T, the computer system 101 displays a representation 958b of the first group 956i of personal content associated with the first location (“Crissy Field”) within the navigation user interface element 904a corresponding to the physical location of the first location. In some embodiments, the representation 958b includes an indication of the number of personal content associated with the first location. In another example, the computer system 101 displays a representation 958a of the second group 956j of personal content associated with the second location (“Golden Gate Park”) within the navigation user interface element 904a corresponding to the physical location of the second location. In some embodiments, the representation 958a includes an indication of the number of personal content items associated with the second location.

In FIG. 9T, the computer system 101 detects user input 906t directed to option 984 to select one or more personal photos to create a new experience (e.g., new collection of personalized content). In some embodiments, the user input 906t is analogous to and/or includes one or more characteristics of the user input 906a in FIG. 9A. In some embodiments, in response to detecting user input 906t, the computer system 101 displays, via the display generation component 120, a second creation user interface element 9560 that includes information about the new collection of personalized content, such as an indication 956q of a number of personal items included in the new collection of personalized content and a creation option 956p that, when selected, causes the computer system 101 to create a collection of personalized content that includes the selected personal content (e.g., check marked photo A 956l and link A 956k). In some embodiments, the computer system detects user input 906u directed to creation option 956p. In some embodiments, detecting the user input 906u is analogous to and/or includes one or more characteristics of detecting the user input 906a in FIG. 9A. In some embodiments, in response to detecting user input 906u directed to creation option 956p, the computer system 101 displays the generated respective collection of content. In some embodiments, displaying the generated respective collection of content is analogous to and/or includes one or more characteristics of displaying the second maps user interface element 932a that includes the first collection of content in FIG. 9D.

FIGS. 9V-9CC illustrate examples of an electronic device 960a presenting a collection of content associated with a physical location. In some embodiments, the electronic device 960a presents the collection in response to receiving a user input corresponding to a request to generate the collection of content associated with the physical location in accordance with some embodiments. The embodiments in these figures are used to illustrate the processes described below, including the processes described with reference to FIG. 10. Although FIGS. 9V-9CC illustrate various examples of ways an electronic device is able to perform the processes described below with respect to FIG. 10, it should be understood that these examples are not meant to be limiting, and the electronic device is able to perform one or more processes described below with reference to FIG. 10 in ways not expressly described with reference to FIGS. 9V-9CC.

FIG. 9V illustrates an example of an electronic device 960a that includes touch screen 960b displaying a maps user interface 962 of a map application. Although electronic device 960a (with touch screen 960b) is used to illustrates the example embodiments described below, other electronic devices or computer systems, such as a portable device (e.g., notebook computer, tablet computer, or handheld), a wearable device (e.g., watch or head-mountable device (HMD)) or other device that presents content to the user can also perform these operations. In FIG. 9V, for example, the maps user interface 962 includes a map 964a including a representation of a first physical area (e.g., San Francisco). FIG. 9V also shows that, in some embodiments, the maps user interface 962 includes a user interface element 964b overlaid on map 964a. In some embodiments, the user interface element 964b includes search user interface element 964c at which the electronic device 960a receives a text input defining a search query for performing a search operation. In some embodiments, the search user interface element 964c is analogous to and/or includes one or more characteristics of the search user interface element 914 in FIG. 9A.

In FIG. 9V, the user interface element 964b also includes content row 964d that includes a partially displayed group of selectable user interface elements (e.g., selectable user interface elements 964c, 964f, and 964g that, when selected, causes the electronic device 960a to display collections of content associated with a respective physical location). As shown in FIG. 9V, the user interface element 964b is displayed as partially-expanded. In some embodiments, when the electronic device 960a displays the user interface element 964b fully expanded, the user interface element 964b includes the group of selectable user interface elements 964c, 964f, and 964g as fully displayed and/or additional content and/or selectable options than when the user interface element 964b is displayed as partially-expanded. For example, in FIG. 9V, the electronic device 960a detects user input 966a (e.g., a swipe contact on touch screen 960b) corresponding to a request to expand the user interface element 964b, and in response to receiving user input 966a, the electronic device 960a displays user interface element 964b fully expanded as shown in FIG. 9W.

In FIG. 9W, the fully expanded user interface element 964b includes search user interface element 964c described above and fully displayed content row 964d including selectable user interface elements 964c, 964f, and 964g described above. In some embodiments, the fully expanded user interface element 964b includes content row 964h that includes a group of selectable user interface elements 964i and 964j that, when selected, causes the electronic device 960a to display collections of content (e.g., location experiences) personalized for the user of the electronic device 960a as described in more detail with reference to method(s) 800 and/or 1000. In some embodiments, the collections of personalized content include content associated with category (“The Best Italian Restaurants in San Francisco) the user recently searched for as represented by selectable user interface element 964i. In another example, the collections of personalized content include content associated with a physical area (“Best Hotels in Northern California”) that the user recently visited as represented by selectable user interface element 964j. In some embodiments, in response to detecting user input, such as a contact on touch screen 960b, actuation of a physical input device of the electronic device 960a or in communication with the electronic device 960a, and/or a voice input from the user corresponding to selection of the selectable user interface element 964j, the electronic device 960a displays the respective collection of content (e.g., location experiences) associated with the physical area (“Best Hotels in Norther California”) as described in more detail with reference to method(s) 800 and/or 1000.

In some embodiments, the electronic device 960a enables the user to create one or more personalized experiences (e.g., collections of content) described in method 1000. For example, in FIG. 9W, the electronic device 960a detects user input 966b that includes contact on touch screen 960b, actuation of a physical input device of the electronic device 960a or in communication with the electronic device 960a, and/or a voice input from the user corresponding to selection of the selectable user interface element 964k. In some embodiments, in response to detecting user input 966b directed to the selectable user interface element 964k, the electronic device 960a displays a creation user interface element 962 for creating a collection of personalized content as shown in FIG. 9X (e.g., a location experience as described in more detail with reference to method(s) 800 and/or 1000).

In FIG. 9X, the creation user interface element 962 includes content row 968a, content row 970a, and content row 972a. For example, content row 968a is optionally analogous to and/or includes one or more characteristics of content row 928a in FIG. 9C. The creation user interface element 962 also includes content row 972a that includes a group of selectable user interface elements 972b through 972d that, when selected, causes the computer system 101 to display collections of content associated with respective physical areas nearby the first physical area (e.g., San Francisco) displayed by map 964a in FIG. 9V.

In FIG. 9X, the content row 970a includes a group of selectable user interface elements that, when selected, cause the electronic device 960a to display collections of content associated with the first physical area created by the electronic device 960a, the collections of content personalized for the user of the electronic device 960a as described in more detail with reference to method(s) 800 and/or 1000. In some embodiments, the collections of personalized content include content associated with a point of interest within the first physical area. For example, the content row 970a includes a first collection of content associated with an indoor arena (“Chase Center”) the user has visited as represented by selectable user interface element 970b, and a second collection of content associated with a park (“Crane Cove”) the user has visited as represented by selectable user interface element 970c. In some embodiments, selectable user interface element 970b includes an indication of a number of content (e.g., “10 photos and 5 videos”) that will be included in the generated collection of content. In some embodiments, the electronic device 960a automatically selects the content to be included in the generated collection of content. In some embodiments, the electronic device 960a enables the user to modify the content to be included (e.g., add, remove, and/or edit the content) in a manner depicted in FIGS. 9T-9U and/or as described in more detail with reference to method(s) 800 and/or 1000. In some embodiments, the electronic device 960a includes more content than the number of content indicated in selectable user interface element 970b.

In FIG. 9X, the electronic device 960a detects user input 966c directed to selectable user interface element 970b. In some embodiments, detecting user input 966c is analogous to and/or includes one or more characteristics of detecting user input 966b in FIG. 9W. In some embodiments, in response to detecting user input 966c, the electronic device 960a displays in the creation user interface element 962 an animation 974 indicating that the respective collection of content (e.g., location experience) is being generated as shown in FIG. 9Y.

After the electronic device 960a generates the respective collection of content (described in more detail with reference to method(s) 800 and/or 1000), the electronic device 960a displays a second maps user interface element 976a that includes the respective collection of content associated with the indoor arena (“Chase Center”) the user has previously visited, such as a photo 976b of the arena taken by the user, a representation of a tour 976c of the arena that, when selected, causes the electronic device 960a to play the tour, and a photo 976d taken at the arena that includes the user. In some embodiments, the second maps user interface element 976a is analogous to and/or includes one or more characteristics of the second maps user interface element 932a in FIG. 9D.

In some embodiments, in response to detecting user input directed to a particular content item or representation, such as detecting user input 966d in FIG. 9Z, the electronic device 960a performs an action associated with the content item, such as displaying the content item, playing the content item, or performing a different action associated with the content item as described in more detail with reference to method(s) 800 and/or 1000. For example, in FIG. 9Z, the electronic device 960a detects user input 966d directed to the representation of the tour 976c of the arena. In some embodiments, detecting user input 966d is analogous to and/or includes one or more characteristics of detecting input 966b in FIG. 9W. In some embodiments, in response to detecting user input 966d directed to the representation of the tour 976c of the arena, the electronic device 960a plays the tour video 978a as shown in FIG. 9AA. In FIG. 9AA, the electronic device 960a also displays an option 978b that, when selected, causes the electronic device 960a to pause playback of the tour video 978a. In FIG. 9AA, the electronic device 960a also displays an option 986 that, when selected, closes or ceases to display the tour video 978a. For example, in FIG. 9AA, the electronic device 960a detects user input 966e directed to the option 986. In some embodiments, detecting user input 966e is analogous to and/or includes one or more characteristics of detecting input 966b in FIG. 9W. In some embodiments, in response to detecting user input 966e directed to option 986, the electronic device 960a ceases to display the tour video 978a and automatically displays the user interface element 962 in FIG. 9BB. User interface element 962 includes the second maps user interface element 976a and selectable options 976e through 976g that, when selected cause the electronic device 960a to display a respective collection of content associated with a respective category of content associated with the first physical area (e.g., San Francisco). For example, selecting selectable option 976f causes the electronic device 960a to display map 964a of FIG. 9V representing the first physical area including one or more pins or representations of public parking lots, parking garages, and/or the like located within the first physical area. In another example, selecting selectable option 976g causes the electronic device 960a to display map 964a of FIG. 9V representing the first physical area including one or more pins or representations of bars, pubs, beer gardens, and/or the like located within the first physical area. In yet another example in FIG. 9BB, the electronic device 960a detects user input 966f directed to selectable option 976e. In some embodiments, detecting user input 966f is analogous to and/or includes one or more characteristics of detecting input 966b in FIG. 9W. In some embodiments, in response to detecting user input 966f directed to selectable option 976e, the electronic device 960a displays the maps user interface 962 as shown in FIG. 9CC.

In FIG. 9CC, the maps user interface 962 includes a map 980a including a representation of the first physical area (e.g., San Francisco). FIG. 9CC also shows that, in some embodiments, the maps user interface 962 includes one or more representations (e.g., representations 980b through 980d) of restaurants located within the first physical area and a user interface element 982d overlaid on map 980a. In some embodiments, the user interface element 982d includes the list of restaurants 982 corresponding to the representations of restaurants in map 980a. In some embodiments, the electronic device 960a displays collections of content (e.g., a location experience) associated with the point of interest (e.g., restaurant “Roadside Burger). For example, in FIG. 9CC, the electronic device 960a displays a user interface element 982b that, when selected, causes the electronic device 960a to display a respective maps user interface element optionally analogous to and/or including one or more characteristics of the second maps user interface element 976a in FIG. 9BB. As shown in FIG. 9CC, the user interface element 982b also includes indications 982c of contacts who shared the respective collection of content and/or content in the respective collection of content associated with the point of interest to the user of the electronic device 960a as described in more detail with reference to method(s) 800 and/or 1000. In some embodiments, the indications 982c include images, avatars, and/or other graphics representing the contacts.

FIG. 10 is a flowchart illustrating an exemplary method of displaying a collection of content associated with a physical location in response to user input corresponding to a request to generate the collection of content associated with the physical location in accordance with some embodiments.

In some embodiments, method 1000 is performed at a computer system (e.g., 101) in communication with a display generation component (e.g., 120) and one or more input devices (e.g., 314). In some embodiments, the computer system has one or more of the characteristics of the computer system of method 800. In some embodiments, the one or more input devices have one or more of the characteristics of the one or more input devices of method 800. In some embodiments, the display generation component has one or more of the characteristics of the display generation component of method 800.

In some embodiments, while displaying, via the display generation component, a user interface of a map application, such as user interfaces and/or user interface elements 902 and/or 904a in FIG. 9A; user interfaces and/or user interface elements 962 in FIG. 9V and/or 984 in FIG. 9X, the computer system receives (1002a), via the one or more input devices, a first input corresponding to a request to generate a respective collection of content (e.g., a location experience as described with reference to method 800) associated with a respective physical area, such as input 906b in FIG. 9B.

In some embodiments, the user interface has one or more of the characteristics of the user interface of method 800. In some embodiments, the computer system displays the user interface within a three-dimensional environment as described in method 800 and in more detail below. In some embodiments, the computer system detects a first user input (e.g., a gaze of a user of the computer system, a contact on a touch-sensitive surface, actuation of a physical input device, a predefined gesture (e.g., pinch gesture or air tap gesture) and/or a voice input from the user) corresponding to the request to generate the respective collection content associated with a respective physical area. For example, and as will be described below, the computer system detects that the first user input is optionally directed to a map user interface element (or map representation or navigation user interface element described below) representing the respective physical area. In some embodiments, the computer system presents the respective collection of content associated with the respective physical area in response to the first input without requiring additional user input (e.g., without a separate user input or without explicit interaction such as interacting with the map user interface element representing the respective physical area).

In some embodiments, the respective physical area is a neighborhood, town, city, state, country, continent, or other geographic area. In some embodiments, the respective physical area is an area centered on a location of the computer system that is optionally based on location data (e.g., GPS data) without requiring user input to provide the location of the computer system. In some embodiments, the respective physical area is an area that is selected and/or identified by the user via the map user interface element (or map representation or navigation user interface element described below). For example, the computer system optionally detects user input to pan, scroll, zoom, and/or rotate a navigation user interface element, and in response to detecting the user input, the computer system optionally initiates a process to generate a respective collection of content associated with the respective physical area that is displayed in response to, while, and/or after detecting the user input. In another example, the user interface optionally includes a search user interface element. In some embodiments, the first input corresponding to the request to generate the respective collection of content associated with the respective physical area includes interaction with the search user interface element to conduct a search using text input by the user (identifying the respective physical area) as search parameters for input to the request to generate respective collection of content.

In some embodiments, the respective collection of content associated with the respective physical area has one or more of the characteristics of the location experience of method 800. For example, the respective collection of content associated with the respective physical area includes content (and/or representation(s) of content) captured by the user of the computer system while at or nearby the respective physical area, representation(s) of points of interest at or nearby the respective physical area, and/or other location-based content (and/or representation(s) of other location-based content) as discussed in method 800 and in further detail below.

In some embodiments, in response to receiving the first input, the computer system displays (1002b), in the user interface, a respective user interface element associated with the respective collection of content associated with the respective physical area, such as user interface element 902 in FIG. 9C. In some embodiments, the respective user interface element (e.g., content container-type user interface, such as a window) includes the respective collection of content associated with the respective physical area. For example, the computer system optionally displays, in the respective user interface element, representation(s) of respective collection(s) of content associated with a respective physical area. In some embodiments, the computer system updates the representation(s) of respective collection(s) of content displayed in the respective user interface element based on the first input corresponding to the request to generate the respective collection content associated with a respective physical area as described above and below. In some embodiments, the computer system displays representation(s) of respective collection(s) of content based on a user account associated with the computer system as will be described in more detail below. In some embodiments, the computer system displays representation(s) of respective collection(s) of content based on object(s) identified in the content, such as a person, animal, food, plant, artwork, landmark, and/or other object identifier as will be described in more detail below.

In some embodiments, while displaying the respective user interface element, the computer system receives (1002c), via the one or more input devices, a second input directed to the respective user interface element, such as gaze 908 in FIG. 9B. In some embodiments, the second input has one or more of the characteristics of the first input described above. For example, the second input is optionally a gaze of the user of the computer system directed to the respective user interface element, contact on a touch-sensitive surface corresponding to selection of the respective user interface element, a predefined gesture (e.g., pinch gesture or air tap gesture) directed to the respective user interface element and/or a voice input from the user.

In some embodiments, in response to receiving the second input (1002d), and in accordance with a determination that the first input was directed to a first physical area, such as input 908b in FIG. 9B, the computer system displays (1002e), in the user interface of the map application, a representation of a first collection of content associated with the first physical area and a navigation user interface element representing the first physical area, such as a first collection of content associated with selectable user interface element 928b and navigation user interface element 904a in FIG. 9C.

For example, the computer system optionally determines that the first input as described above corresponding to the request to generate a respective collection of content is directed to a first area of a navigation user interface element (or a map representation) representing and/or corresponding to the first physical area. For example, the first input optionally includes a gaze of the user of the computer system, contact on a touch-sensitive surface, actuation of a physical input device (e.g., mouse, trackpad, button, and/or the like), and/or a predefined gesture (e.g., pinch gesture or air tap gesture) directed to the first physical area, wherein the first physical area corresponds to the area included in the navigation user interface element while (and/or in response to) detecting the first input. In some embodiments, the navigation user interface element has one or more of the characteristics of the navigation user interface element of method 800.

In another example, the computer system optionally determines that the first input is directed to the first physical area without detecting user input directed to the navigation user interface element. For example, the computer system optionally receives voice input specifying the first physical area. Thus, in this instance, the computer system optionally determines the first input is directed to the first physical area (e.g., voice input specifying the first physical area) without requiring input directed to the navigation user interface element.

In some embodiments, the computer system displays a representation of a first collection of content associated with the first physical area in the user interface of the map application and/or in the respective user interface element. In some embodiments, the navigation user interface element is oriented along a horizontal surface in the three-dimensional environment or floating along a horizontal plane and the respective user interface element including the first collection of content associated with the first physical area oriented vertically. In some embodiments, the computer system will change the display of the navigation user interface element (e.g., rotate, re-size, and/or tilt) and/or render a respective portion of the navigation user interface element at a zoom level to focus on an area and/or location of the map that represents the first physical area. In some embodiments, the navigation user interface element is a two-dimensional map representing the first physical area.

In some embodiments, the computer system receives, via the one or more input devices, a third input directed to the representation of the first collection of content associated with the first physical area, and in response to receiving the third input, the computer system displays, via the display generation component, a second representation of the first collection of content associated with the first physical area that includes animated content as discussed in method 800 and in further detail below. In some embodiments, the animated content experience includes user interactions and/or content analogous to the location experience(s) as described with reference to method 800 and in more detail below.

In some embodiments, in response to receiving the second input, and in accordance with a determination that the first input was directed to a second physical area different from the first physical area, such as input 906P in FIG. 9P, the computer system displays (1002f), in the user interface of the map application, a representation of a second collection of content associated with the second physical area and a navigation user interface element representing the second physical area, such as a second collection of content associated with selectable user interface element 922b and navigation user interface element 904a in FIG. 9Q.

In some embodiments, the second physical area includes a larger or smaller area than the first physical area. In some embodiments, the second collection of content does not include content that is included in the first collection of content. In some embodiments, the second collection of content does include content included in the first collection of content. It is understood that although the embodiments described herein are directed to the first collection of content associated with the first physical area, such functions and/or characteristics, optionally apply to other collection(s) of content, such as the second collection of content associated with the second physical area. For example, the computer system determines that the first input is directed to a second physical area, different from the first physical area, and in response, the computer system displays in the user interface a representation of the second collection of content associated with the second physical area optionally analogous to displaying the representation of the first collection of content associated with the first physical area. In some embodiments, the computer system displays the navigation user interface element representing the second physical area optionally analogous to displaying the navigation user interface element representing the first physical area.

Automatically surfacing a collection of content associated with a physical area in response to user input corresponding to a request to generate the collection of content associated with the physical area provides an efficient way of viewing content corresponding to the physical area without leaving the user interface of the map application, thereby reducing the need for subsequent inputs to locate content related to the physical area which simplifies the interaction between the user and the computer system and enhances the operability of the computer system and makes the user-computer system interface more efficient. In some embodiments, the first collection of content associated with the first physical area includes content associated with a first physical location within a threshold distance (e.g., 0.5, 1, 3, 5, 7, 10, 20, 30, 40, or 50 kilometers) of the first physical area, such as for example, the respective collection of content associated with content row 924 in FIG. 9B.

In some embodiments, the first physical location is within the first physical area, such as a neighborhood, street, or block within a city or town. In some embodiments, the first collection of content includes photos, videos, and/or other content described above, below, and in method 800 captured at the first physical location. For example, the first collection optionally includes photos taken in the first physical location (e.g., downtown Los Angeles) within the threshold distance of the first physical area (e.g., West Hollywood Los Angeles). In another example, the first collection of content optionally includes representations of travel guides (described below) corresponding to the first physical location. For example, a travel guide optionally includes information about restaurants, landmarks, points of interest, and/or other geographic features located at the first physical location (e.g., Hollywood Boulevard) within the threshold distance of the first physical area (e.g., West Hollywood Los Angeles).

In some embodiments, the content included in the collection is (are) captured at different locations (e.g., the first location, a second location, and/or other location, different from the first location) within a same area (e.g., the first physical area). For example, the first collection of content optionally includes a first photo taken at Golden Gate Bridge, a second photo taken at Fort Point National Historic Site, and a first video taken at Golden Gate Beach. In some embodiments, the computer system includes the first photo, the second photo, and the first video in the first collection because they were taken within the first physical area (e.g., Presidio San Francisco). In some embodiments, the computer system determines that a second video was captured at a second physical location, different from the first physical location, and beyond a threshold distance (e.g., 10, 20, 30, 50, 100, 200, 300, 500, or 1000 kilometers) from the first physical area. In some embodiments, when the computer system determines that the second video was captured at the second physical location, the computer system includes the second video in a second collection of content associated with the second physical location.

In some embodiments, while the computer system displays the first collection of content in the user interface (e.g., described above), the computer system concurrently displays a second representation of the first collection of content within the navigation user interface element as will be described in more detail below. In some embodiments, the second collection of content associated with the second physical area includes content associated with a second physical location within the threshold distance (described herein) of the second physical area, such as for example, the respective collection of content associated with content row 930 in FIG. 9C.

In some embodiments, the second physical area is different from the first physical area. For example, the second physical area is optionally San Francisco and the first physical area is optionally Los Angeles. In some embodiments, the second physical area and the first physical area are within a same portion of a physical map, such as San Francisco and Los Angeles within California. In some embodiments, the computer system automatically groups collections of content based on their associated physical location without user input indicating to which physical location the collection of content should be associated with. It is understood that although the embodiments described herein are directed to the first physical location and the first physical area, such functions and/or characteristics, optionally apply to other physical locations and physical areas including the second physical location and the second physical area.

In some embodiments, while displaying the navigation user interface element representing the second physical area including the second collection of content and/or representations of the second collection of content associated with the second physical area, the computer system receives an input corresponding to a request to pan and/or zoom the navigation user interface element, and in response the computer system changes the display of the navigation user interface element representing the second physical area to represent the first physical location. For example, the computer system changes the display of the navigation user interface element representing West Hollywood Los Angeles to represent downtown Los Angeles including the respective collection of content and/or representations of the respective collection of content associated with downtown Los Angeles.

In another example, the content(s) included in the collection is (are) captured at different locations (e.g., a first location, a second location different from the first location, and/or other location, different from the first location and the second location) within a same area (e.g., a first physical area). For example, the respective collection of content optionally includes a first photo taken at Golden Gate View Point, a second photo taken at Fort Point National Historic Site, and a first video taken at Golden Gate Beach. In some embodiments, the second representation of said respective collection of content is displayed at a respective location within the navigation user interface element corresponding to a significant location based on the content(s) included in the collection (e.g., the first photo, the second photo, and the first video). In some embodiments, the computer system designates and/or identifies the significant location as a physical location of one (or more) of the content(s). For example, the computer system optionally determines that a majority of content (e.g., 50, 60, 70, 80, 90, or 100 percent) included in the first collection was captured at a first physical location (e.g. Golden Gate Beach), and in accordance with the determination that the majority of content included in the first collection was captured at the first physical location, the computer system displays the second representation of the respective collection of content at a respective location within the navigation user interface element corresponding to the first physical location (e.g. Golden Gate Beach). In another example, the computer system optionally designates and/or identifies the significant location as a physical location that is within a respective radius (e.g., 0.1, 0.3, 0.5, 1, 3, 5, 10, 20, 30, 40, or 50 kilometers) of the physical locations associated with the one (or more) content(s). In some embodiments, the significant location is a major landmark, geographic feature, building, and/or point of interest based on map data. In some embodiments, the significant location is a popular location frequently visited by users based on map data. In some embodiments, the significant location is associated with a historical, cultural, or social event based on map data. For example, the computer system optionally requests map data from a remote server in communication with the computer system and/or a local processor (e.g., maintained by the computer system optionally from a map application operating on the computer system) for retrieving map information including identifying significant locations with a respective physical area. Similar to the example, above, the computer system optionally displays the second representation of the respective collection of content at a respective location within the navigation user interface element corresponding to a significant location (e.g., Golden Gate Park) that is within the respective radius of the first photo taken at Golden Gate View Point, the second photo taken at Fort Point National Historic Site, and the first video taken at Golden Gate Beach.

Providing a collection of content associated with a physical location within a threshold distance of a physical area provides an efficient way of viewing content associated with the physical area without leaving the user interface of the map application, thereby reducing the need for subsequent inputs to locate content related to the physical area which simplifies the interaction between the user and the computer system and enhances the operability of the computer system and makes the user-computer system interface more efficient.

In some embodiments, the first collection of content associated with the first physical area includes content associated with the first physical location within the threshold distance of the first physical area (described above) and within a first predetermined time span (e.g., 1 day, 3 days, 1 week, 2 weeks, 1 month, 3 months, 6 months, or 1 year), such as shown by the time span indication associated with the group 956i of content in FIG. 9T. For example, the first predetermined time span is optionally from a current time/date (e.g., at the moment when the computer system received the first input described above).

In some embodiments, the first collection of content includes content described above that was captured within a duration that spans one or more days, weeks, months, or years. In some embodiments, the first collection of content was captured at the first physical location within the first predetermined time span. In some embodiments, the content was captured at a respective location within a predetermined distance (described above) from the first physical location within the first predetermined time span. Similar to the example described above, the first collection optionally includes photos taken in the first physical location (e.g., downtown Los Angeles) within the threshold distance of the first physical area (e.g., West Hollywood Los Angeles), and optionally within a time span of one day. Similar to the example described above, the first collection of content optionally includes restaurants, landmarks, points of interest, and/or other geographic features of a travel guide (described below) located at the first physical location (e.g., Hollywood Boulevard) within the threshold distance of the first physical area (e.g., West Hollywood Los Angeles), and optionally created within the last three months.

In some embodiments, the second collection of content associated with the second physical area includes content associated with the second physical location within the threshold distance of the second physical area (described above) within a second predetermined time span (e.g., same or different from the first predetermined time span described herein), such as shown by the time span indication associated with the group 956j of content in FIG. 9T.

It is understood that although the embodiments described herein are directed to content within a first predetermined time span, such functions and/or characteristics, optionally apply to other content within other predetermined time spans including the content within the second predetermined time span. In some embodiments, the user interface includes a user interface element that, when selected, causes the computer system to filter and display a respective collection of content based on a user-selected predetermined time span.

In some embodiments, the computer system generates for display a third collection of content associated with the first physical location (described herein) over a timespan, different from the first predetermined time span. In some embodiments, the computer system generates for display a fourth collection of content associated with the second physical location (described herein) over a timespan, different from the second predetermined time span.

Providing a collection of content associated with a physical location within a threshold distance of a physical area, and within a predetermined time span provides an efficient way of viewing content captured and/or created within a predetermined time span without leaving the user interface of the map application, thereby reducing the need for subsequent inputs to locate content related to the physical area within a predetermined time span which simplifies the interaction between the user and the computer system and enhances the operability of the computer system and makes the user-computer system interface more efficient.

In some embodiments, the computer system displays, via the display generation component, a second representation of the respective collection of content within the navigation user interface element, such as displaying user interface element 932a in FIG. 9D, user interface element 902 in FIG. 9L, and/or user interface element 976a in FIG. 9BB. In some embodiments, the second representation of the respective collection of content is optionally analogous to and/or has one or more of the characteristics of a representation of a respective point of interest and/or a representation of a respective location experience described in method 800.

For example, the respective collection of content optionally includes a first representation (e.g., user interface element) of a restaurant favorited by the user of the computer system (e.g., saved as a favorite) located in the Chase Center indoor arena and a first panoramic photo taken at the Chase Center. In some embodiments, the computer system displays the respective collection of content adjacent to (e.g., above) the navigation user interface element within the three-dimensional environment. In some embodiments, the computer system concurrently displays the respective collection of content and the second representation of the respective collection of content within the navigation user interface element. In some embodiments, the second representation of said respective collection of content is displayed at a respective location within the navigation user interface element corresponding to the physical location of the Chase Center.

In some embodiments, the second representation of the respective collection of content optionally includes a pin, icon, label, or user interface element overlaid onto a respective location within the navigation user interface element corresponding to the physical location of the content. For example, the computer system optionally displays a pin indicative of a collection of content (e.g., photos, videos, text, models, and/or the like) related to the Alcatraz Federal Penitentiary at a respective location within the navigation user interface element corresponding to the physical location (e.g., Alcatraz island in the San Francisco Bay) of the Alcatraz Federal Penitentiary. In another example, the second representation of the respective collection of content optionally includes a user interface element (e.g., content window or volume) including a preview or first amount of content, such as a label and/or photo. In some embodiments, the computer system receives user input (e.g., analogous to and/or has one or more of the characteristics of the first input described above) directed to the user interface element, and in response, the computer system increases the size (e.g., displays an expanded version) of the user interface element to include a second amount of content, greater than the first amount of content (e.g., a plurality of (or representations of) photos, videos, content, text, models, and/or the like). In some embodiments, in response to receiving the user input directed to the user interface element including the preview of the first amount of content, the computer system updates the respective user interface element (described above) to include the respective collection of content. For example, user input directed to the pin or user interface element (representing the respective collection of content) within the navigation user interface element optionally causes the respective user interface element, different from the navigation user interface element, to display the respective collection of content. In another example, in response to receiving the user input directed to the user interface element including the preview of the first amount of content, the computer system performs an operation associated with the respective collection of content, such as play a video or animated content (described below), display a model associated with the respective collection of content (e.g., three-dimensional mode of the Alcatraz Federal Penitentiary), and/or perform another operation as will be described in more detail below and/or with reference to method 800.

Displaying a second representation of the respective collection of content within the navigation user interface element provides quick display of the location corresponding to the respective collection of content without requiring the user to provide further inputs to pan and/or zoom to the location corresponding to the respective collection of content, thereby reducing the number of inputs and providing more efficient interactions between the user and the computer system.

In some embodiments, while displaying the navigation user interface element including the second representation of the respective collection of content (described above), the computer system receives, via the one or more input devices, a third input directed to the second representation of the respective collection of content, such as input 906d in FIG. 9D.

In some embodiments, the third input has one or more of the characteristics of the first input and/or second input described above. For example, the third input optionally includes a gaze of the user of the computer system directed to the second representation of the respective collection of content, contact on a touch-sensitive surface corresponding to selection of the second representation of the respective collection of content, a predefined gesture (e.g., pinch gesture or air tap gesture) directed to the second representation of the respective collection of content and/or a voice input from the user targeting the second representation of the respective collection of content.

In some embodiments, in response to receiving the third input directed to the second representation of the respective collection of content, the computer system displays, via the display generation component, animated content associated with the respective collection of content, such as aerial tour video 934a in FIG. 9E.

In some embodiments, displaying the animated content including the animated content itself is optionally analogous to and/or has one or more of the characteristics of the animated content described in method 800. For example, the animated content optionally includes aerial tours, panoramas, photos, videos, audio, animations, and/or other curated content corresponding and/or including the respective collection of content. In another example, the animated content optionally features personalized photos, videos, and/or other media from the respective collection of content.

Displaying animated content associated with the respective collection of content provides an efficient way of viewing content corresponding to the respective physical area without having to leave the user interface of the map application, thereby reducing the need for subsequent inputs to search for content corresponding to the respective physical area which simplifies the interaction between the user and the computer system and enhances the operability of the computer system and makes the user-computer system interface more efficient.

In some embodiments, while displaying the user interface of the map application (described above), the computer system concurrently displays, via the display generation component, a first user interface element that, when selected, causes the computer system to navigate through the respective collection of content, such as user interface element 952a in FIG. 9M.

In some embodiments, the computer receives and/or detects selection of the first user interface element via a user input, such as the first input, the second input, and/or other input described above corresponding to a request to select the first user interface element for navigation through the respective collection of content. In some embodiments, the computer system displays the respective collection of content the first user interface element. For example, the first user interface element is optionally a user interface container element/virtual object including visible or invisible boundaries. In some embodiments, the first user interface element is optionally moveable and/or rotatable such as a virtual carousel, virtual scroll wheel, a virtual dial, a virtual slider, or a virtual picker configured to allow for presenting and navigating within a continuum or sequence of the respective collection of content.

In some embodiments, the computer system displays the first user interface element floating above the navigation user interface element in the three-dimensional environment. In some embodiments, displaying the first user interface element includes displaying a first content item of the respective collection of content and (optionally) one or more other content items albeit partially displayed. In some embodiments, while displaying the first content item, the computer system receives user input to navigate through the respective collection of content. In some embodiments, the user input is a swipe gesture or a scroll gesture in a first (forward) direction or a second (backwards) direction. In some embodiments, in response to receiving the user input, the computer system displays a second content item of the respective collection of content and ceases display of at least portion of the first content item. In some embodiments, the computer system continues to display respective content items in the respective collection of content in accordance with the user input (e.g., in accordance with movement in the first direction or second direction described herein).

In some embodiments, the computer system will change the display of the navigation user interface element (e.g., rotate, re-size, and/or tilt) and/or render a respective portion of the navigation user interface element at a zoom level to focus on an area and/or location of the map that represents the respective collection of content as described below and/or with reference to method 800. For example, in response to (or while) navigating through the respective collection of content, a first content (e.g., a photo) corresponding to a first physical location (e.g., Oracle Park) is currently displayed and in response to (or while) the first content (or representation of the first content) is displayed, the computer system displays the navigation user interface element zoomed in on a respective location within the navigation user interface element corresponding to the first physical location.

Navigating through the respective collection of content in response to selection provides quick access to the collection of content without requiring the user to provide further inputs to leave the user interface of the map application and locate the collection of content, thereby reducing the number of inputs and providing more efficient interactions between the user and the computer system.

In some embodiments, while displaying the navigation user interface element including the second representation of the respective collection of content (described above), the computer system receives, via the one or more input devices, a third input corresponding to a request to change a zoom level of the navigation user interface element, such as input 906b in FIG. 9B.

In some embodiments, the third input has one or more of the characteristics of the first input and/or second input described above. For example, the third input is optionally a gaze of the user, a contact on a touch-sensitive surface, actuation of a physical input device, a predefined gesture (e.g., pinch gesture or air tap gesture) and/or a voice input from the user corresponding to the request to change the zoom level of the navigation user interface element. In some embodiments, the third input is directed to the navigation user interface element. In some embodiments, the third input is directed to a user interface element that, when selected, initiates the process to change the zoom level as described herein. For example, the third input is optionally a pinch to zoom gesture while attention of the user is directed to the navigation user interface element (e.g., a predetermined portion of the navigation user interface element and/or a user interface element/virtual object associated with (and/or within) the navigation user interface element that is selectable to change the zoom level) while a hand of the user performs a pinch air gesture that includes the tips of the thumb and index fingers of the hand coming together and touching, or the index finger in direct interaction with the virtual object associated with the navigation user interface element selectable to change the zoom level (e.g., air tapping or air touching), or while two hands of the user come together towards each other (e.g., to zoom out of the respective portion of the navigation user interface element) or away from each other (e.g., to zoom into the respective portion of the navigation user interface element). For example, the computer system initially displays the navigation user interface element with a first zoom level appropriate for the respective collection of content (as described above), such that the navigation user interface element is optionally centered on an area and/or portion associated with a respective physical location corresponding to the respective collection of content and/or a significant location associated with the respective collection of content as described above (e.g., without changing the viewpoint of the user of the computer system). In some embodiments, the computer system changes the zoom level in response to voice input from the user corresponding to the request to change the zoom level of the navigation user interface element.

In some embodiments, while the computer system displays the navigation user interface element with the first zoom level as described herein, the computer system displays the second representation of the respective collection of content within the navigation user interface element as described above. In some embodiments, in response to the request to change the zoom level of the navigation user interface element, the computer system displays a third representation of third collection of content, different from the second representation of the respective collection of content as will be described in more detail herein.

In some embodiments, in response to receiving the third input corresponding to the request to change the zoom level of the navigation user interface element, the computer system changes the display of the navigation user interface element representing a respective physical location to represent a third physical location, different from the respective physical location, wherein the third physical location includes a third representation of a third collection of content, different from the second representation of the respective collection of content, such as illustrated in FIG. 9C with user interface element 902 and navigation user interface element 904a.

In some embodiments, the computer system changes the display of the navigation user interface element depending on the level of zoom (e.g., amount of zoom) applied to the navigation user interface element in response to the third input as described herein. In some embodiments, when the computer system changes the display of the navigation user interface element representing the respective physical location associated with the respective collection of content to the third physical location, the navigation user interface element is centered on an area and/or portion associated with the third physical location that is larger or smaller than the area and/or portion associated with the respective physical location when the navigation user interface element represented the respective physical location (e.g., prior to the third input to change the zoom level of the navigation user interface element). For example, when the navigation user interface element represents the respective physical location, the navigation user interface element includes natural features (e.g., landforms, plants, etc.), optionally without showing manmade features (e.g., buildings, infrastructure, etc.) that are displayed when the navigation user interface element represents the third physical location.

In some embodiments, the third representation of the third collection of content is optionally analogous to and/or has one or more of the characteristics of a representation of a respective point of interest and/or a representation of a respective location experience described in method 800. As described above, in some embodiments, the second representation of the respective collection of content optionally includes a pin, icon, label, or user interface element overlaid onto a respective location within the navigation user interface element corresponding to the physical location of the content. For example, and as described in more detail above, the computer system optionally displays a pin indicative of a collection of content (e.g., photos, videos, text, models, and/or the like) related to Golden Gate Park at a respective location within the navigation user interface element corresponding to the physical location of Golden Gate Park. In some embodiments, when the computer system changes the display of the navigation user interface element from including the second representation of the respective collection of content to including the third representation of third collection of content the third representation of the third collection of content is larger or smaller than the second representation of the respective collection of content. For example, and as described herein, the second representation of the respective collection of content is optionally a pin, and the third representation of the third collection of content is optionally a user interface element that is a size larger than the pin and/or includes more information than the respective information found associated with (contained within) the second representation of the collection of content.

In some embodiments, the navigation user interface element representing the third physical location including the third representation of third collection of content is more granular or less granular than the navigation user interface element representing the respective physical location including the second representation of the respective collection of content. In some embodiments, the third collection of content is a subset of the respective collection of content. For example, the third collection of content optionally includes content items associated with the third physical location that are a subset of content items of the respective collection of content items associated with the respective physical location, such as content items captured in the Mission Bay neighborhood of San Francisco. Thus, in this instance, while the computer system displays the second representation of the respective collection of content (e.g., photos, videos, and/or the like captured in San Francisco), and in response to user input to zoom in on the navigation user interface element representing the respective physical location, the computer system optionally changes the navigation user interface element to represent the third physical location including displaying the third representation of the third collection of content (e.g., photos, videos, and/or the like captured in the Mission Bay neighborhood of San Francisco).

In another example, in response to user input to zoom out of the navigation user interface element representing the respective physical location, the computer system optionally changes the navigation user interface element to represent a fourth physical location including displaying a fourth representation of third respective collection of content (e.g., photos, videos, and/or the like captured in California). Thus, in this instance, displaying the navigation user interface element representing the fourth physical location corresponds to a larger area and/or portion of the navigation user interface element than the area and/or portion associated with the respective physical location when the navigation user interface element represented the respective physical location (e.g., prior to the user input to zoom out of the navigation user interface element).

In some embodiments, a number of representation(s) of respective collection(s) of content displayed within the navigation user interface element is based on the zoom level. For example, displaying the navigation user interface element representing a particular zoom level optionally includes a larger, smaller, or a same number of representation(s) of respective collection(s) of content than when displaying the navigation user interface element representing the respective physical location (e.g., prior to the user input to change the zoom level of the navigation user interface element).

Changing the display of the navigation user interface element representing a respective physical location to represent a third physical location including a third representation of a third collection of content, different from the second representation of the respective collection of content in response to a request to change a zoom level of the navigation user interface element provides quick display of the respective collection of content in an organized manner which reduces clutter caused by displaying too many or not enough representations of respective collections of content, thereby reducing the cognitive burden on the user and providing more efficient interactions between the user and the computer system.

In some embodiments, while displaying a respective representation of the respective collection of content associated with a respective physical area and the navigation user interface element representing the respective physical area (described above), the computer system displays, via the display generation component, the user interface including a first user interface element that, when selected, causes the computer system to share the respective collection of content associated with the respective physical area with a second computer system, different from the computer system, such as illustrated in FIG. 9P with user interface element 940a.

For example, the computer system receives user input to select the first user interface element, and in response to receiving the user input, the computer system displays a second user interface element including representations of user accounts selectable to share the respective collection of content to. In some embodiments, while displaying the second user interface element, the computer system receives a second user input corresponding to selection of one or more of the representations of user accounts, and in response to receiving the second user input, the computer system initiates a process to share the respective collection of content.

In some embodiments, a same user account is associated with the second computer system and the computer system. In some embodiments, a first user account is associated with the computer system and a second user account, different from the first user account is associated with the second computer system. In some embodiments, the first user interface element is an affordance, a virtual button, icon, label, or other virtual object. In some embodiments, the respective collection of content is shared with other computer systems, for example, using a messaging application, an email application, and/or a wireless ad hoc service. In some embodiments, sharing the respective collection of content with the second computer system includes transmitting the respective collection of content from the computer system to the second computer system, or from a server in communication with the computer system to the second computer system. In some embodiments, sharing the respective collection of content with the second computer system includes displaying the respective collection of content (and/or a representation of the respective collection of content) at the second computer system in a manner appropriate for the one or more display generation components of the second computer system, such as with respect to display size, and/or virtual content rendering. In some embodiments, sharing the respective collection of content with the second computer system includes displaying a respective representation of the respective collection of content within a navigation user interface element that is displayed at the second computer system. In some embodiments, the displayed respective collection of content optionally including the representation of the respective collection of content displayed within the navigation user interface element at the second computer system is optionally analogous to displaying the respective collection of content (and/or the representation of the respective collection of content) including the respective representation of the respective collection of content within the navigation user interface element at the computer system as described above and/or below.

Allowing the respective collection of content associated with the respective physical area to be shared increases collaboration, thereby improving the interaction between the user and the computer system and ensuring consistency of information displayed across different computer systems. In some embodiments, displaying the first user interface element includes displaying an indication of a contact of the second computer system associated with the respective collection of content, such as indications 922c of contacts in FIG. 9B.

In some embodiments, the second computer system associated with the respective collection of content includes a user account identified in the respective collection of content (e.g., by name, face, and/or other characteristic using one or more techniques in the field(s) of facial recognition, pattern recognition, optical character recognition, machine learning, and/or other recognition technique to detect and/or identify a person, animal, landmark, scene, painting, or other object). In some embodiments, the first user interface element (described above) is a window or volume overlaid onto the user interface of the map application. In some embodiments, the first user interface element includes a plurality of representations of contacts of respective computer systems including the indication of the contact of the second computer system associated with the respective collection of content. In some embodiments, the plurality of contacts including the contact of the second computer system is an affordance, a virtual button, icon, label, or other virtual object that, when selected causes the computer system to share the respective collection of content with a respective computer system, different from the computer system. In some embodiments, the contact of the second computer system associated with respective collection of content includes displaying a representation of the contact with an appearance that indicates that the contact is associated with the respective collection of content (e.g., the contact is captured in the respective collection of content, the contact is capturing the content that is part of the respective collection of content, the content was captured at a location associated with the contact (e.g., at the contact's home, city, and/or the like), the content was captured by a device of the contact and/or the content was shared from the contact as described in more detail below). In some embodiments, the computer system automatically identifies the contact as being associated with the respective collection of content without user input associating the contact with the respective collection of content. In some embodiments, the representation of the contact is displayed with a color, shading, and/or other visual effect different from representation(s) of other contacts not associated with the respective collection of content.

In some embodiments, when the computer system determines that a first set of contacts are associated with the respective collection of content, the computer system, displays the first set of contacts as suggested recipients of the respective collection of content as described in more detail below. In some embodiments, when the computer system determines that a second set of contacts, different from the first set of contacts, is associated with the respective collection of content, the computer system, displays the second set of contacts as suggested recipients of the respective collection of content. In some embodiments, the second set of contacts includes one or more additional contacts or one or more less contacts than the first set of contacts.

Displaying an indication of a contact of the second computer system associated with the respective collection of content enables a user to quickly locate and share the respective collection of content to a contact associated with the respective collection of content, thereby reducing the need for subsequent inputs to identify a contact associated with the respective collection of content, which reduces power usage and improves battery life of the computer system by enabling the user to use the computer system more quickly and efficiently and without the need for additional inputs for navigating through the collection of content and identifying contact(s) associated with the content.

In some embodiments, the user interface of the map application includes a representation of a third collection of content, such as selectable user interface element 964i in FIG. 9W. In some embodiments, the representation of the third collection of content is optionally analogous to and/or has one or more of the characteristics of the representation of the first collection of content described above. In some embodiments, while the computer system displays the representation of the first collection of content in the user interface (e.g., described above), the computer system concurrently displays the representation of the third collection of content in the user interface. In some embodiments, the user interface includes one or more rows of representations of collections of content. For example, a first row optionally includes the representation of the first collection of content and a second row (located adjacent to and/or below the first row) includes the representation of the third collection of content.

In some embodiments, in accordance with a determination that a current location of the computer system is a third location, the third collection of content is associated with the third location, such as the first physical location associated with map 964a in FIG. 9V.

In some embodiments, the current location of the computer system corresponds to the physical location of the computer system as determined by GPS-based location services. For example, the user of the computer system has optionally enabled location services for the computer system while the map application is operating on the computer system. In another example, when the user disables location services for the map application and/or the computer system, the computer system and/or map application does not identify the current location of the computer system. In some embodiments, the third collection of content associated with the third location (e.g., the current location of the computer system) includes content captured at respective physical locations that are within a predetermined radius (e.g., 0.1, 0.3, 0.5, 1, 3, 5, 10, 20, 30, 40, or 50 kilometers) of the current location of the computer system.

In some embodiments, in accordance with a determination that the current location of the computer system is a fourth location, different from the third location, the third collection of content is associated with the fourth location, such as for example, the physical location that is shown by navigation user interface element 904a in FIG. 9L.

In some embodiments, the computer system displays the third collection of content associated with the fourth physical area optionally analogous to displaying the third collection of content associated with the third physical area. In some embodiments, the third collection of content associated with the fourth location includes content different from the third collection of content associated with the third location. In some embodiments, the third collection of content is associated with a previously searched for location by the computer system in response to user input. In some embodiments, in accordance with a determination that a previously searched for location by the computer system is a fifth location, (optionally the same or different from the fourth location), the third collection of content is associated with the fifth location. In some embodiments, the fifth location (e.g., the previously searched for location) includes content captured at respective physical locations that are within a predetermined radius (e.g., 0.1, 0.3, 0.5, 1, 3, 5, 10, 20, 30, 40, or 50 kilometers) of the previously searched for location by the computer system.

In some embodiments, the computer system automatically groups or selects content into a collection based on various criteria, such as location, timing, associated contacts, and/or other criteria described above and/or below. Providing a respective collection of content in accordance with a current location of the computer provides quick and efficient access to relevant content without the need for additional inputs for searching for such content and avoids erroneous inputs related to searching for such content, thereby reducing the number of inputs and providing more efficient interactions between the user and the computer system. In some embodiments, the user interface of the map application includes a representation of a third collection of content associated with a third physical location shared by a contact of the computer system, such as user interface element 982b in FIG. 9CC.

In some embodiments, the representation of the third collection of content is optionally analogous to and/or has one or more of the characteristics of the representation of the first collection of content described above. In some embodiments, the contact of the computer system is a second user different from the user of the computer system. In some embodiments, the third collection of content was previously shared with the computer system by the contact of the computer system. In some embodiments, the third collection of content shared by a contact includes content shared using a messaging application, an email application, a media content application, a social media application, web browsing application, a photos application, and/or a wireless ad hoc service. In some embodiments, content that is shared by a contact is automatically presented via the map application, such as automatically included (without user input) in the third collection of content. In some embodiments, the representation of the third collection of content includes an indication that the contact of the computer system shared the collection of content and/or content in the collection to the user of the computer system. For example, the content optionally includes photos, videos, travel guides, and/or the like that was shared from the contact captured at the third physical location.

In some embodiments, when the computer system determines that a first contact of the computer system shared the third collection of content, the computer system displays the third collection of content. In some embodiments, when the computer system determines that the first contact of the computer system shared a fourth collection of content, different from the third collection of content, the computer system displays the fourth collection of content.

Providing a respective collection of content shared by a contact of the computer system provides quick and efficient access to relevant content without the need for additional inputs for searching for such content and avoids erroneous inputs related to searching for such content, thereby reducing the number of inputs and providing more efficient interactions between the user and the computer system.

In some embodiments, while displaying the user interface of the map application, the computer system receives, via the one or more input devices, a third input corresponding to a request to generate a travel guide including the respective collection of content associated with a physical area, such as user input 906u in FIG. 9U and/or user input 966c in FIG. 9X.

In some embodiments, the third input has one or more of the characteristics of the first input and/or second input described above. For example, the third input is optionally a gaze of the user, a contact on a touch-sensitive surface, actuation of a physical input device, a predefined gesture (e.g., pinch gesture or air tap gesture) and/or a voice input from the user corresponding to the request to generate a travel guide including the respective collection of content associated with a physical area. In some embodiments, in response to receiving the third input corresponding to the request to generate the travel guide, such as input 906r in FIG. 9R, the computer system determines a respective physical area in which the third input is detected as being directed to.

In some embodiments, a travel guide is a compilation of collection(s) of content organized by physical area. In some embodiments, the travel guide is organized by type of content contained in the collection of content (e.g., photos, spatial media, videos, panoramas, and/or the like). In some embodiments, the request to generate the travel guide includes generating a new travel guide to include one or more collection(s) of content. In some embodiments, the request to generate the travel guide includes modifying (adding and/or removing) one or more collection(s) of content from an existing travel guide. In some embodiments, the computer system displays one or a sequence of user interface elements overlaid onto the user interface of the map application that, when selected, causes the computer system to perform an operation as described herein, such as display a representation of a travel guide, create a new travel guide, edit an existing travel guide, and/or other operation associated with the travel guide.

In some embodiments, in accordance with a determination that the third input was directed to a third physical area, the computer system displays, in the user interface of the map application, a representation of a first travel guide comprising a collection of content associated with the third physical area, such as the collection of content associated with the user interface element 932a in FIG. 9D

For example, the computer system optionally determines that the third input as described above corresponding to the request to generate a travel guide including the respective collection of content associated with a physical area is directed to a third area of the navigation user interface element (or a map representation) representing and/or corresponding to the third physical area. For example, the third input optionally includes a gaze of the user of the computer system, contact on a touch-sensitive surface, actuation of a physical input device (e.g., mouse, trackpad, button, and/or the like), and/or a predefined gesture (e.g., pinch gesture or air tap gesture) directed to the third physical area, wherein the third physical area corresponds to the area included in the navigation user interface element while (and/or in response to) detecting the third input. In some embodiments, the navigation user interface element has one or more of the characteristics of the navigation user interface element of method 800 and/or described above.

In another example, the computer system optionally determines that the third input is directed to the third physical area without detecting user input directed to the navigation user interface element. For example, the computer system optionally receives voice input specifying the third physical area. Thus, in this instance, the computer system optionally determines the third input is directed to the third physical area (e.g., voice input specifying the third physical area) without requiring input directed to the navigation user interface element.

In some embodiments, the computer system displays a representation of a first travel guide comprising a collection of content associated with the third physical area in the user interface of the map application and/or in the respective user interface element. In some embodiments, the computer system will change the display of the navigation user interface element (e.g., rotate, re-size, and/or tilt) and/or render a respective portion of the navigation user interface element at a zoom level to focus on an area and/or location of the map that represents the third physical area. In some embodiments, the navigation user interface element is a two-dimensional map representing the third physical area.

In some embodiments, the computer system receives, via the one or more input devices, a fourth input directed to the representation of the first travel guide comprising a collection of content associated with the third physical area, and in response to receiving the fourth input, the computer system displays, via the display generation component, the collection of content associated with the third physical area as described above and/or in method 800. In some embodiments, the collection of content includes user interactions and/or content analogous to the location experience(s) as described with reference to method 800.

In some embodiments, in accordance with a determination that the third input was directed to a fourth physical area, displaying, in the user interface of the map application, a representation of a second travel guide comprising a collection of content associated with the fourth physical area, such as the collection of content associated with the user interface element 976a in FIG. 9BB.

In some embodiments, the fourth physical area includes a larger or smaller area than the third physical area. In some embodiments, the representation of the second travel guide comprising the collection of content associated with the fourth physical area does not include content that is included in the collection of content associated with the third physical area. In some embodiments, the collection of content associated with the fourth physical area does include content included in the collection of content associated with the third physical area. For example, the computer system determines that the third input is directed to a fourth physical area, different from the third physical area, and in response, the computer system displays, in the user interface, the representation of the second travel guide comprising the collection of content associated with the fourth physical area optionally analogous to displaying the representation of the travel guide comprising the collection of content associated with the third physical area as described herein. In some embodiments, the computer system displays the navigation user interface element representing the fourth physical area optionally analogous to displaying the navigation user interface element representing the third physical area.

Automatically surfacing a representation of a travel guide comprising a collection of content associated with a physical area in response to user input corresponding to a request to generate the travel guide associated with the physical area provides an efficient way of viewing content corresponding to the physical area without leaving the user interface of the map application, thereby reducing the need for subsequent inputs to locate content related to the physical area which simplifies the interaction between the user and the computer system and enhances the operability of the computer system and makes the user-computer system interface more efficient.

In some embodiments, while displaying a representation of a third collection of content associated with a third physical area and the navigation user interface element representing the third physical area, the computer system receives, via the one or more input devices, a third input directed to the representation of the third collection of content, such as user input 906k in FIG. 9K. In some embodiments, the representation of the third collection of content associated with the third physical area is optionally analogous to and/or has one or more of the characteristics of the representation of the first collection of content associated with the first physical area described above. In some embodiments, the navigation user element representing the third physical area is optionally analogous to and/or has one or more of the characteristics of the navigation user interface element representing the first physical area described above.

In some embodiments, the third input has one or more of the characteristics of the first input and/or second input described above. For example, the third input is optionally a gaze of the user, a contact on a touch-sensitive surface, actuation of a physical input device, a predefined gesture (e.g., pinch gesture or air tap gesture) and/or a voice input from the user directed to the representation of the third collection of content. In some embodiments, in response to receiving the third input directed to the representation of the third collection of content, the computer system displays, via the display generation component, a first plurality of content of a first category and a second plurality of content of a second category, grouped according to category, such as selectable user interface elements 950b-950f in FIG. 9L.

For example, the first plurality of content of a first category and second plurality of content of a second category optionally includes content associated with a particular category (e.g., vibes, food, drink, and/or the like) and/or a particular location within the third physical area (e.g., patio, bar, dining area, restroom, patio, museum exhibit area, stadium seating area, and/or the like). In some embodiments, in accordance with a determination that user input is directed to the first plurality of content of the first category (e.g., patio), the computer system displays animated content (optionally analogous to and/or has one or more of the characteristics of the animated content described in method 800) corresponding to the patio area of the third physical area (e.g., aerial tours, panoramas, photos, videos, audio, animations, and/or other content that includes/captures the patio area. In another example, the animated content optionally features personalized photos, videos, and/or other media captured by the user of the computer system and/or contacts of the user of the computer system. In some embodiments, in accordance with a determination that user input is directed to the second plurality of content of the second category (e.g., food), different from the first category, the computer system displays content (optionally animated) corresponding to food found at the third physical area (e.g., photos, videos, audio, animations, and/or other content that includes/captures the food). Thus, in this instance, the computer system includes category filers for optionally limiting content presented to the user (e.g., present only content of the first category, present content of the first category and the second category, or presenting content based on another category or a combination of categories).

Displaying content grouped according to category provides an efficient way of viewing content corresponding to the physical area in an organized manner which reduces clutter caused by displaying too much content, thereby reducing the cognitive burden on the user and providing more efficient interactions between the user and the computer system. It should be understood that the particular order in which the operations in methods 800 and/or 1000 have been described is merely exemplary and is not intended to indicate that the described order is the only order in which the operations could be performed. One of ordinary skill in the art would recognize various ways to reorder the operations described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with a display generation component and one or more input devices:
displaying, via the display generation component, a user interface that includes a first representation of a first location experience and a first portion of a navigation user interface element with a first orientation that includes a first representation of a first point of interest experience associated with the first location experience;
while displaying, via the display generation component, the user interface:
detecting, via the one or more input devices, a first input directed to the first representation of the first location experience; and
in response to detecting the first input:
changing the display of the navigation user interface element from the first orientation to a second orientation corresponding to the first location experience; and
displaying the navigation user interface element to include a second portion, different from the first portion and associated with the first location experience.

2. The method of claim 1, further comprising:
while displaying the navigation user interface element:
displaying, via the display generation component, a second representation of the first location experience that includes animated content;
receiving, via the one or more input devices, an input selecting the second representation of the first location experience; and
in response to receiving the input selecting the second representation of the first location experience, displaying, via the display generation component, the first location experience.

3. The method of claim 2, further comprising:
while displaying the first location experience:
displaying a first selectable option;
receiving, via the one or more input devices, a second input directed to the first selectable option; and
in response to receiving the second input, pausing the first location experience;
while the first location experience is paused:
receiving, via the one or more input devices, a third input directed to the first selectable option; and
in response to receiving the third input, playing the first location experience.

4. The method of claim 2, wherein:
displaying the second representation of the first location experience includes displaying the second representation of the first location experience at a first size, and displaying the first location experience includes displaying the first location experience at a second size greater than the first size.

5. The method of claim 2, wherein displaying the second representation of the first location experience includes:
in accordance with a determination that the second representation of the first location experience is displayed at a first location within the navigation user interface element, displaying the second representation of the first location experience at a first location in the user interface associated with the first location within the navigation user interface element; and
in accordance with a determination that the second representation of the first location experience is displayed at a second location within the navigation user interface element different from the first location within the navigation user interface element, displaying the second representation of the first location experience at a second location in the user interface associated with the second location within the navigation user interface element and different from the first location in the user interface.

6. The method of claim 1, wherein the first representation of the first point of interest includes information associated with a physical location corresponding to the first location experience, and displaying the first representation of the first point of interest includes:
in accordance with a determination that the physical location corresponding to the first location experience is located at a first physical location, displaying the first representation of the first point of interest at a first location within the navigation user interface element corresponding to the first physical location; and
in accordance with a determination that the physical location corresponding to the first location experience is located at a second physical location different from the first physical location, displaying the first representation of the first point of interest at a second location within the navigation user interface element corresponding to the second physical location and different from the first location within the navigation user interface element corresponding to the first physical location.

7. The method of claim 1, further comprising:
while displaying the navigation user interface element including the second portion:
displaying a first representation of a second location experience different from the first location experience, wherein the first representation of the first location experience is displayed with increased visual prominence relative to visual prominence of the first representation of the second location experience;
receiving, via the one or more input devices, a second input directed to the first representation of the first location experience that corresponds to a request to update the visual prominence of the first representation of the first location experience and the first representation of the second location experience; and
in response to receiving the second input:
displaying, via the display generation component, the first representation of the second location experience with increased visual prominence relative to the visual prominence of the first representation of the first location experience; and
displaying, via the display generation component, the navigation user interface element to include a third portion different from the first portion, different from the second portion, and associated with the second location experience.

8. The method of claim 1, wherein displaying the user interface includes displaying the user interface in a three-dimensional environment from a viewpoint of a user of the computer system, and the method further comprises:
while displaying the three-dimensional environment from a first viewpoint of the user including displaying a third portion of the navigation user interface element oriented towards the first viewpoint of the user, detecting a change in the viewpoint of the user from the first viewpoint to a second viewpoint different from the first viewpoint; and
in response to detecting the change in the viewpoint of the user, displaying the three-dimensional environment from the second viewpoint of the user including displaying a fourth portion of the navigation user interface element oriented towards the first viewpoint of the user, the fourth portion different from the third portion.

9. The method of claim 1, further comprising:
while displaying the first location experience and the navigation user interface element:
displaying, via the display generation component, the first location experience including video having a respective viewpoint that changes over time; and
displaying, via the display generation component, a visual indication of the respective viewpoint at a location relative to the navigation user interface element that changes over time in accordance with the respective viewpoint that changes over time.

10. The method of claim 1, wherein displaying the first representation of the first point of interest includes displaying a visual indication of a source of the first location experience, and:
in accordance with a determination that the source of the first location experience is a first source, the visual indication is a first visual indication corresponding to the first source, and
in accordance with a determination that the source of the first location experience is a second source different from the first source, the visual indication is a second visual indication corresponding to the second source and different from the first visual indication.

11. The method of claim 1, wherein displaying the first representation of the first location experience includes displaying the first representation of the first location experience with a visual indication of information about a physical location corresponding to the first location experience.

12. The method of claim 1, wherein displaying the first representation of the first location experience includes:
in accordance with a determination that a first contact of the computer system has visited a physical location associated with the first location experience, a visual indication of the first contact, and
in accordance with a determination that a second contact of the computer system different from the first contact of the computer system has visited the physical location associated with the first location experience, a visual indication of the second contact different from the visual indication of the first contact.

13. The method of claim 1, wherein the first location experience includes media captured by a user of the computer system.

14. The method of claim 1, further comprising:
while displaying the first representation of the first location experience, a second representation of a second location experience, and the navigation user interface element, displaying, via the display generation component, a visual indication of a current location of a second computer system associated with a user account that is a contact of a user account associated with the computer system, wherein:
in accordance with a determination that the current location is a first physical location, the visual indication of the current location is displayed at a first location in the navigation user interface element corresponding to the first physical location, and
in accordance with a determination that the current location is a second physical location different from the first physical location, the visual indication of the current location is displayed at a second location in the navigation user interface element corresponding to the second physical location different from the first location in the navigation user interface element corresponding to the first physical location.

15. The method of claim 1, wherein the first location experience is associated with a business located at a first physical location.

16. The method of claim 15, wherein displaying the first location experience includes displaying, via the display generation component, one or more of (1) a selectable option that, when selected, causes the computer system to view a website of the business; and/or (2) a selectable option that, when selected, causes the computer system to initiate a process to make a reservation with the business; and/or (3) a selectable option that, when selected, causes the computer system to display, via the display generation component, a video tour of the business.

17. The method of claim 1, further comprising:
while displaying, via the display generation component, the first location experience, receiving, via the one or more input devices, one or more inputs corresponding to a request to add an annotation to the first location experience; and
in response to receiving the one or more inputs, modifying the first location experience to include the annotation.

18. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
displaying, via the display generation component, a user interface that includes a first representation of a first location experience and a first portion of a navigation user interface element with a first orientation that includes a first representation of a first point of interest associated with the first location experience;
while displaying, via the display generation component, the user interface:
detecting, via the one or more input devices, a first input directed to the first representation of the first location experience; and
in response to detecting the first input:
changing the display of the navigation user interface element from the first orientation to a second orientation corresponding to the first location experience; and
displaying the navigation user interface element to include a second portion, different from the first portion and associated with the first location experience.

19. A non-transitory computer readable storage medium storing one or more programs, the one or more programs comprising instructions, which when executed by one or more processors of a computer system that is in communication with a display generation component and one or more input devices, cause the computer system to perform a method comprising:
displaying, via the display generation component, a user interface that includes a first representation of a first location experience and a first portion of a navigation user interface element with a first orientation that includes a first representation of a first point of interest associated with the first location experience;
while displaying, via the display generation component, the user interface:
detecting, via the one or more input devices, a first input directed to the first representation of the first location experience; and
in response to detecting the first input:
changing the display of the navigation user interface element from the first orientation to a second orientation corresponding to the first location experience; and
displaying the navigation user interface element to include a second portion, different from the first portion and associated with the first location experience.

20.-42. (canceled)
